(19) United States
(12) Patent Application Publication
(10) Pub. No.: US 2012/0189948 A1
(43) Pub. Date: Jul. 26, 2012

(54) CHARGE TRANSPORT FILM, ORGANIC ELECTRONIC DEVICE, ELECTROPHOTOGRAPHIC PHOTORECEPTOR, PROCESS CARTRIDGE, AND IMAGE FORMING APPARATUS

(75) Inventors: Kenya SONOBE, Tokyo (JP); Katsumi NUKADA, Kanagawa (JP)

(73) Assignee: FUJI XEROX CO., LTD., TOKYO (JP)

(21) Appl. No.: 13/195,395

(22) Filed: Aug. 1, 2011

(30) Foreign Application Priority Data
Jan. 21, 2011 (JP) 2011-011019

(51) Int. Cl. G03G 15/00; G03G 21/18

(52) U.S. Cl. 430/56; 399/111; 399/159

(57) ABSTRACT

Provided is a charge transport film including an enethiol resin having a charge transporting skeleton, and having a sulfur atom content of from 2.0% by mass to 15% by mass.

### CROSS-REFERENCE TO RELATED APPLICATIONS

This application is based on and claims priority under 35 USC 119 from Japanese Patent Application No. 2011-011019 filed Jan. 21, 2011.

### BACKGROUND

1. Technical Field

The present invention relates to a charge transport film, an organic electronic device, an electrophotographic photoreceptor, a process cartridge, and an image forming apparatus.

2. Related Art

In recent years, development of charge transport films making use of organic compounds, which are used in electronic devices such as electrophotographic photoreceptors, organic electroluminescent devices (organic EL devices), organic transistors, and organic solar cells, has been actively carried out.

### SUMMARY

According to an aspect of the invention, there is provided a charge transport film containing an enethiol resin having a charge transporting skeleton, the charge transport film having a sulfur atom content of from 2.0% by mass to 15% by mass.

### BRIEF DESCRIPTION OF THE DRAWINGS

Exemplary embodiments of the present invention will be described in detail based on the following figures, wherein:

FIG. 1 is a schematic partial cross-sectional diagram showing the electrophotographic photoreceptor according to an exemplary embodiment of the invention;

FIG. 2 is a schematic partial cross-sectional diagram showing the electrophotographic photoreceptor according to another exemplary embodiment of the invention;

FIG. 3 is a schematic partial cross-sectional diagram showing the electrophotographic photoreceptor according to another exemplary embodiment of the invention;

FIG. 4 is a schematic partial cross-sectional diagram showing the electrophotographic photoreceptor according to another exemplary embodiment of the invention;

FIG. 5 is a schematic constitutional diagram showing an image forming apparatus according to an exemplary embodiment of the invention; and

FIG. 6 is a schematic constitutional diagram showing an image forming apparatus according to another exemplary embodiment of the invention.

### DETAILED DESCRIPTION

[Charge Transport Film]

The charge transport film according to an exemplary embodiment of the invention is a charge transport film containing an enethiol resin having a charge transporting skeleton and having a sulfur atom content of from 2.0% by mass to 15% by mass (or from about 2.0% by mass to about 15% by mass).

Here, the sulfur content being in the range described above means that sulfur atoms are included in the molecules that constitute the enethiol resin. That is, it is meant that with only the sulfur atoms derived from additives such as an initiator (sulfur atoms contained in additives), the sulfur atom content does not fall in the range described above.

When the charge transport film according to an exemplary embodiment of the invention is made to have the constitution described above, a charge transport film having excellent flexibility and toughness is obtained.

The reason for this is not clearly known, but is thought to be based on the following reason.

First, it is thought that, in order to impart charge transportability so as to function as a charge transport film, it is necessary that a charge transporting skeleton bring about regular molecular orientation in the film so that a conjugated system is spread out intramolecularly and intermolecularly. This is because the path of transporting the charge is thought to be secured thereby.

However, for example, it is known that in a charge transport film formed by a method of dispersing a compound having a charge transport function in a resin, uniform dispersion of the compound and the resin is realized by using a solvent; however, when a film is formed, the mutual compatibility of the resin and the compound having a charge transport function is deteriorated along with the removal of the solvent, so that the rate of charge transport in the resin is consequently decreased.

The cause for this phenomenon is not clearly known, but one of the factors may be, in addition to the dilution of the charge transporting skeleton, that it is difficult for the charge transporting skeleton and the resin to maintain the mutually dispersed state with each other, and the charge transportability cannot be fully manifested.

In this regard, it is contemplated that as in the case of the exemplary embodiment of the invention, when the charge transporting skeleton is incorporated into the polymer skeleton of the enethiol resin, the deterioration of the compatibility is suppressed, and since the charge transporting skeleton is bonded with a relatively flexible structure, that is, so-called carbon-sulfur bonding which is a structure characteristic to the enethiol resin, regular molecular orientation of the charge transporting skeleton and dispersion of the charge transporting skeleton are attained even after film formation.

The enethiol resin having the charge transporting skeleton incorporated into the resin polymer skeleton, has a relatively flexible structure that is so-called carbon-sulfur bonding, and also attains regular molecular orientation of the charge transporting skeleton and dispersion of the charge transporting skeleton. Therefore, it is thought that even if an external force is applied to the charge transport film containing the enethiol resin, the stress concentration is relieved.

It is also thought that as sulfur atoms are present in the charge transport film in the content range described above, these actions are exhibited.

As discussed above, it is contemplated that the charge transport film according to the exemplary embodiment of the invention serves as a charge transport film having excellent flexibility and toughness. As a result, bending resistance, folding resistance and elongation properties are thought to be imparted.

On the other hand, it is thought that these properties of flexibility and toughness are maintained because, even if the enethiol resin is made into a cross-linked resin for the purpose of enhancing the mechanical properties of the film, the enethiol resin has a relatively flexible structure that is so-called carbon-sulfur bonding, and also, regular molecular orientation of the charge transporting skeleton and dispersion of the charge transporting skeleton are attained. Therefore, even a cured film containing a cross-linked product of the enethiol resin and having excellent mechanical strength may become a charge transport film having excellent flexibility and toughness. As a result, high surface hardness, abrasion resistance and scratch resistance may be imparted.

Furthermore, the charge transport film according to the exemplary embodiment of the invention is also a charge transport film having excellent charge transportability.

This is because, as explained above, when regular molecular orientation of the charge transporting skeleton and dispersion of the charge transporting skeleton are attained, and the sulfur atoms in the charge transport film are present in the content range described above, it is believed that an electronic conjugated system is apparently spread between the charge transporting skeletons as well as between the charge transporting skeleton and the sulfur atoms.

Furthermore, it is thought that when the enethiol resin having a charge transporting skeleton is obtained by, for example, a reaction between a reactive functional group having a carbon double bond and a thiol group, the reaction is likely to occur fast and selectively. Accordingly, it is thought that side reactions that induce deterioration of the charge transporting skeleton do not easily occur, and thus deterioration of the charge transport function in the enethiol resin having a charge transporting skeleton is believed to be prevented.

Here, the charge transport film according to the exemplary embodiment of the invention has a sulfur atom content of from 2.0% by mass to 15% by mass (or from about 2.0% by mass to about 15% by mass), but from the viewpoint of obtaining a film which has excellent charge transportability and mechanical properties, as well as in flexibility and toughness, the sulfur atom content may be from 2.5% by mass to 15% by mass (or from about 2.5% by mass to about 15% by mass), desirably from 3.0% by mass to 15% by mass (or from about 3.0% by mass to about 15% by mass), and more desirably from 4.0% by mass to 10% by mass (or from about 4.0% by mass to about 10% by mass). Furthermore, when the charge transport film is a cured film containing a cross-linked product of the enethiol resin, the sulfur atom content is preferably from 2.0% by mass to 11% by mass (or from about 2.0% by mass to about 11% by mass).

The sulfur atom content is determined by calculation from the mixing ratio of the respective raw materials when the raw materials used are clearly known. When the raw materials used are unclear, only the charge transport film is collected, and the sulfur content in the film is determined according to an elemental analysis method based on X-ray fluorescence.

Furthermore, the sulfur atom content is controlled by, for example, regulating the amount of compounds having thiol groups when synthesis of the enethiol resin is carried out.

Hereinafter, the enethiol resin having a charge transporting skeleton (hereinafter, may be simply referred to as “enethiol resin”), which constitutes the charge transport film according to the exemplary embodiment of the invention, will be described in detail.

(Enethiol Resin)

The enethiol resin is, for example, a resin which can be polymerized using one or more kinds of a compound having two or more reactive functional groups each having a carbon double bond and one or more kinds of a compound having two or more thiol groups as raw materials, by applying external energy such as ultraviolet irradiation or heat in the co-presence of a catalyst having hydrogen abstraction ability, and is a resin obtainable by using a compound prepared by introducing a charge transporting skeleton into at least one of a compound having a reactive functional group having a carbon double bond and a compound having a thiol group.

There are no particular limitations on the enethiol resin as long as the same structure as the structure obtainable by the method described above is consequently given to the resin even if other production methods and raw materials are used.

Here, the charge transporting skeleton is an organic compound skeleton having at least one of a known electron transporting structure and a hole transporting structure. There are no particular limitations but examples of the charge transporting skeleton include skeletons derived from a phthalocyanine-based compound, a porphyrin-based compound, an azobenzene-based compound, a triarylamine-based compound, a benzidine-based compound, an arylalkane-based compound, an aryl-substituted ethylene-based compound, a stilbene-based compound, an anthracene-based compound, a hydrazone-based compound, a quinone-based compound, and a fluorenone-based compound. Among these, a skeleton of a triarylamine-based compound is desirable from the viewpoint that the charge transportability and mechanical properties of the resulting film are excellent.

Here, particularly the charge transporting skeleton is suitably a skeleton represented by the following formula (AAA), from the viewpoint that the charge transportability and mechanical properties of the resulting film are excellent.

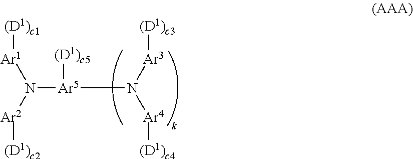

In the formula (AAA), Ar¹ to Ar⁴ each independently represent a substituted or unsubstituted aryl group.

Ar⁵ represents a substituted or unsubstituted aryl group, or a substituted or unsubstituted arylene group.

D¹'s each independently represent a linking group that links the skeleton to a site other than the charge transporting skeleton that constitutes the enethiol resin, and each represent “Ar”-(G)ₐ₁-(X)ₐ₂—Y—S—* or “Ar”-(G)ₐ₁-(Z)ₐ₂—Y′—CH(R)—CH₂—*.

c1 to c5 each independently represent 0, 1 or 2.

k represents 0 or 1, and the total number of D¹ is 2 or greater.

Here, in regard to the group represented by D¹ in the formula (AAA),

“Ar” represents any one among Ar¹ to Ar⁵, to which D¹ is linked.

G represents a divalent organic group having from 1 to 5 carbon atoms, and specific examples include an alkylene group having from 1 to 5 carbon atoms, an alkylene ether group having from 1 to 5 carbon atoms, and a polyalkylene ether group having from 1 to 5 carbon atoms.

X represents —CO—O—, or —O—.

Y represents a divalent organic group having from 1 to 5 carbon atoms which may be substituted with SH as a substituent, and specific examples include an alkylene group having from 1 to 5 carbon atoms, an alkylene ether group having from 1 to 5 carbon atoms, and a polyalkylene ether group having from 1 to 5 carbon atoms, which may be substituted with —SH as a substituent.

Y′ represents a divalent organic group having from 1 to 5 carbon atoms, and specific examples include an alkylene group having from 1 to 5 carbon atoms, an alkylene ether group having from 1 to 5 carbon atoms, and a polyalkylene ether group having from 1 to 5 carbon atoms.

Z represents —CO—, —O—, or a phenylene group.

R represents a hydrogen atom, or an alkyl group having from 1 to 4 carbon atoms.

a1 and a2 each independently represent 0 or 1.

* represents a linking unit to a site other than the charge transporting skeleton of the enethiol resin, and a specific example is a linking unit to at least one repeating unit of a polyene structure and a polythiol structure.

In the formula (AAA), Ar¹ to Ar⁵, c1 to c5, and k have the same definitions as Ar¹ to Ar⁵, c1 to c5, and k in the formula (A) that will be described below, and therefore, further explanation will not be repeated.

Specific examples of the enethiol resin include copolymers having the following combinations as raw materials.

1) A combination of (I) a compound which has two or more reactive functional groups each having a carbon double bond, and has a charge transporting skeleton (hereinafter, may be referred to as compound of (I)), and (II) a compound which has two or more thiol groups and does not have a charge transporting skeleton (hereinafter, may be referred to as compound of (II)).

2) A combination of (III) a compound which has two or more reactive functional groups each having a carbon double bond and does not have a charge transporting skeleton (hereinafter, may be referred to as compound of (III)), and (IV) a compound which has two or more thiol groups and has a charge transporting skeleton (hereinafter, may be referred to as compound of (IV)).

3) A combination of the compound of (I) and the compound of (IV).

The enethiol resin may be a copolymer of these raw material combinations only, or may be a copolymer using a mixture of two or more of these raw material combinations.

Furthermore, the enethiol resin may be a polymer which has a charge transporting skeleton in one molecule, and uses a compound with a total number of two or more reactive functional groups having a carbon double bond and a thiol group as raw materials.

Here, a cross-linked product of the enethiol resin is obtained. That is, from the viewpoint of obtaining a film having excellent mechanical properties as well as excellent flexibility and toughness, the relationship between the number of moles of the reactive functional group having a carbon double bond and the number of moles of the thiol group for obtaining the enethiol resin is such that the value of [(molar amount of thiol group)/(molar amount of reactive functional group having carbon double bond)]×100(%) may be, for example, from 20% to 100%, preferably from 35% to 90%, and even more preferably from 45% to 80%.

That is, when the amount of the raw materials is adjusted such that the relationship between the number of moles of the reactive functional group having a carbon double bond and the number of moles of the thiol group is in the range described above, the number of moles of the reactive functional group having a carbon double bond becomes larger than the number of moles of the thiol group. As a result, it is expected that cross-linking curing of the film proceeds as a result of the progress of polymerization by the reactive functional group having a carbon double bond, and thus the enethiol resin turns into a cross-linked product, so that the resulting film turns into a cured film.

Similarly, a cross-linked product of the enethiol resin is obtained. That is, from the viewpoint of obtaining a film having excellent mechanical properties as well as excellent flexibility and toughness, it is desirable to use at least a compound having three or more of any one of a reactive functional group having a carbon double bond and a thiol group, for the raw materials of the combination selected from the compound (I) to the compound of (IV).

That is, it is desirable to use at least a compound having three or more reactive functional groups each having a carbon double bond, or a compound having three or more thiol groups, for the raw material of the combination selected from the compound of (I) to the compound of (IV).

It is thought that theoretically, the enethiol resin thereby turns into a cross-linked product, and the resulting film turns into a cured film.

Hereinafter, the compounds of (I) to (IV) will be described in detail.

Compound of (I)

The compound of (I) is a compound which has two or more reactive functional groups each having a carbon double bond and has a charge transporting skeleton in the same molecule.

The reactive functional group having a carbon double bond in the compound of (I) may be, for example, a group selected from an acryloyl group, a methacryloyl group, a vinylphenyl group, an allyl group, a vinyl group, a vinyl ether group, an allyl vinyl ether group, and derivatives thereof. Among these, from the viewpoint of having excellent reactivity, the chain polymerizable functional group may be at least one selected from an acryloyl group, a methacryloyl group, a vinylphenyl group, a vinyl group, and derivatives thereof.

The compound of (I) may be a compound having 4 or more reactive functional groups each having a carbon double bond in the same molecule. Thereby, it is easier to obtain a film having high charge transportability and mechanical strength.

The number of the reactive functional groups each having a carbon double bond may be in the range of 20 or less, or in the range of 10 or less, from the viewpoint of stability and electrical properties of the raw material composition (coating liquid) for obtaining a film composed of an enethiol resin.

A specific example of the compound of (I) is suitably a compound represented by the following formula (A), from the viewpoint that the resulting film has excellent charge transportability and mechanical properties.

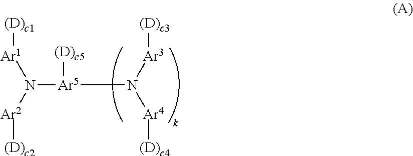

In the formula (A), Ar¹ to Ar⁴ each independently represent a substituted or unsubstituted aryl group; Ar⁵ represents a substituted or unsubstituted aryl group, or a substituted or unsubstituted arylene group; D represents a group having a functional group having a carbon double bond; c1 to c5 each independently represent 0, 1 or 2; k represents 0 or 1; and the total number of D's is 2 or greater.

Here, the compound represented by the formula (A) may be a compound in which D represents at least one group selected from an acryloyl group, a methacryloyl group, a vinylphenyl group, an allyl group, a vinyl group, a vinyl ether group, an allyl vinyl ether group, and derivatives thereof (particularly, a group having these groups at a terminal), from the viewpoint that the resulting film has excellent mechanical strength.

Furthermore, the compound represented by the formula (A) may also be a compound in which D represents —(CH₂)_{d}—(O—CH₂—CH₂)ₑ—O—CO—C(R′)═CH₂ (provided that R′ represents a hydrogen atom, or a methyl group; d represents an integer from 1 to 5; and e represents 0 or 1), from the viewpoint that the resulting film has excellent charge transportability and mechanical strength.

Particularly, a compound in which D represents (G)ₐ₁-(Z)ₐ₂—Y′—C(R)═CH₂ (provided that G, Y′, Z, R, a1 and a2 respectively have the same meanings as those in the formula (AAA)) is desirable.

In addition, an acryloyl group, a methacryloyl group, and a vinylphenyl group tend to have high reactivity with the chain transfer agent, and high mechanical strength in the resulting film. On the other hand, an allyl group, a vinyl group, a vinyl ether group and an allyl vinyl ether group are less reactive, and the reaction does not easily proceed in a general polymerization process; however, these groups are highly reactive with a compound having a thiol group (with the thiol group), and polymerization proceeds. Thus, the resulting film has increased mechanical strength.

In the formula (A), Ar¹ to Ar⁴ each independently represent a substituted or unsubstituted aryl group. Each of Ar¹ to Ar⁴ may be identical with the others, or may be different from the others.

Here, the substituent in the substituted aryl group may be groups other than the groups represented by D, and examples include an alkyl group having from 1 to 4 carbon atoms, an alkoxy group having from 1 to 4 carbon atoms, and a substituted or unsubstituted aryl group having from 6 to 10 carbon atoms.

Specifically, Ar¹ to Ar⁴ may be a group of any one of the following formulas (1) to (7). In the following formulas (1) to (7), “-(D)_{C1}” to “-(D)_{C4}” that may be respectively linked to Ar¹ to Ar⁴ will be collectively represented as “-(D)_{C}”.

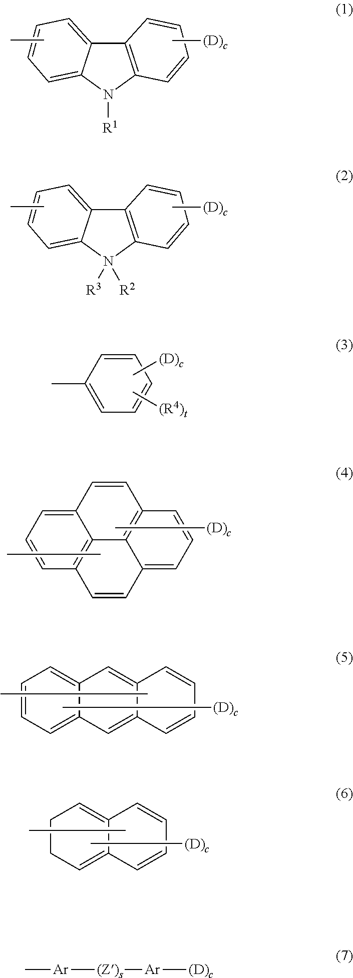

In the formulas (1) to (7), R¹ represents any one selected from the group consisting of a hydrogen atom, an alkyl group having from 1 to 4 carbon atoms, a phenyl group substituted with an alkyl group having from 1 to 4 carbon atoms or an alkoxy group having from 1 to 4 carbon atoms, an unsubstituted phenyl group, and an aralkyl group having from 7 to 10 carbon atoms; R² to R⁴ each independently represent any one selected from the group consisting of a hydrogen atom, an alkyl group having from 1 to 4 carbon atoms, an alkoxy group having from 1 to 4 carbon atoms, a phenyl group substituted with an alkoxy group having from 1 to 4 carbon atoms, an unsubstituted phenyl group, an aralkyl group having from 7 to 10 carbon atoms, and a halogen atom; Ar represents a substituted or unsubstituted arylene group; D represents the same group as D in the formula (A); c represents 1 or 2; s represents 0 or 1; and t represents an integer from 0 to 3.

Here, Ar in the formula (7) may be represented by the following structural formula (8) or (9).

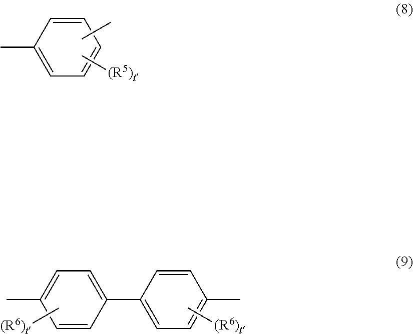

In the formulas (8) and (9), R⁵ and R⁶ each independently represent any one selected from the group consisting of a hydrogen atom, an alkyl group having from 1 to 4 carbon atoms, an alkoxy group having from 1 to 4 carbon atoms, a phenyl group substituted with an alkoxy group having from 1 to 4 carbon atoms, an unsubstituted phenyl group, an aralkyl group having from 7 to 10 carbon atoms, and a halogen atom; and t′ represents an integer from 0 to 3.

Furthermore, in the formula (7), Z′ represents a divalent organic linking group, but Z′ may be represented by any one of the following formulas (10) to (17).

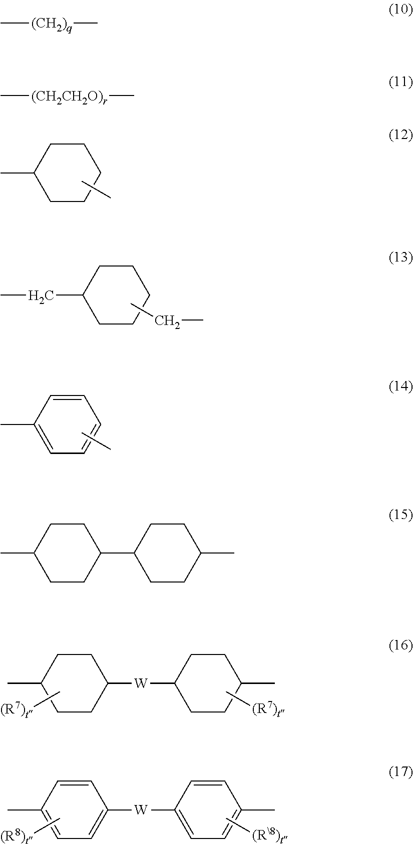

In the formulas (10) to (17), R⁷ and R⁸ each independently represent any one selected from the group consisting of a hydrogen atom, an alkyl group having from 1 to 4 carbon atoms, an alkoxy group having from 1 to 4 carbon atoms, a phenyl group substituted with an alkoxy group having from 1 to 4 carbon atoms, an unsubstituted phenyl group, an aralkyl group having from 7 to 10 carbon atoms, and a halogen atom; W represents a divalent group; q and r each independently represent an integer from 1 to 10; and t″ represents an integer from 0 to 3.

W in the formulas (16) and (17) may be any one of the divalent groups represented by the following formulas (18) to (26). However, in the formula (25), u represents an integer from 0 to 3.

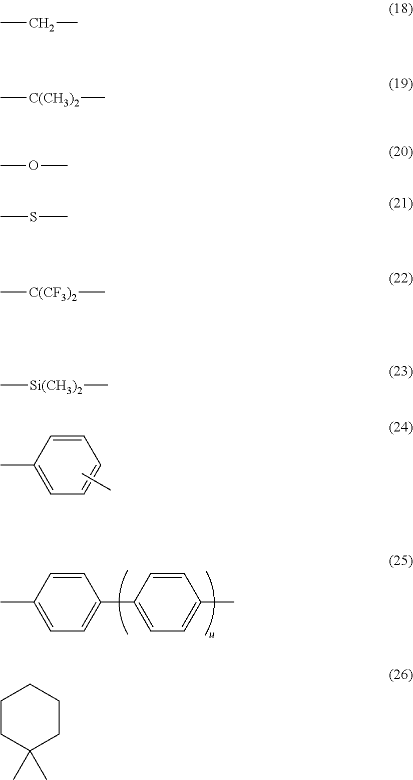

Furthermore, in the formula (A), Ar⁵ represents a substituted or unsubstituted aryl group when k is 0, and this aryl group may be the same aryl group as that exemplified in the definition of Ar¹ to Ar⁴. Furthermore, Ar⁵ represents a substituted or unsubstituted arylene group when k is 1, and this arylene group may be an arylene group obtained by eliminating one hydrogen atom from an intended position of the aryl group exemplified in the definition of Ar¹ to Ar⁴.

Hereinafter, specific examples of the compound represented by the formula (A) (compound of (I)) are shown below. However, the compound represented by the formula (A) is not intended to be limited to these.

First, specific examples of a compound having two reactive functional groups each having a carbon double bond will be shown below, but the examples are not limited to these.

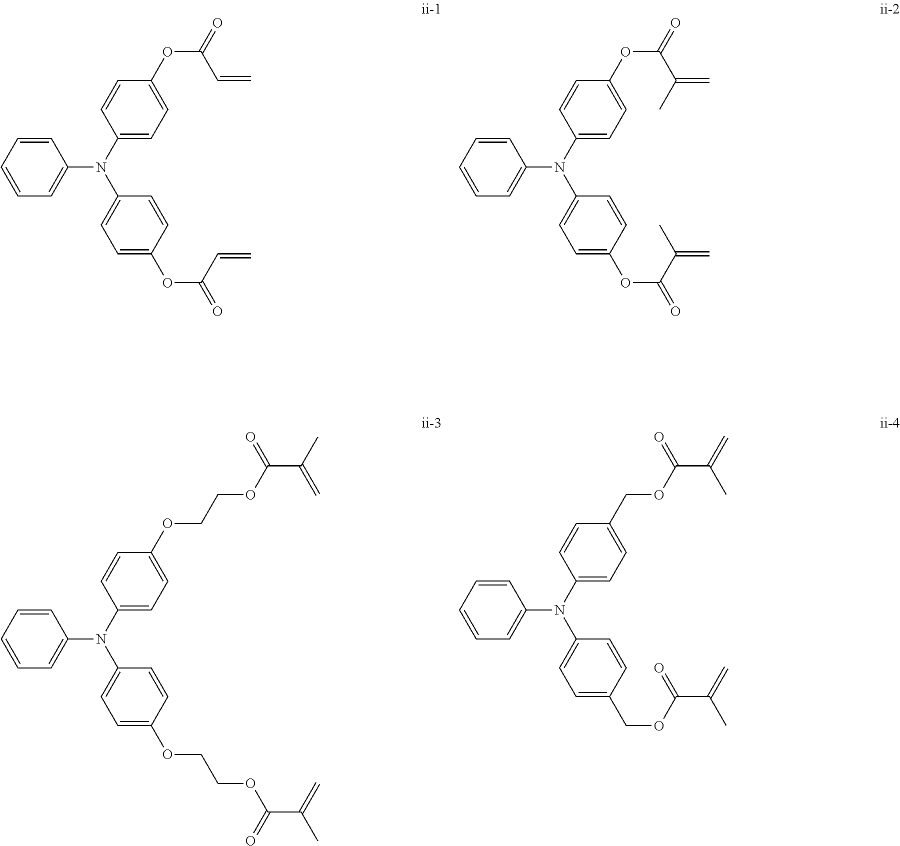

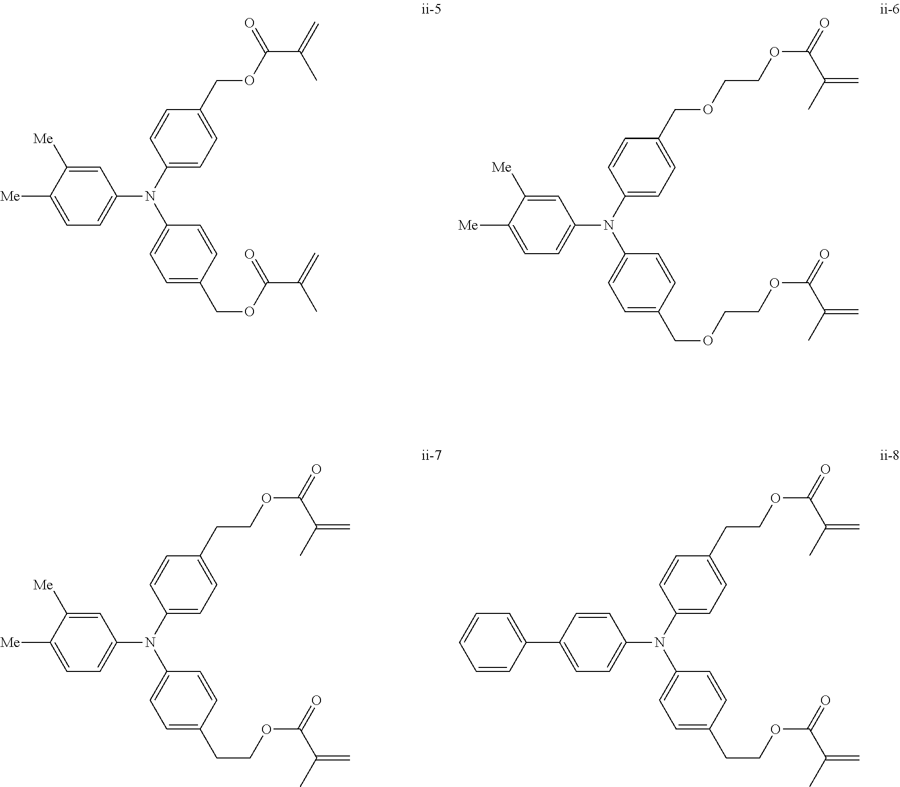

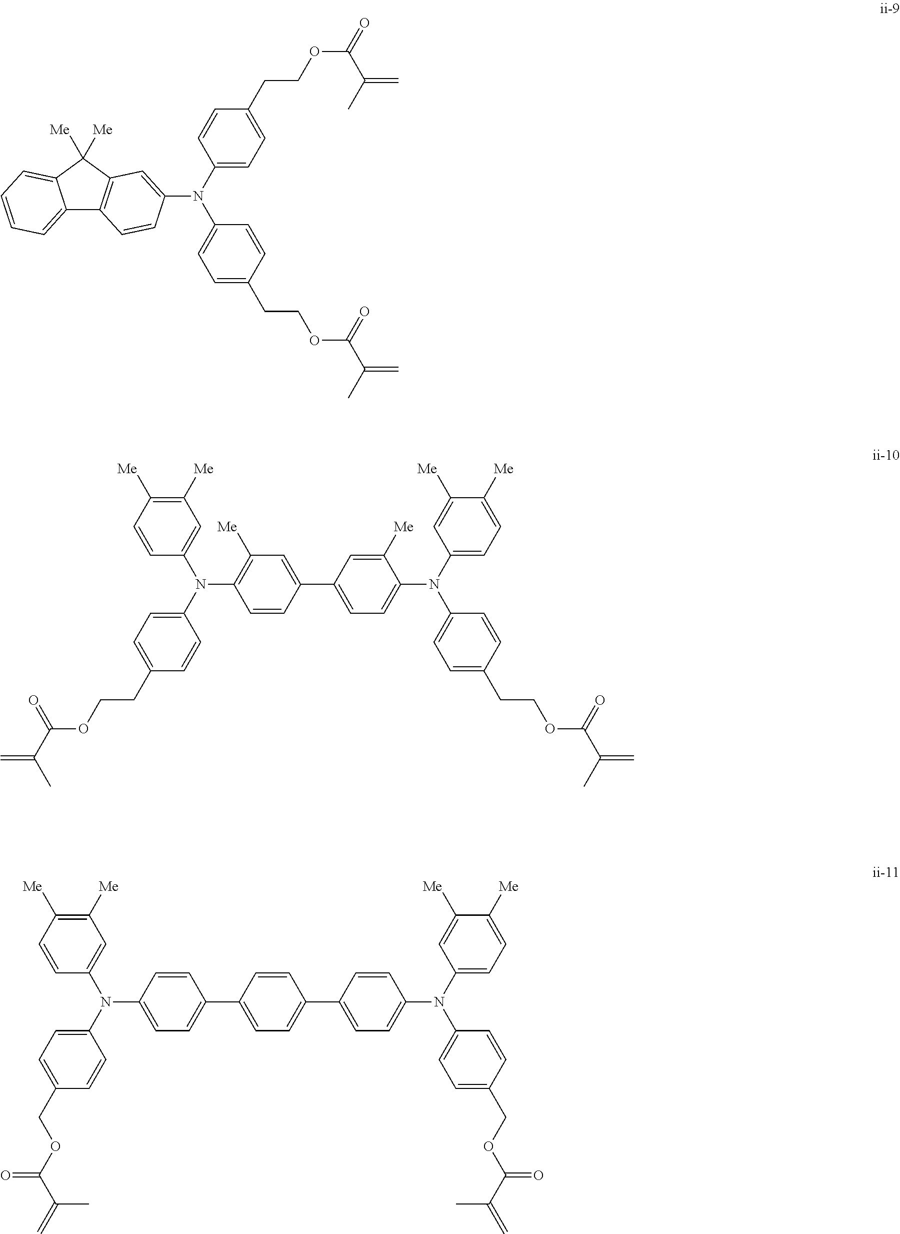

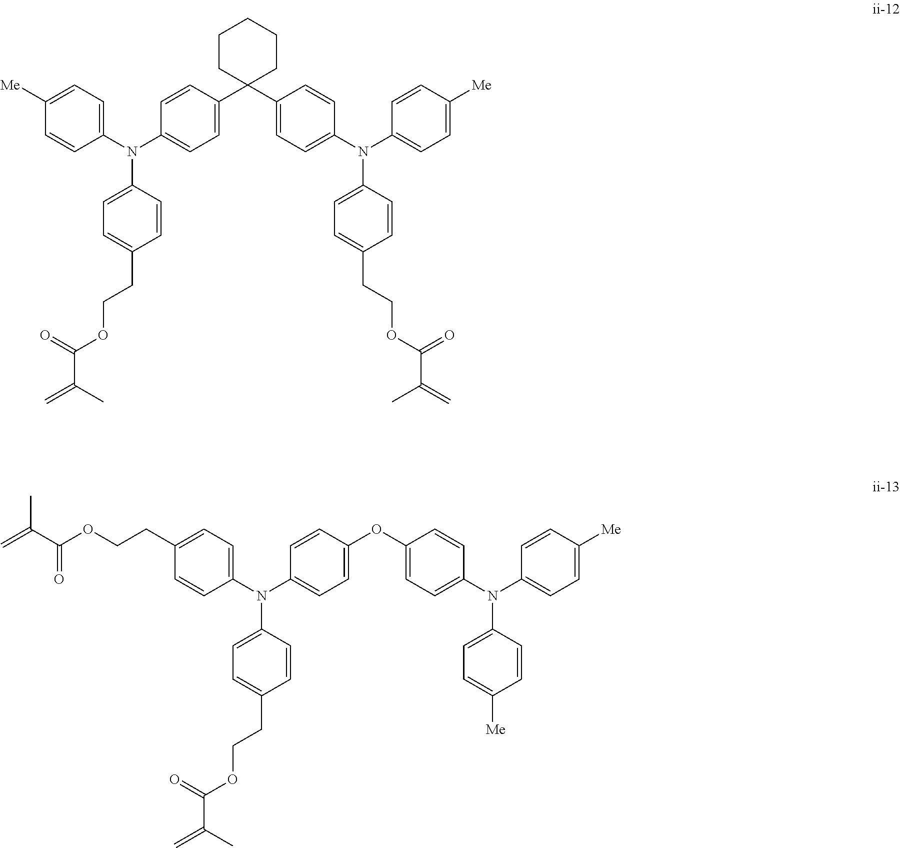

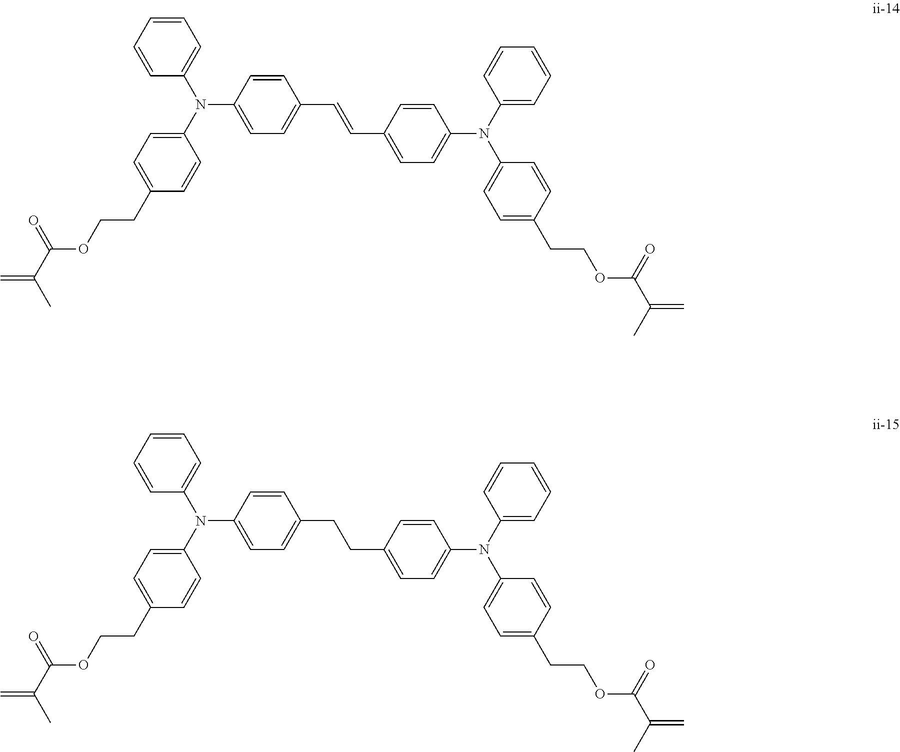

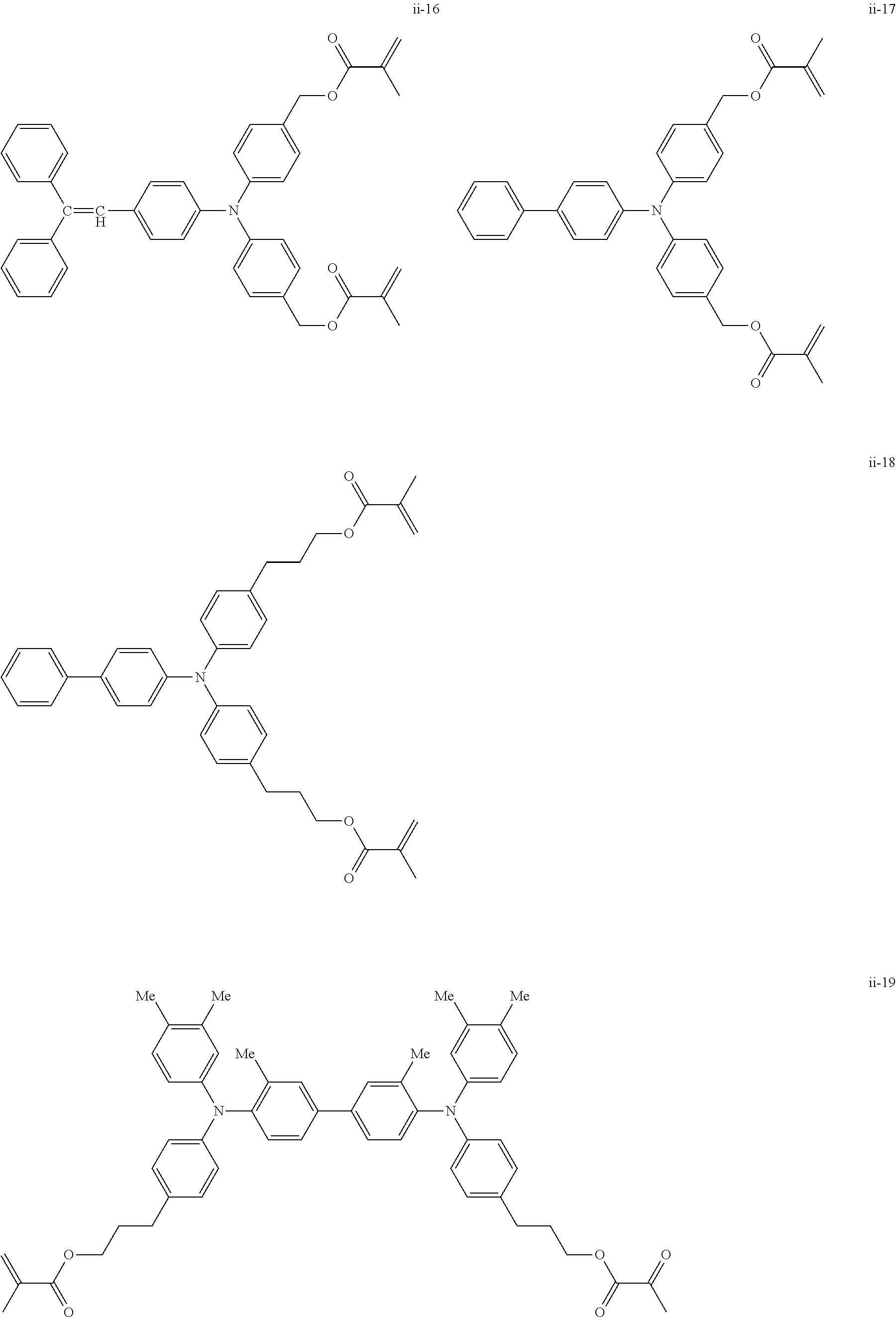

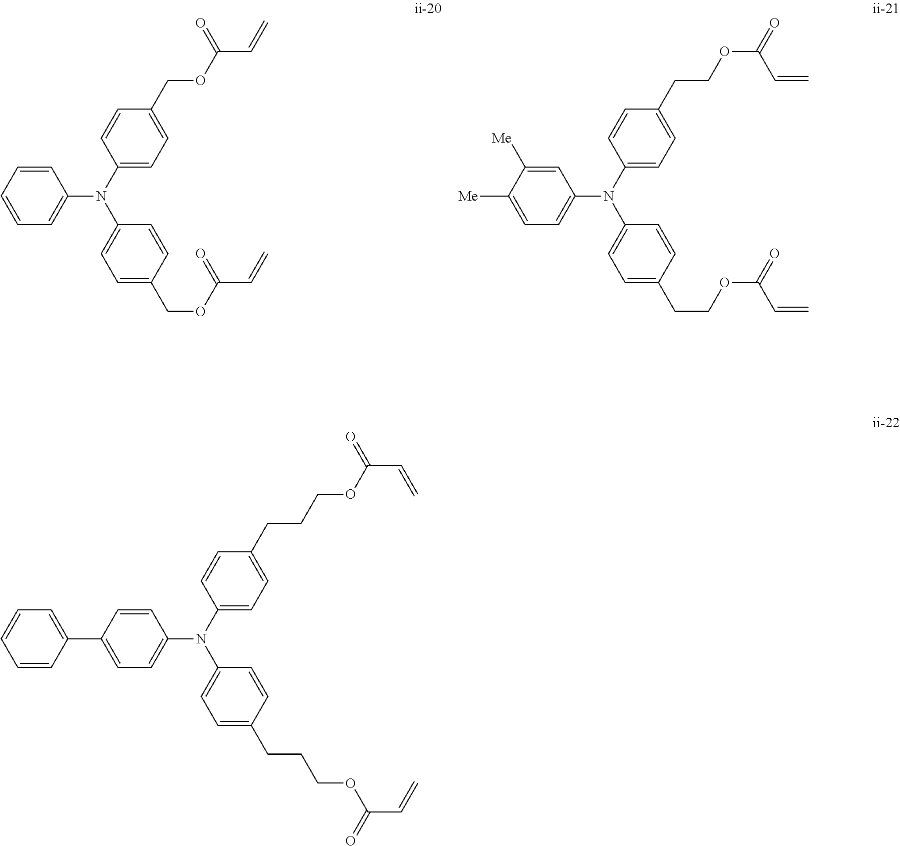

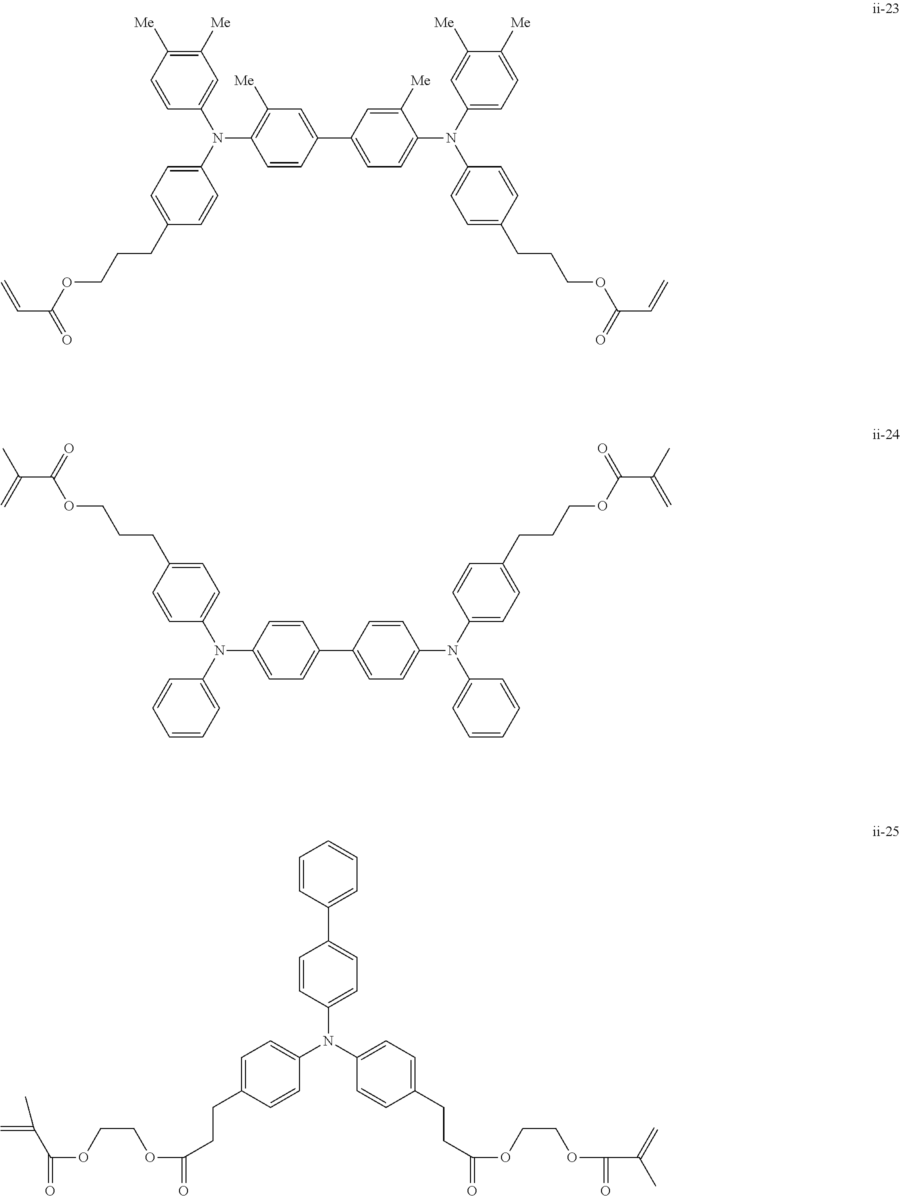

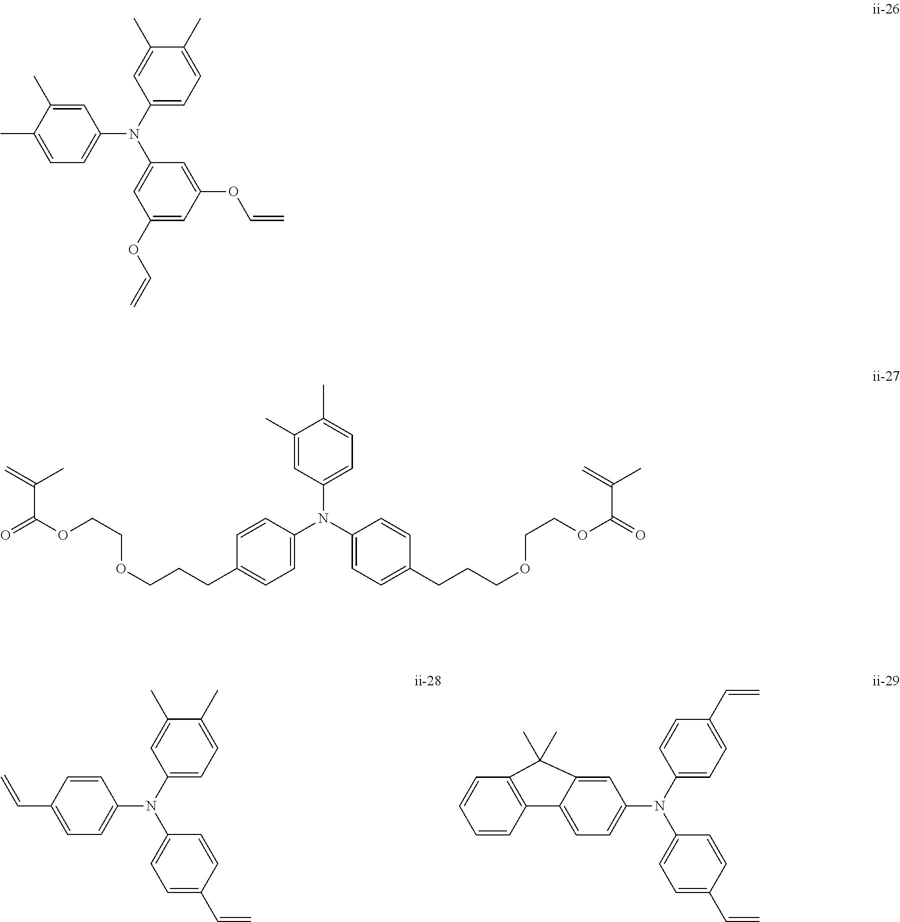

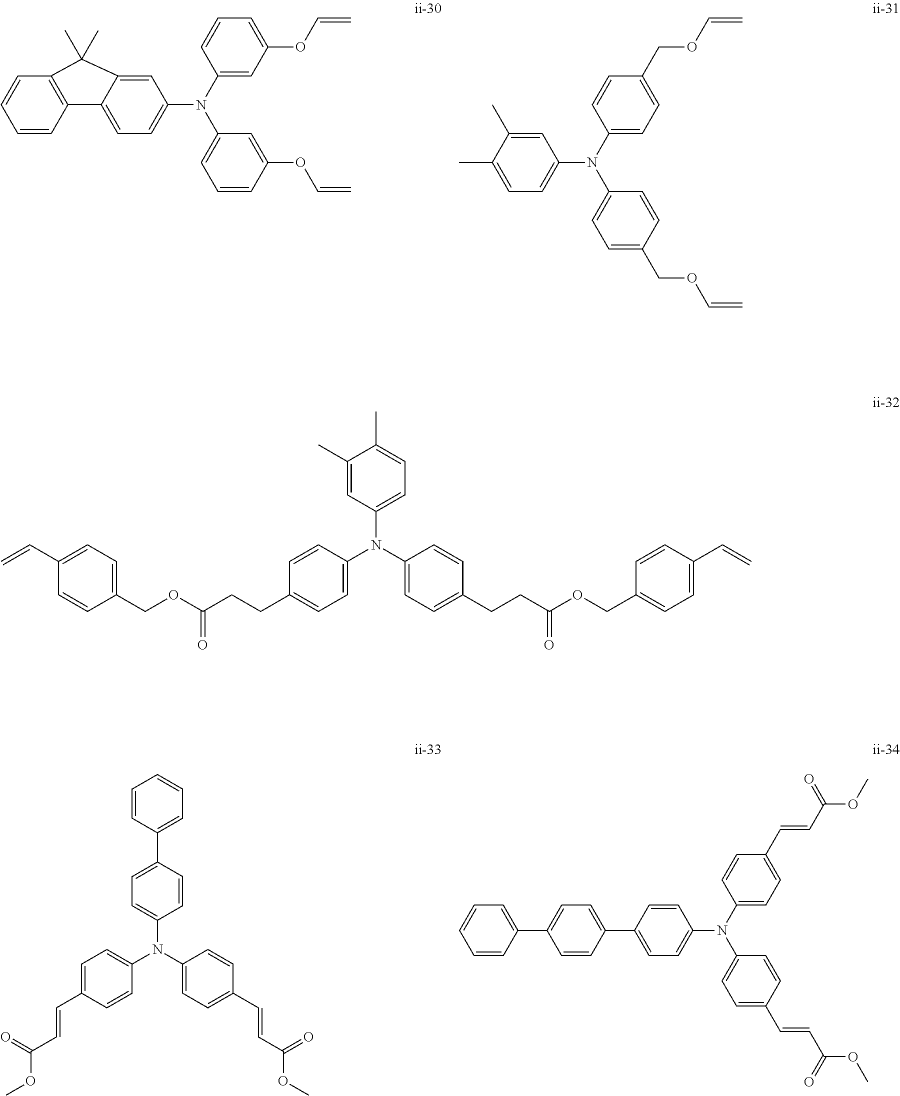

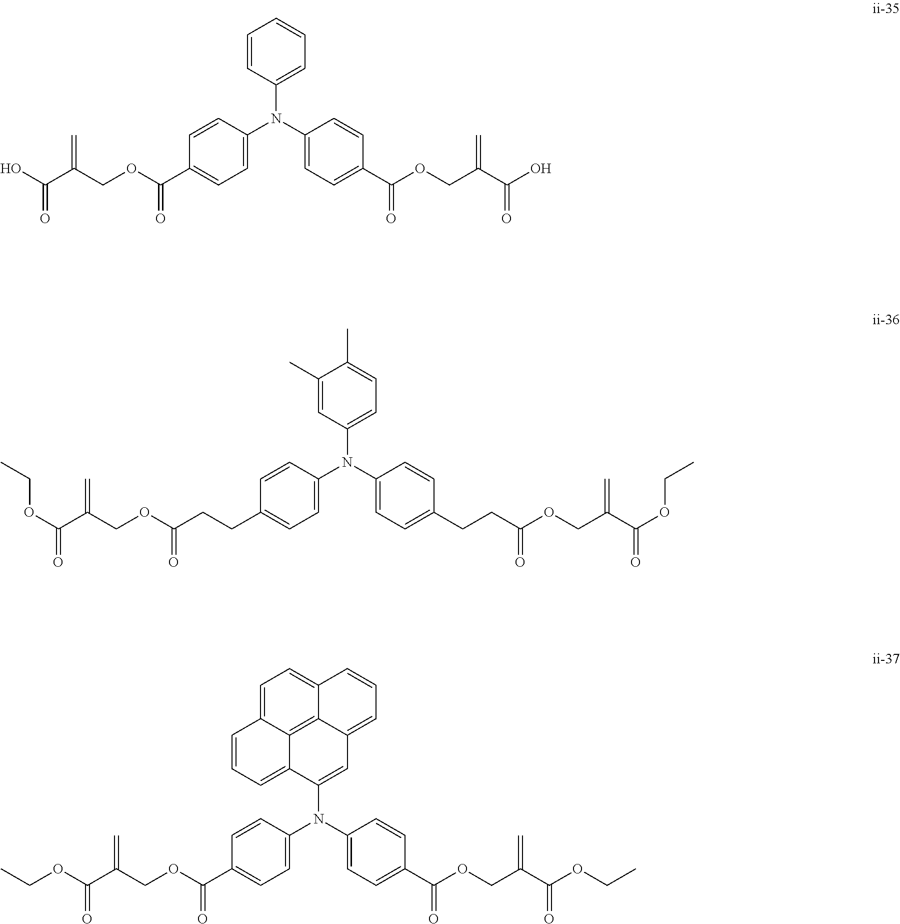

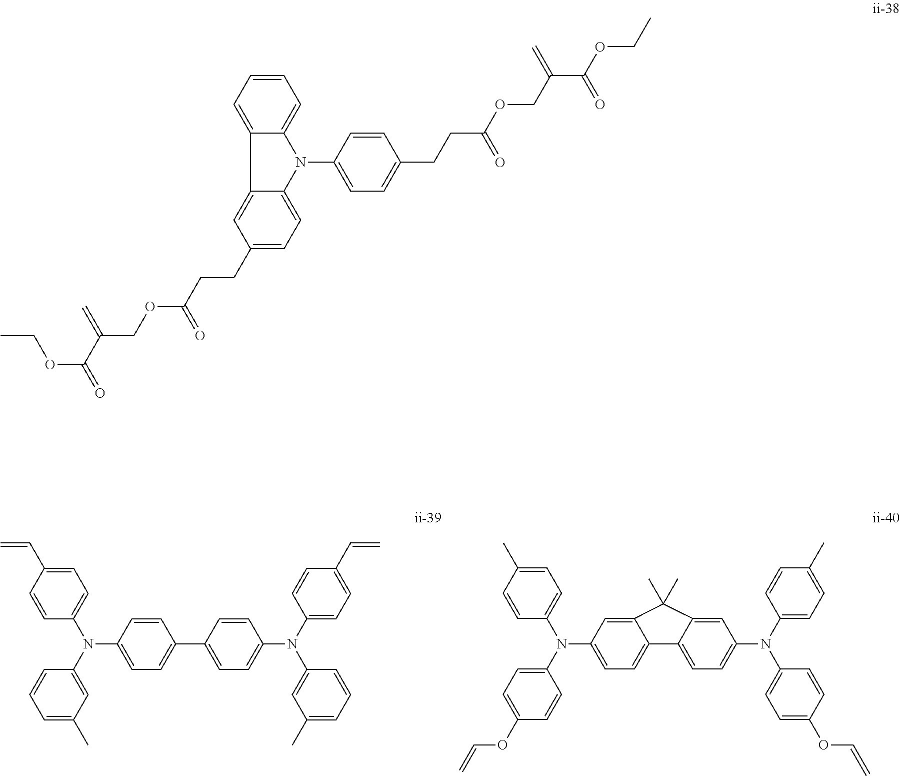

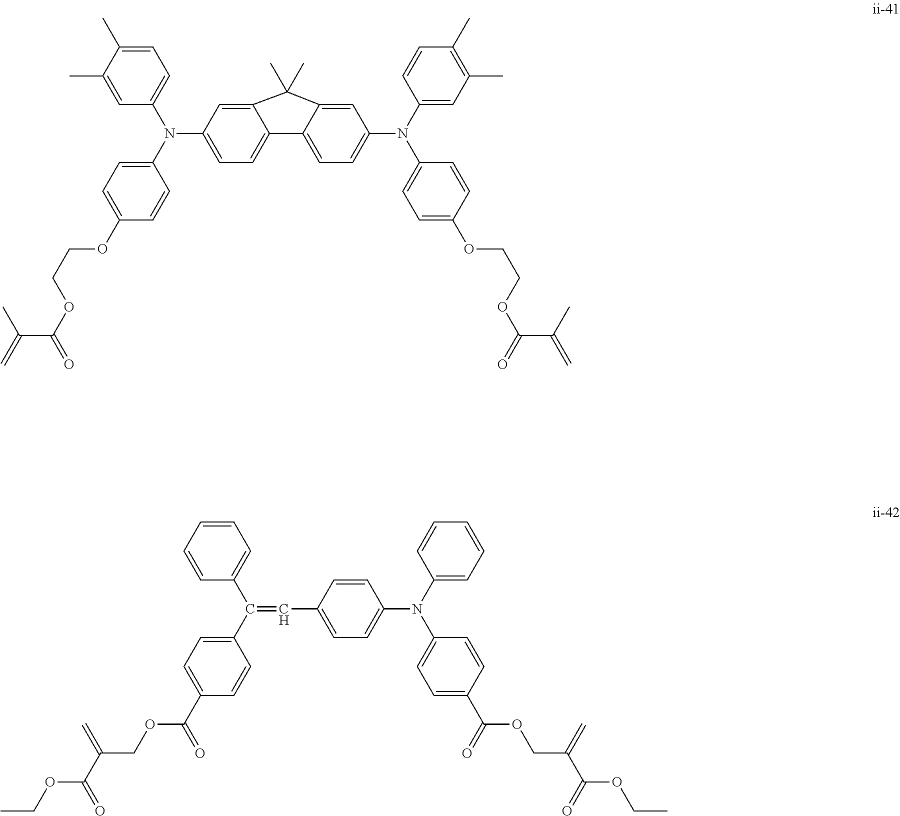

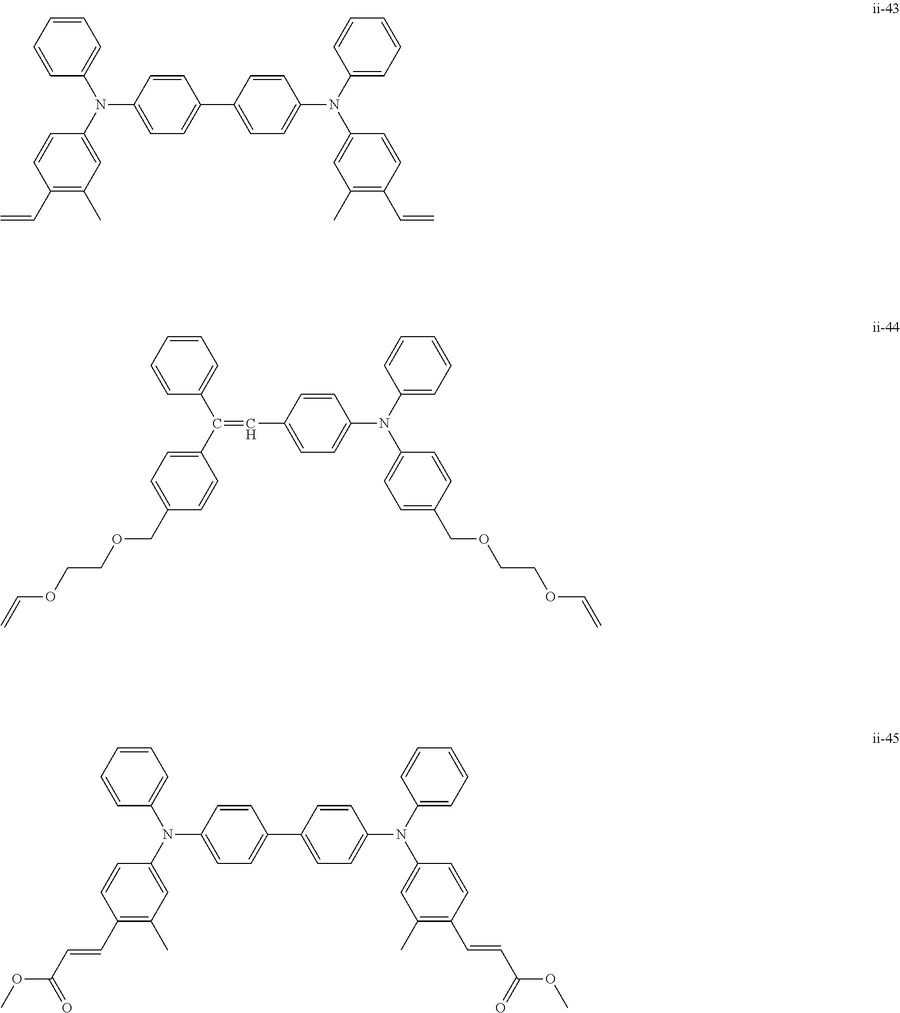

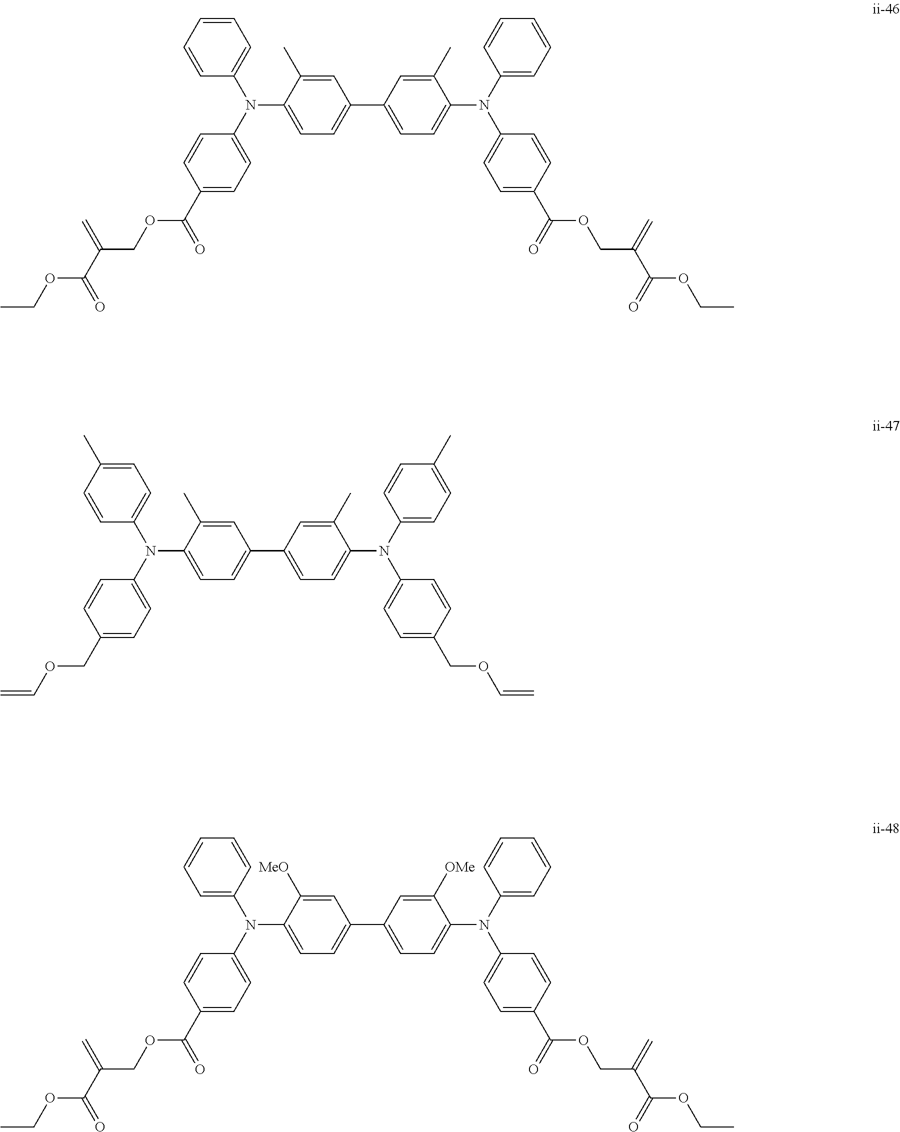

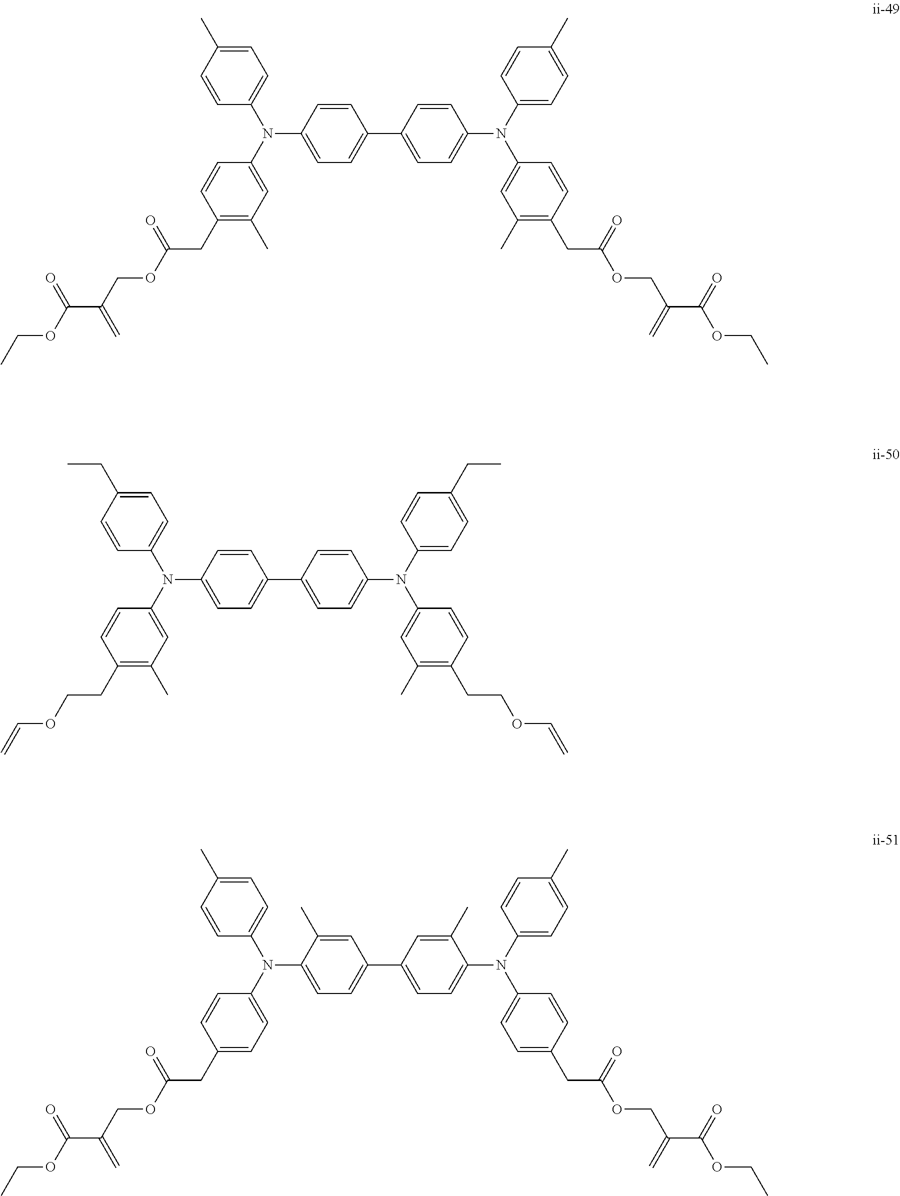

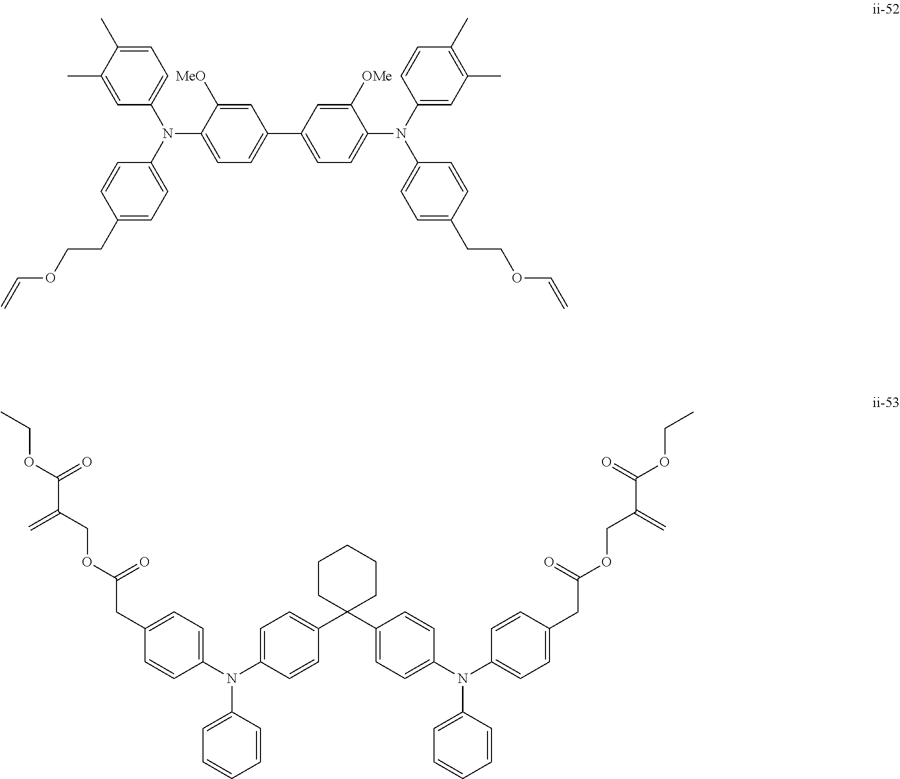

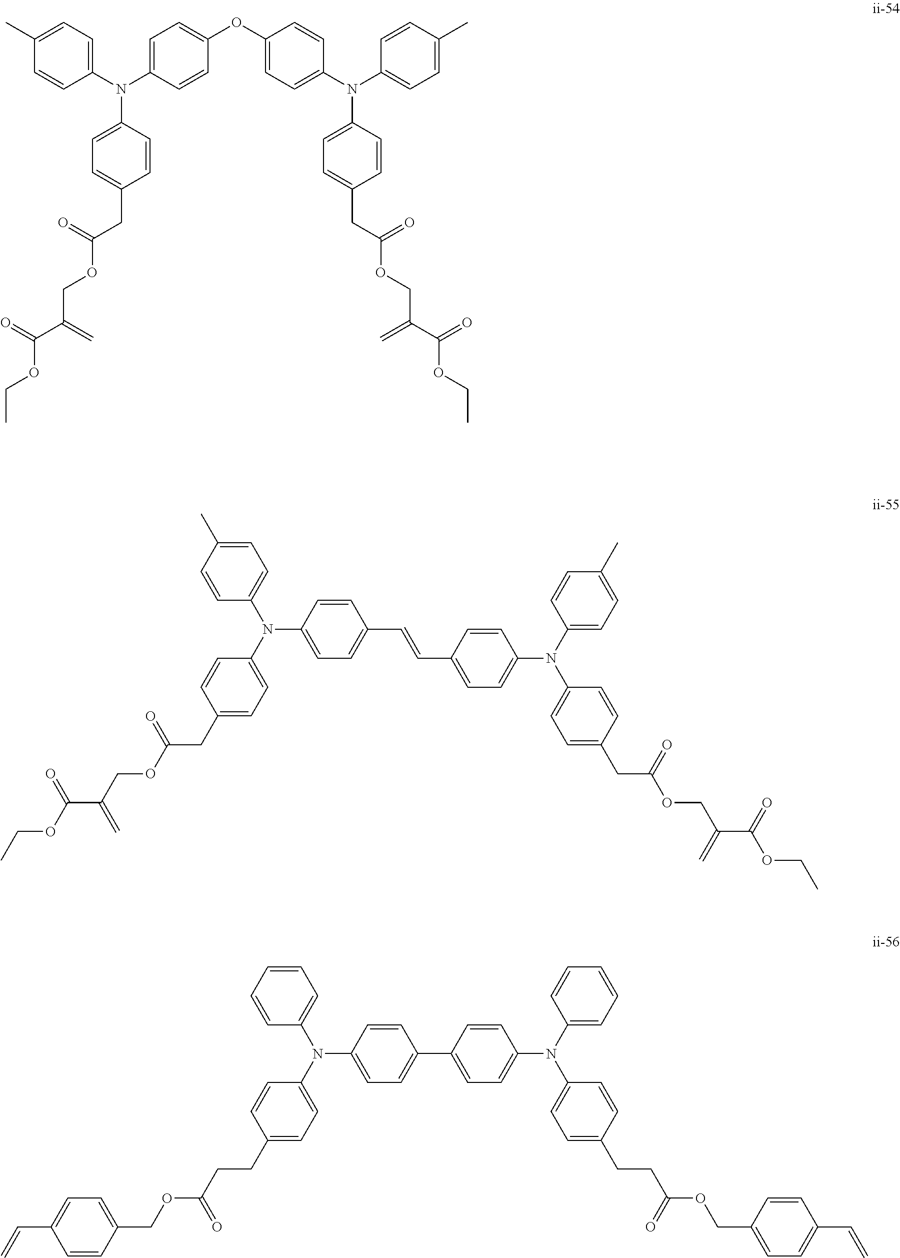

Furthermore, specific examples of a compound having three reactive functional groups each having a carbon double bond will be shown below, but the examples are not limited to these.

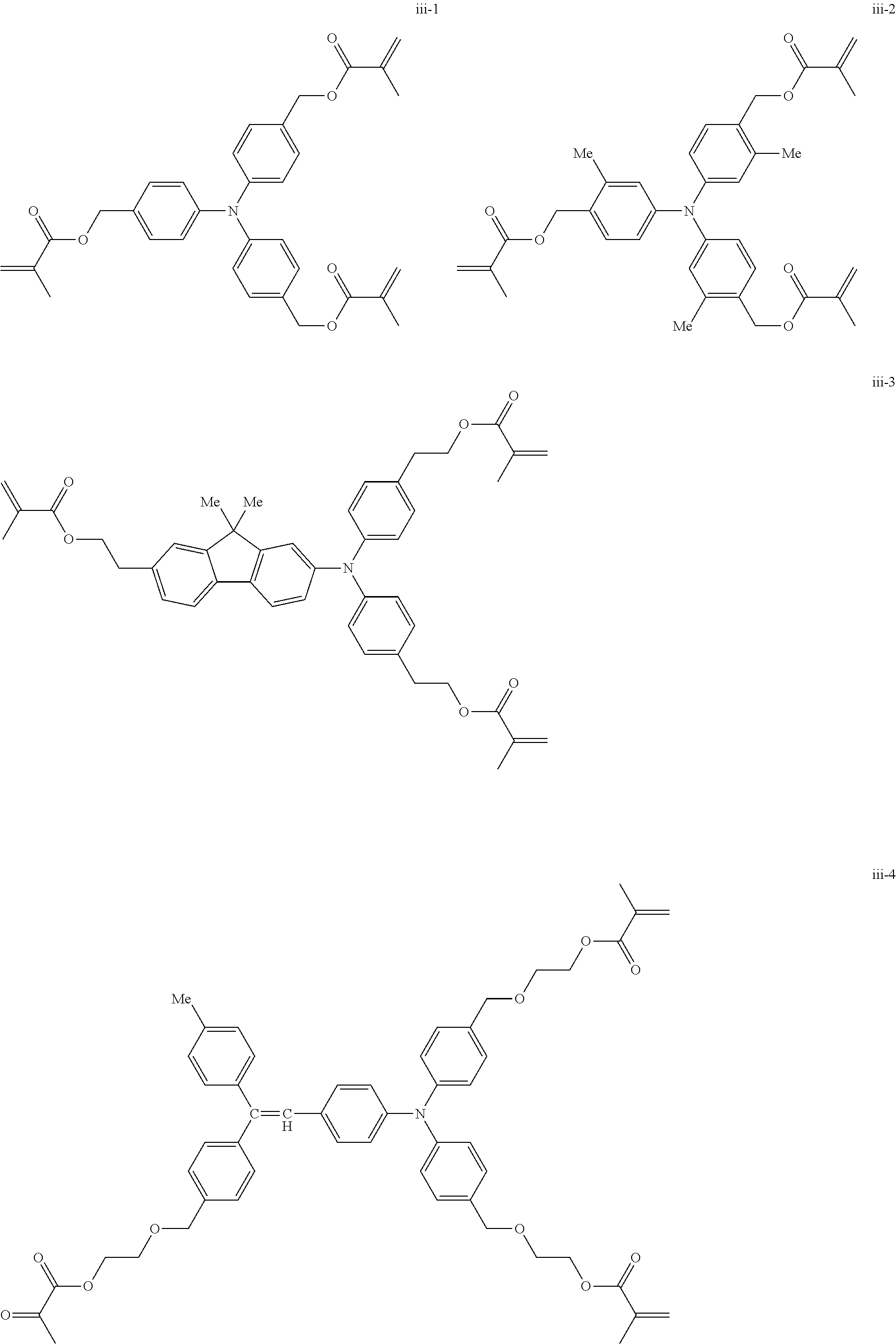

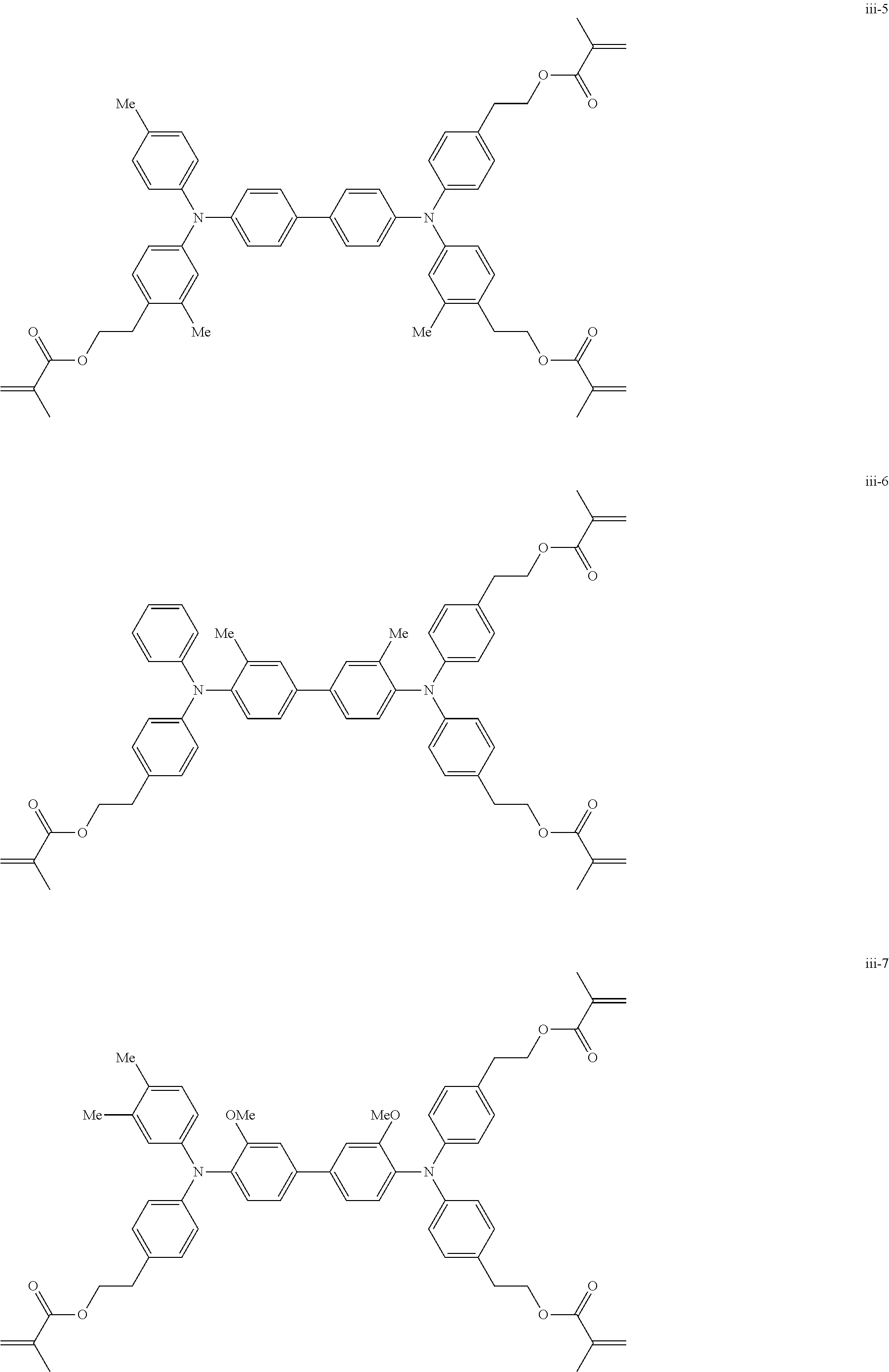

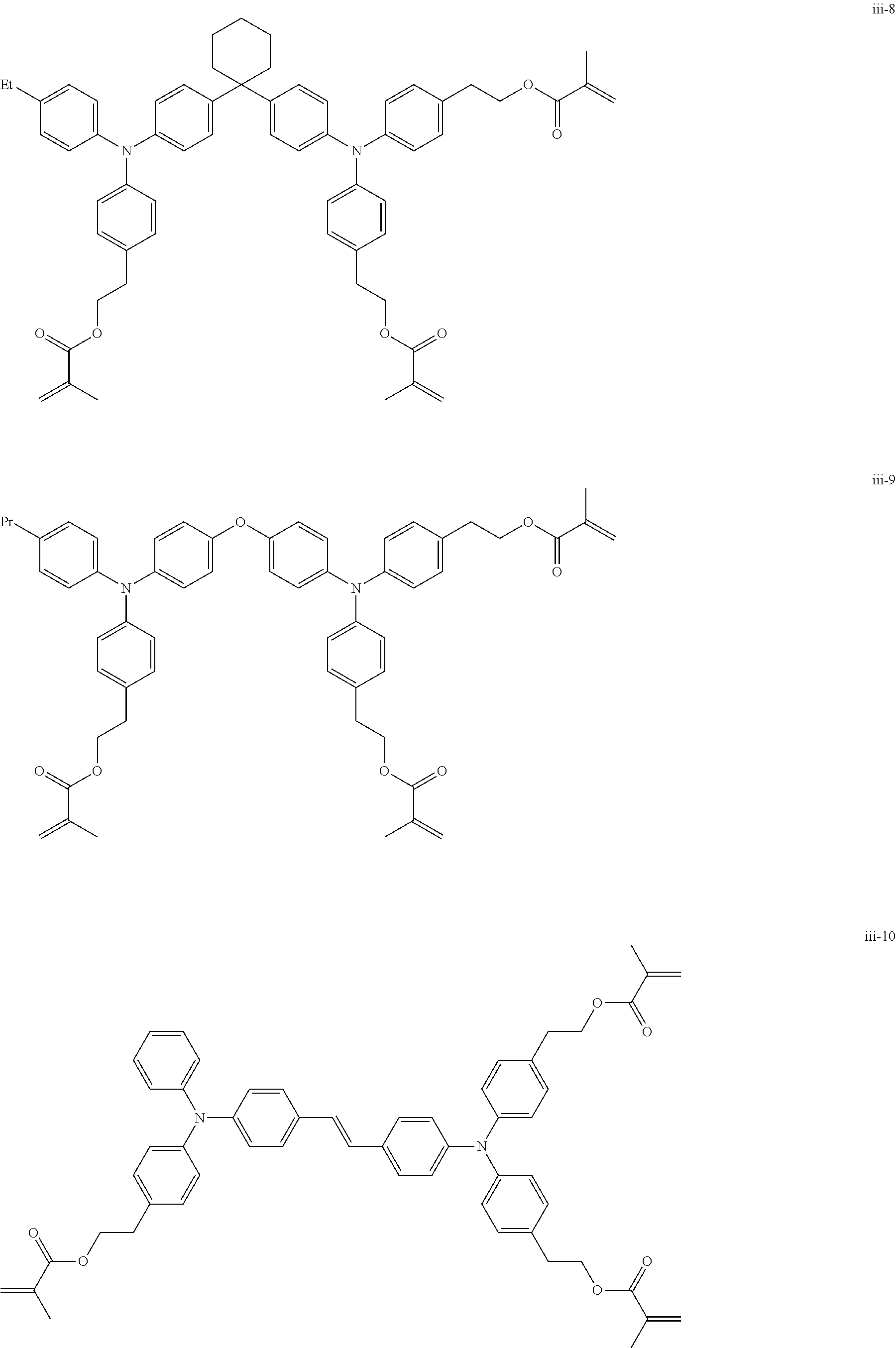

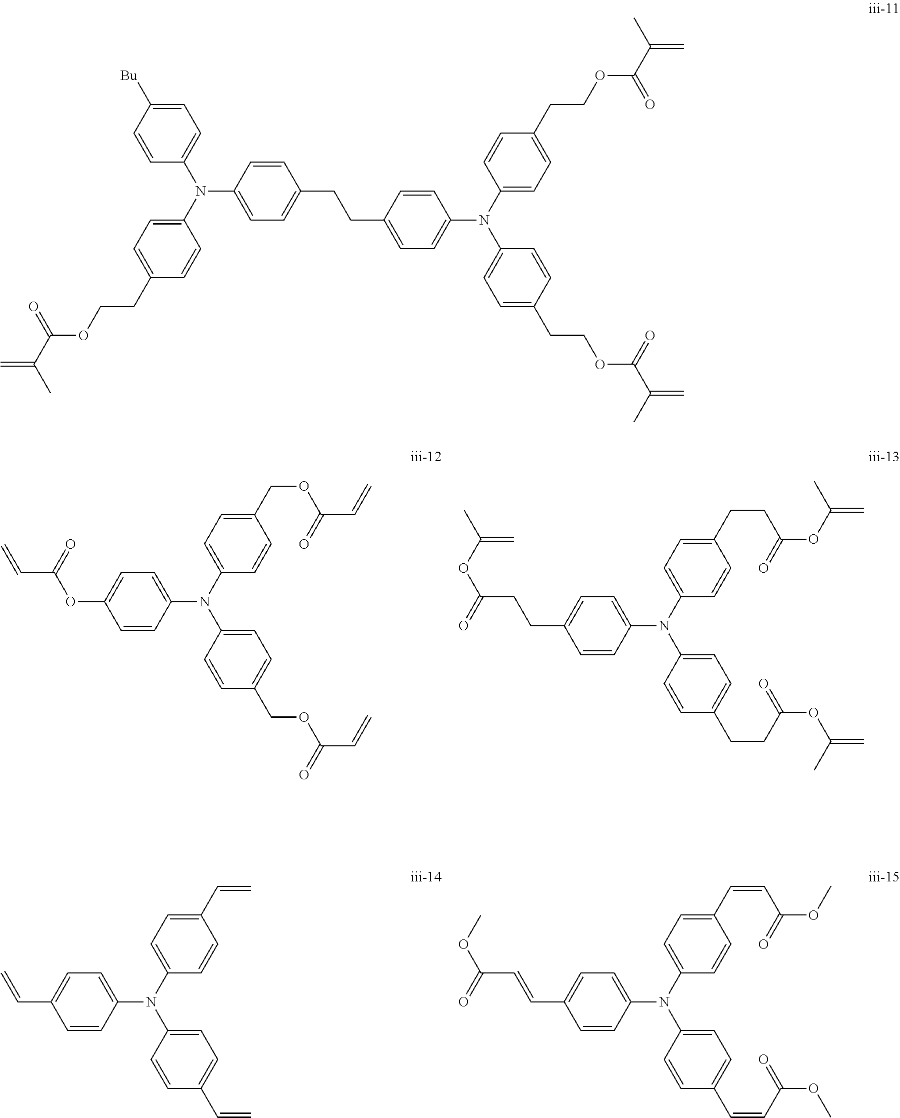

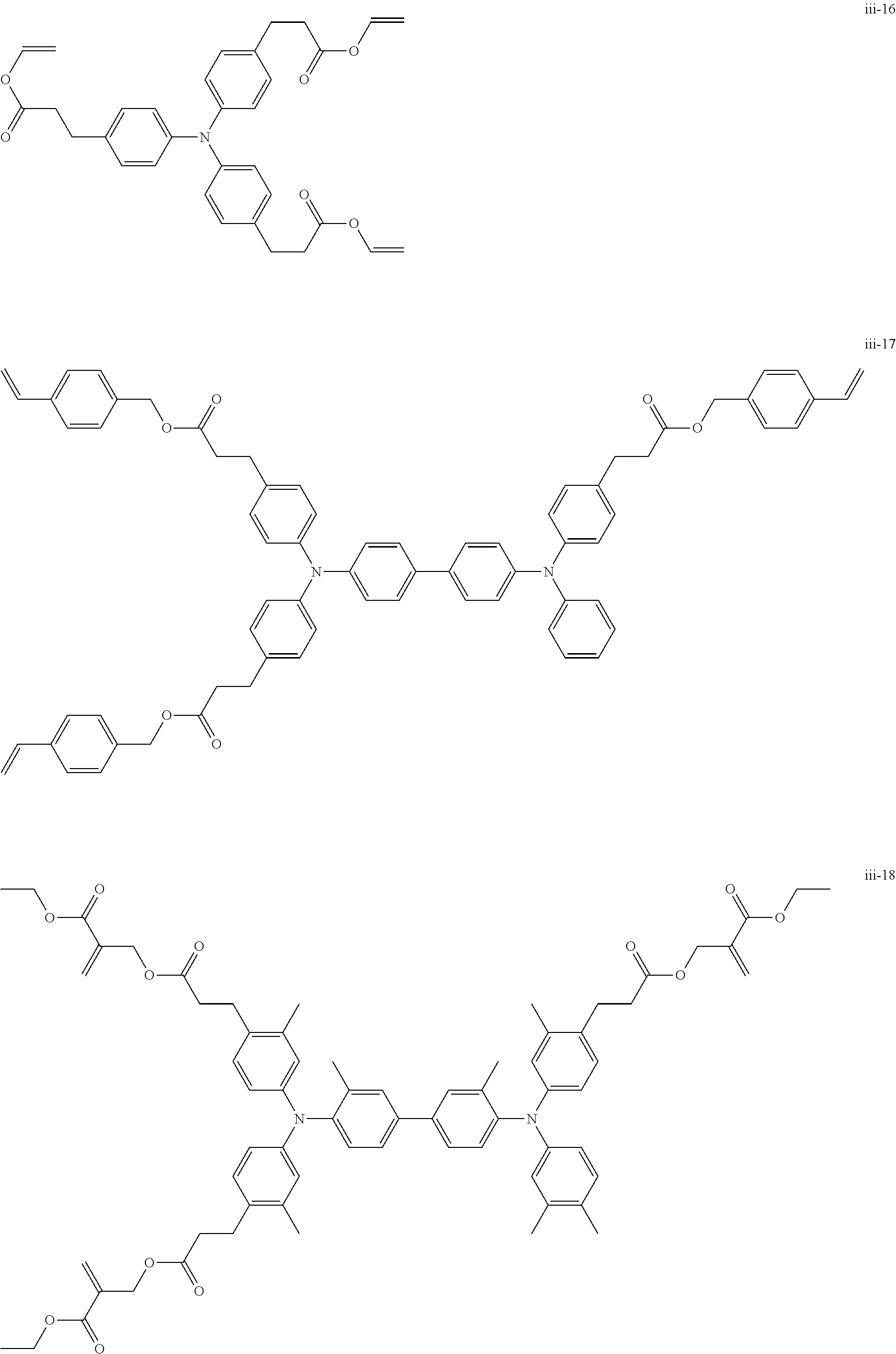

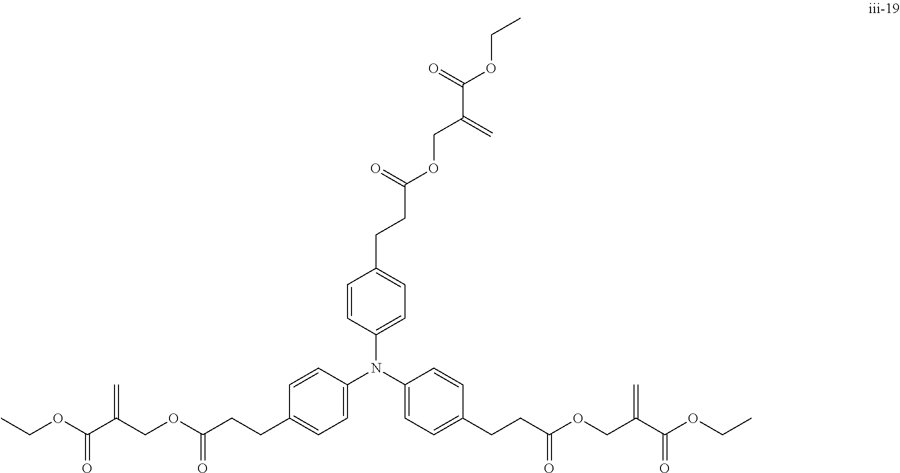

Furthermore, specific examples of a compound having 4 to 6 reactive functional groups each having a carbon double bond will be shown below, but the examples are not limited to these.

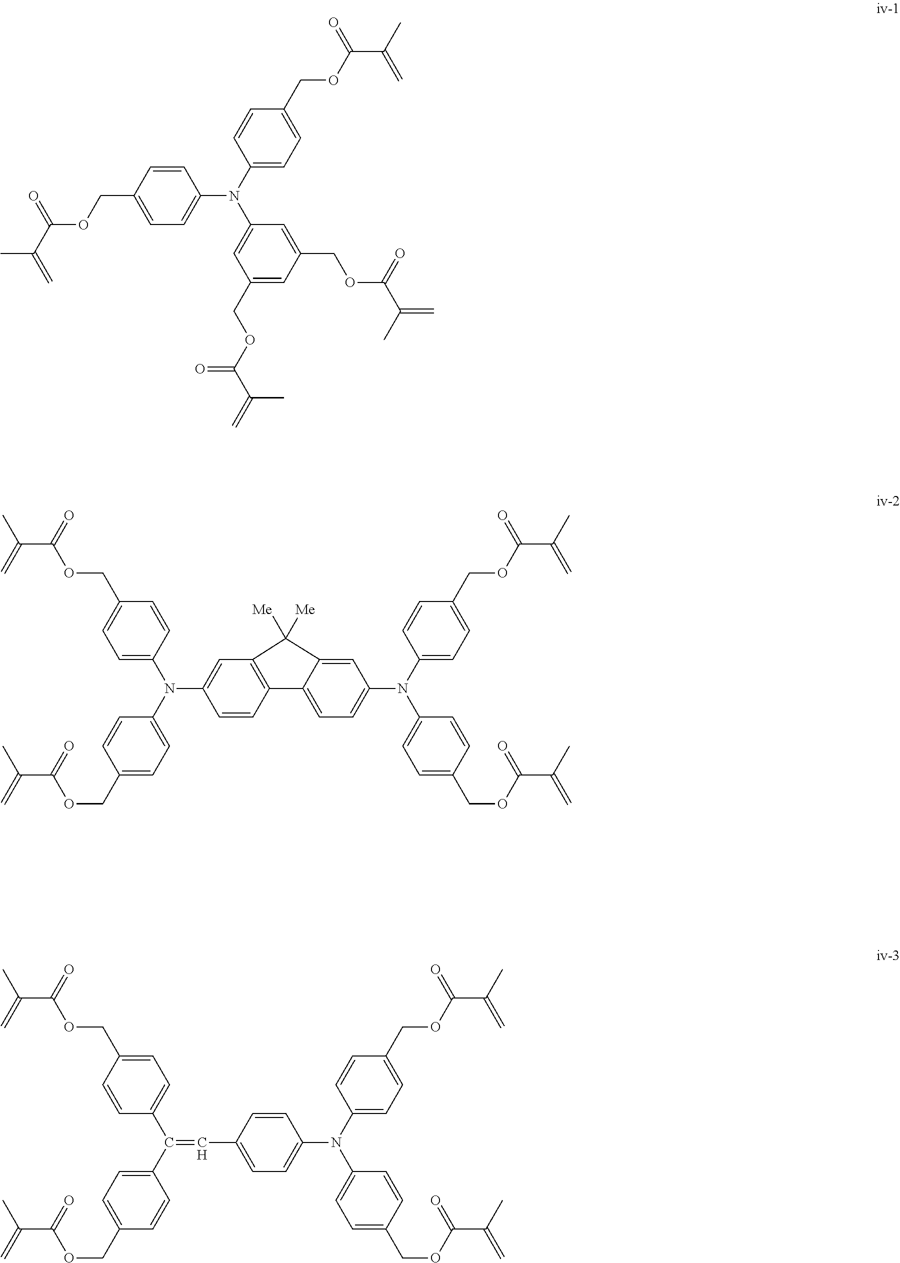

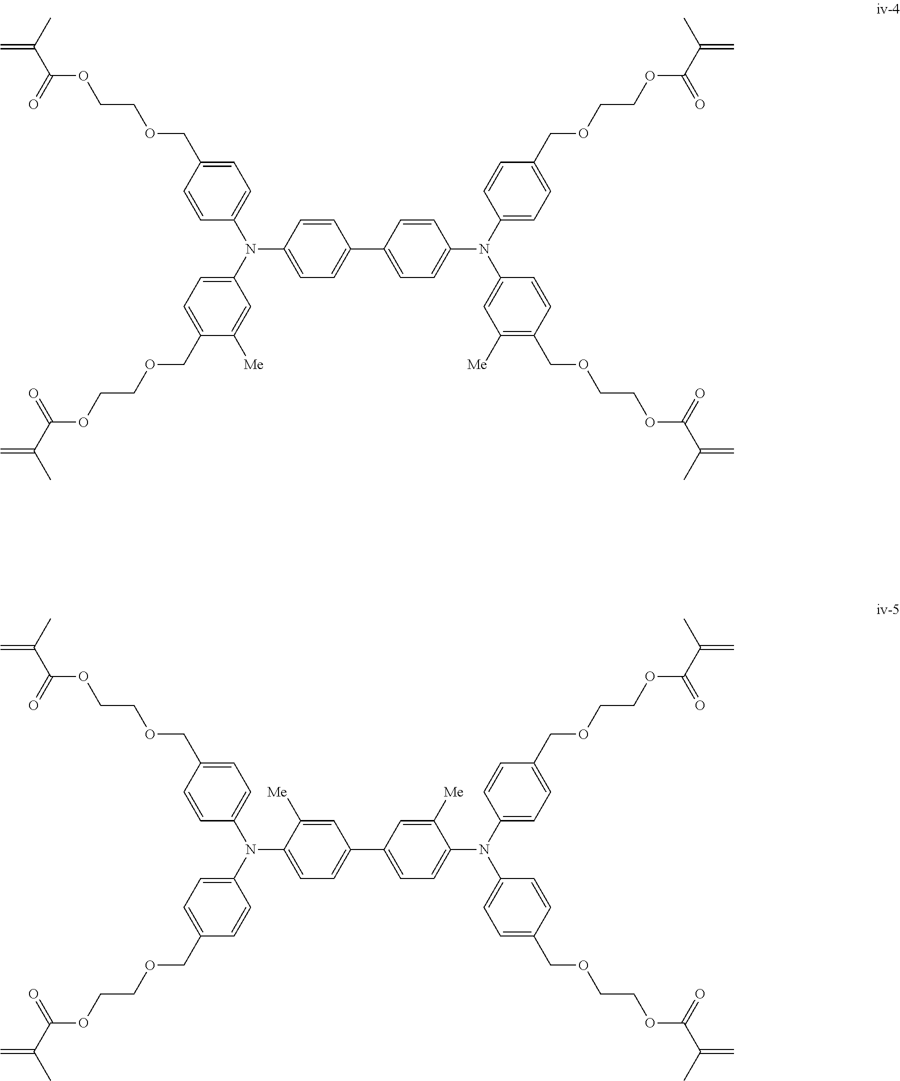

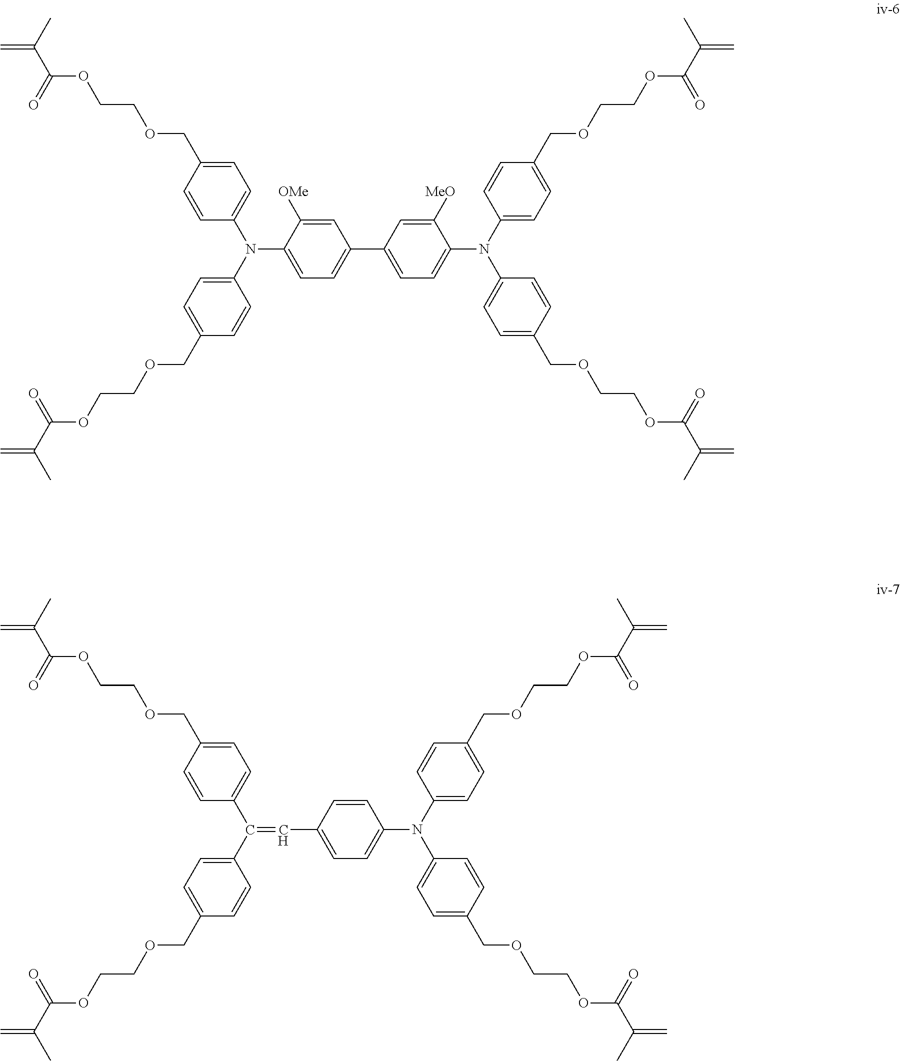

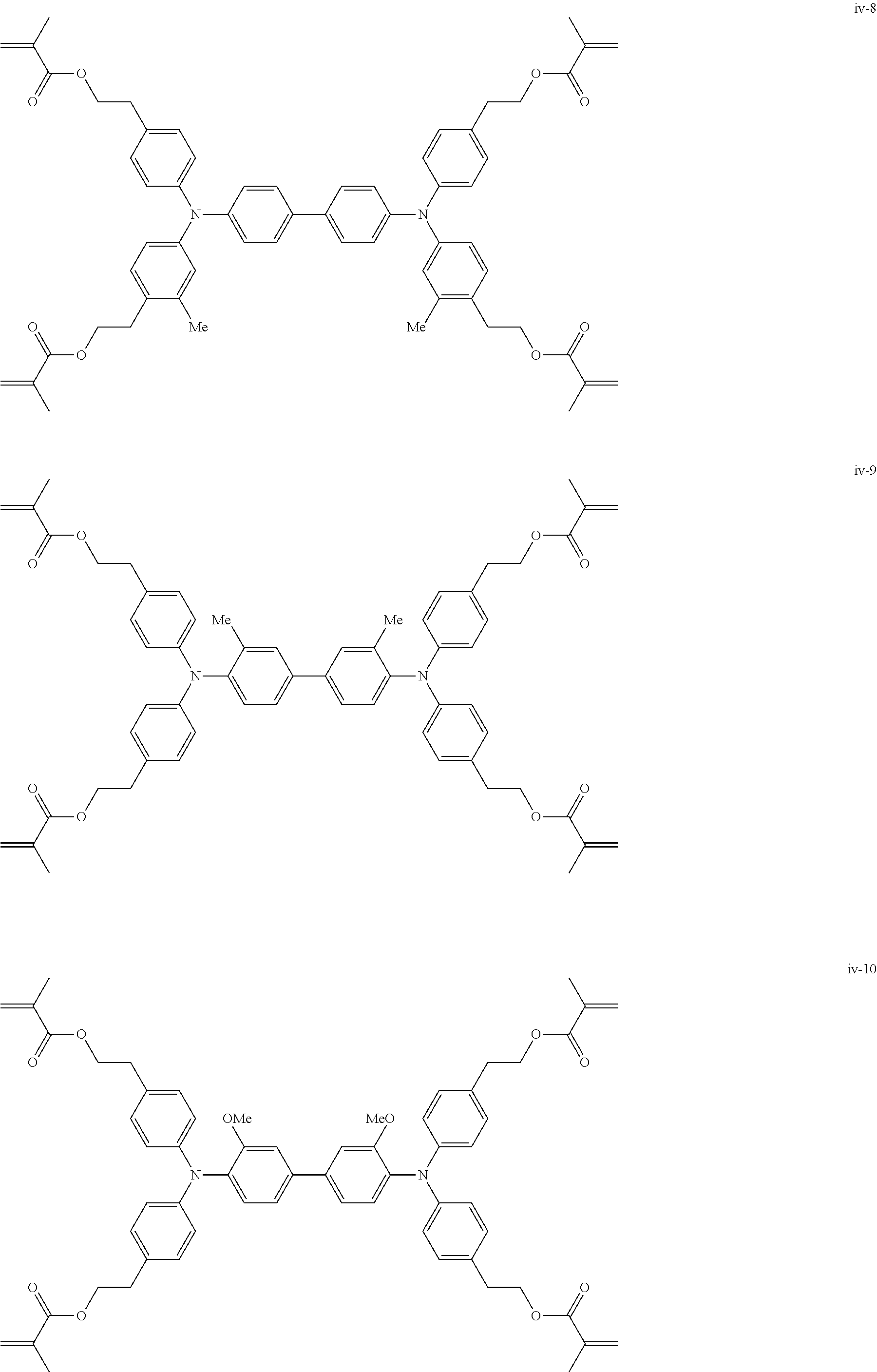

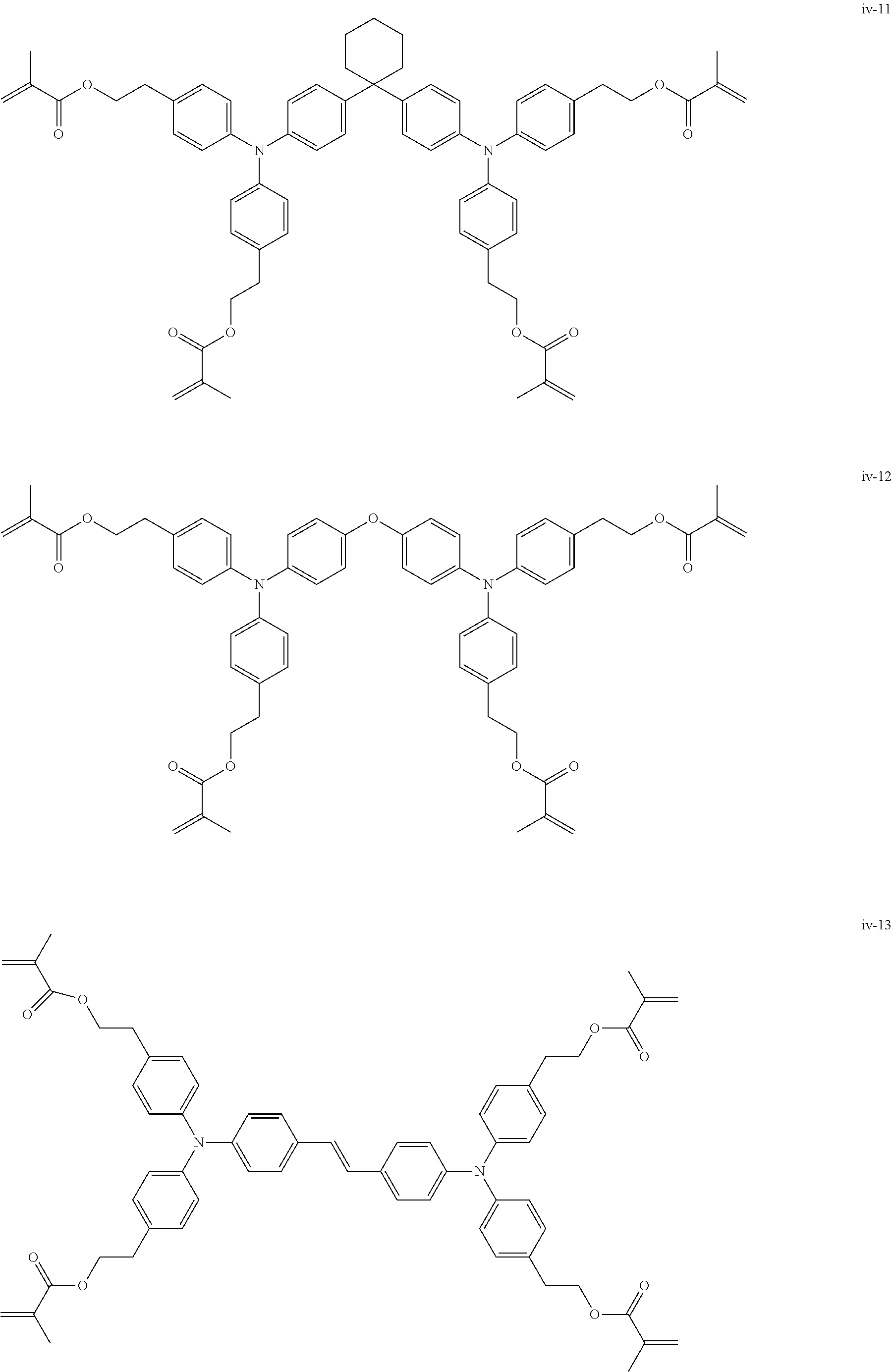

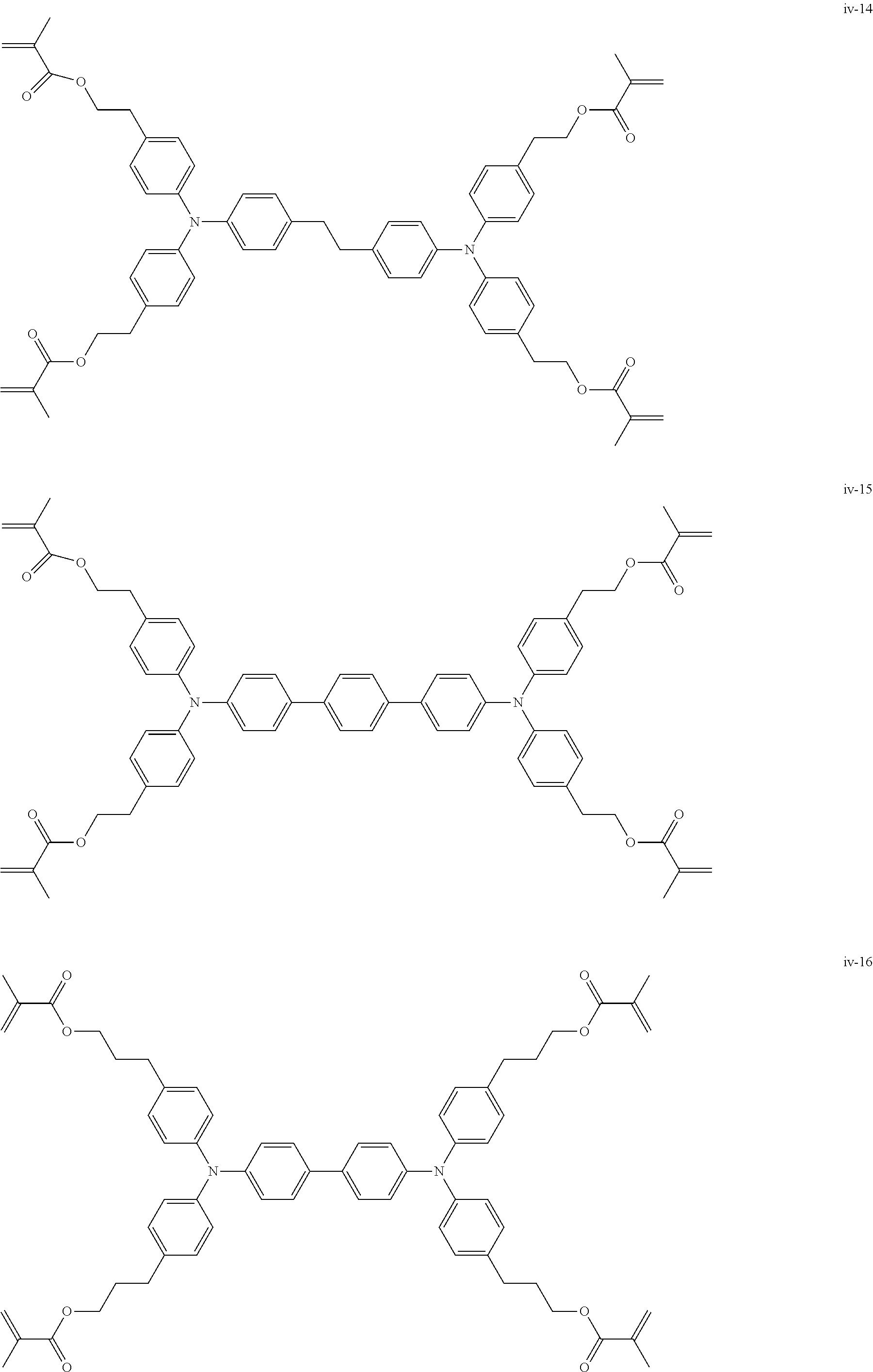

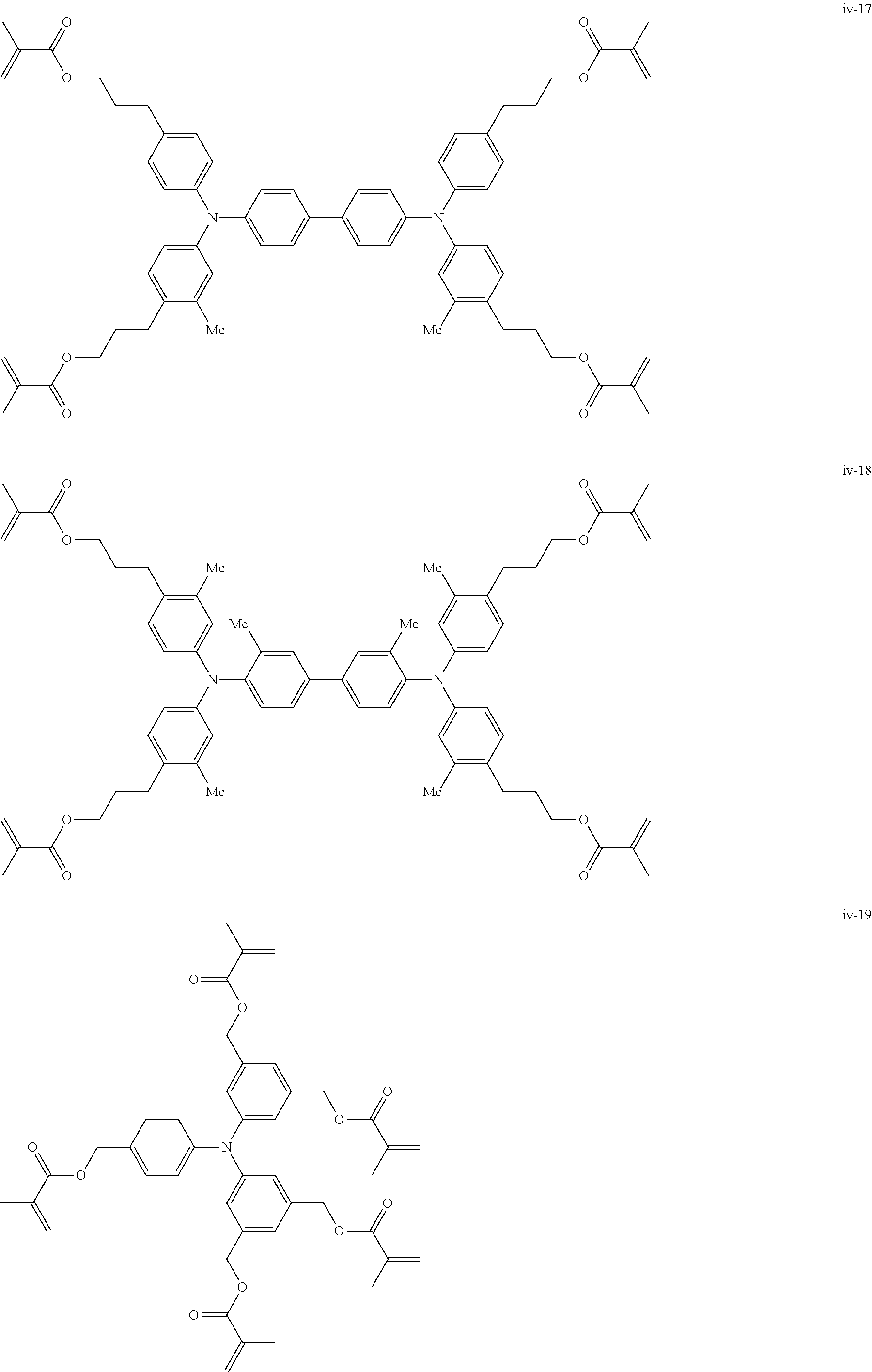

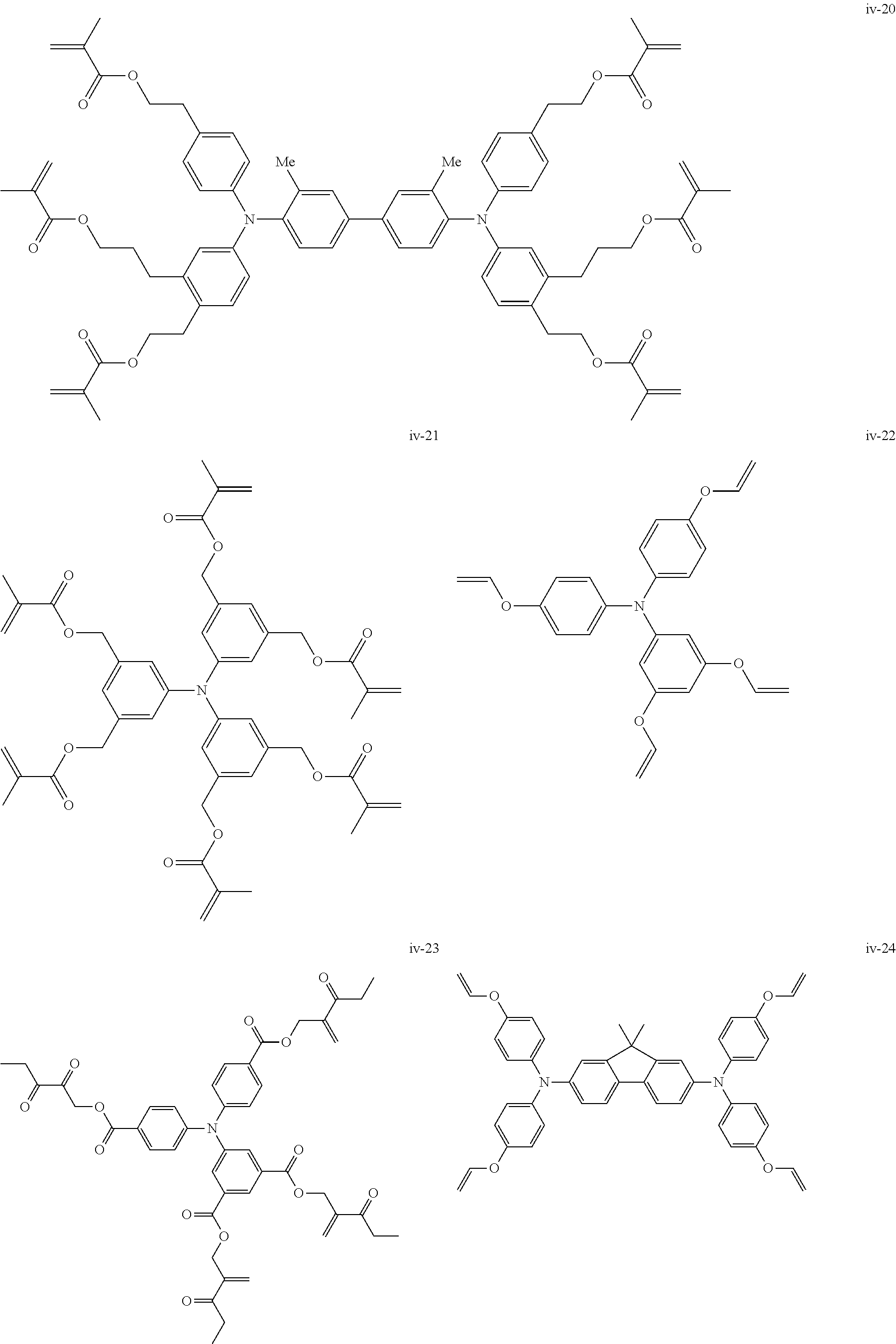

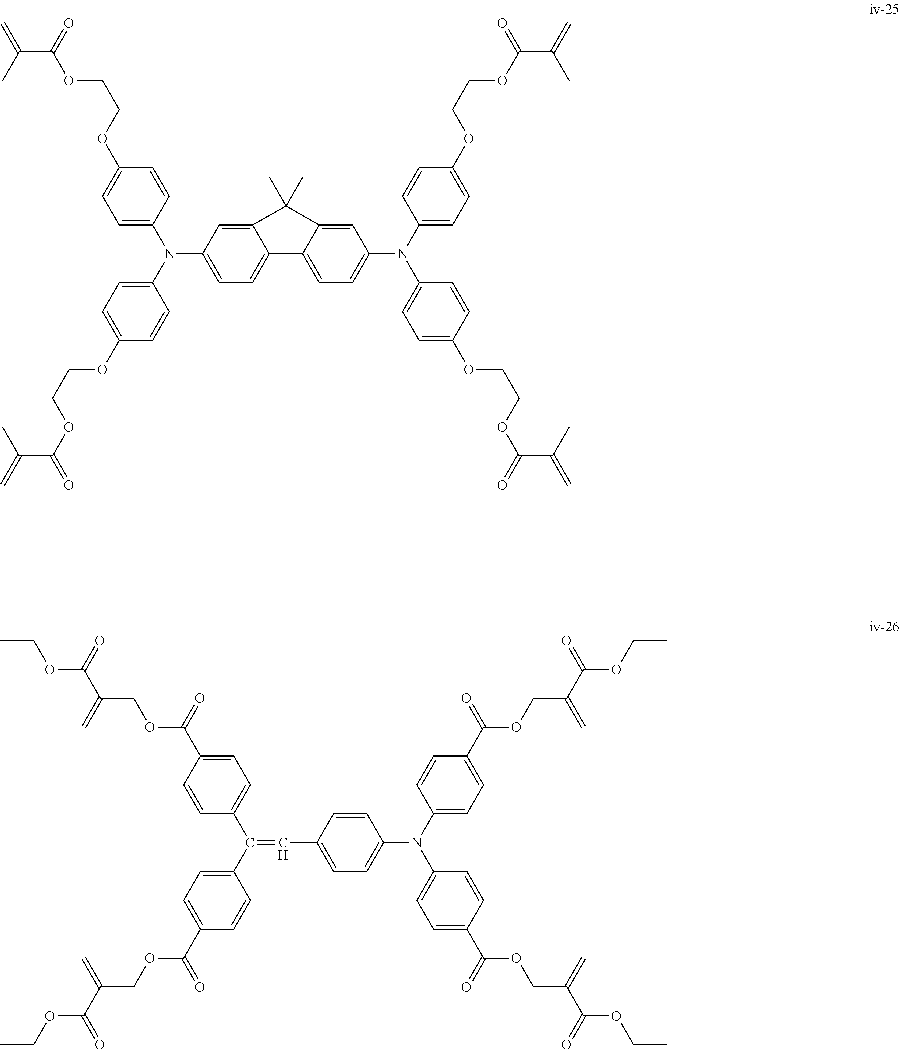

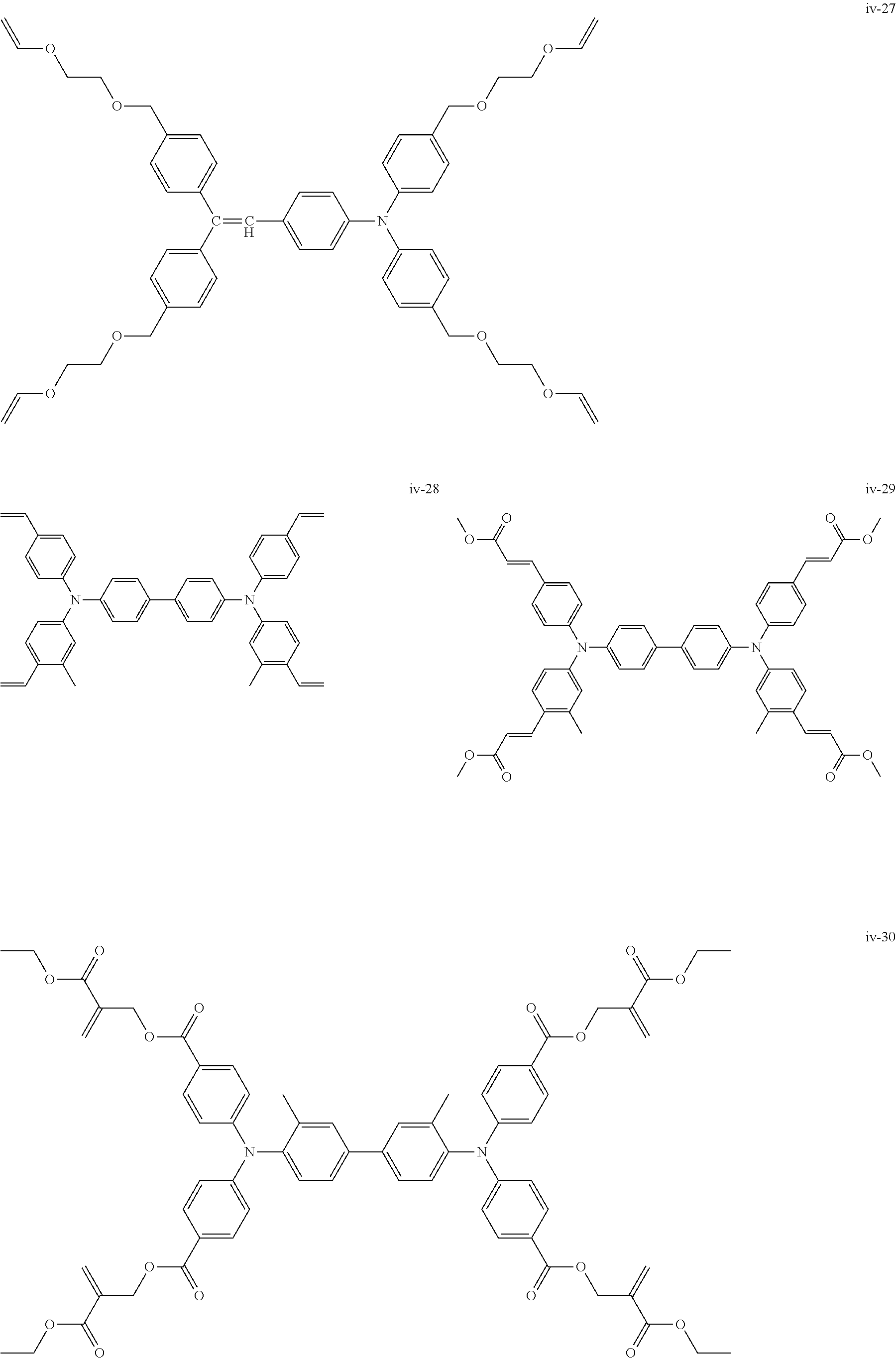

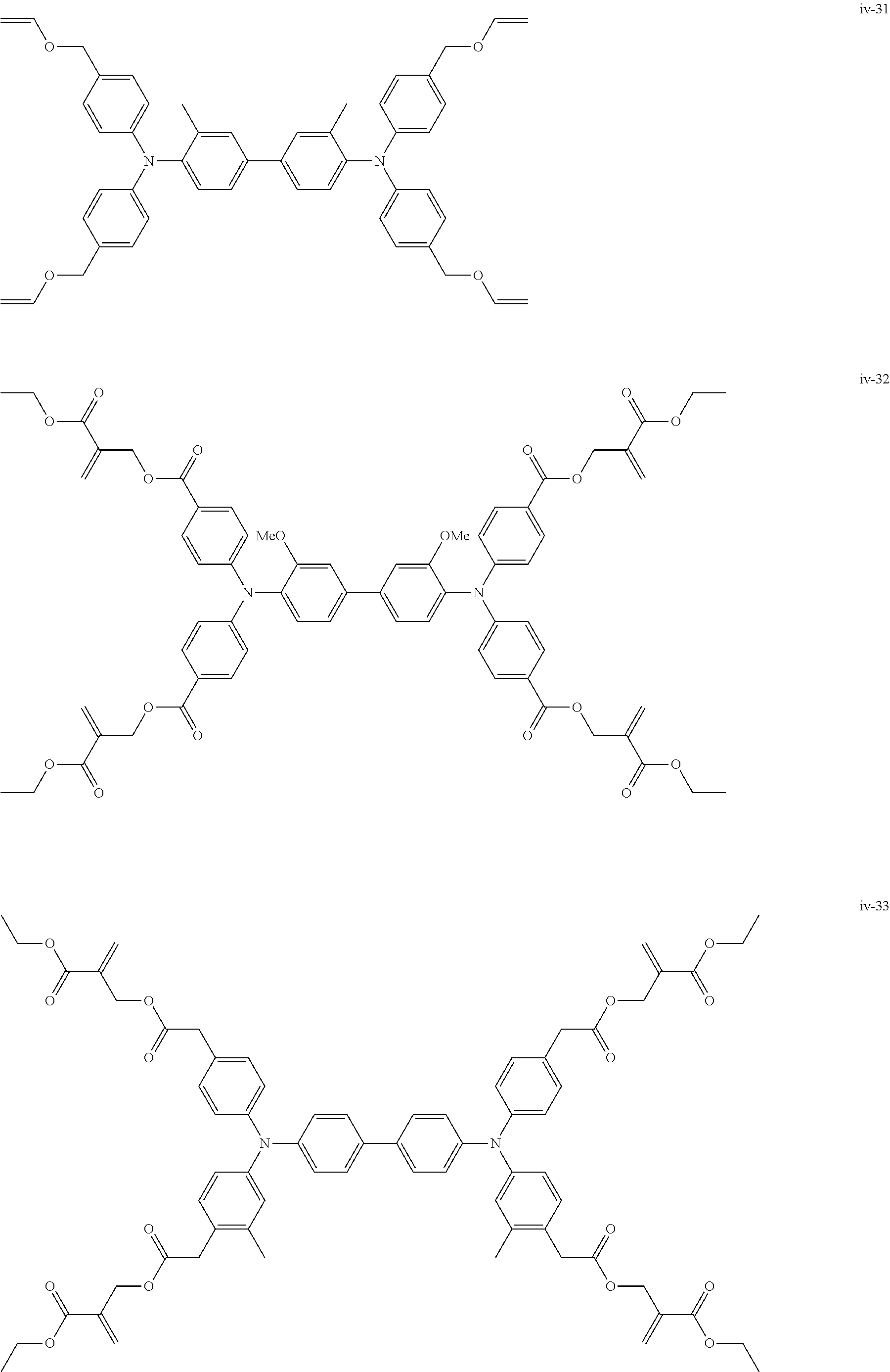

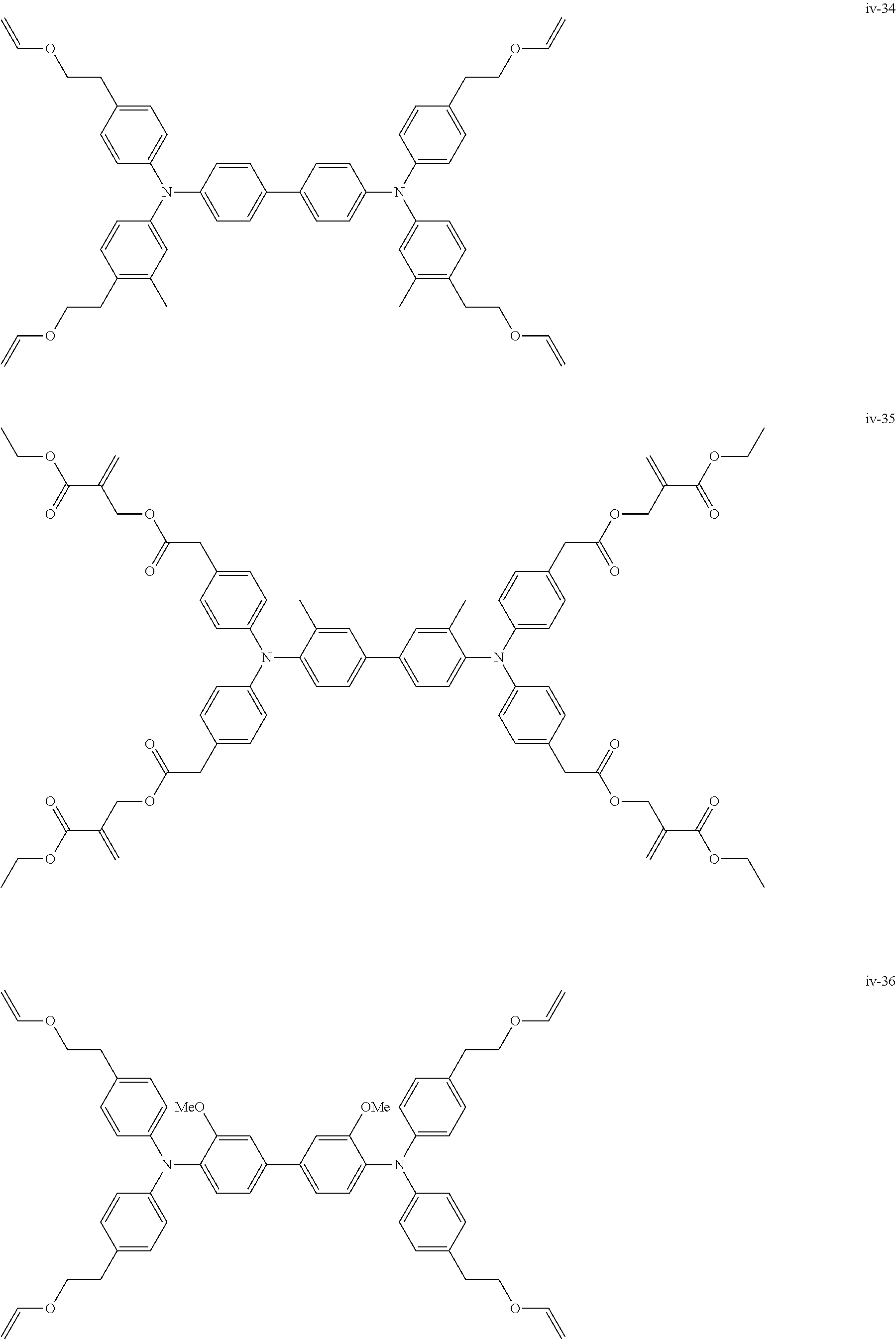

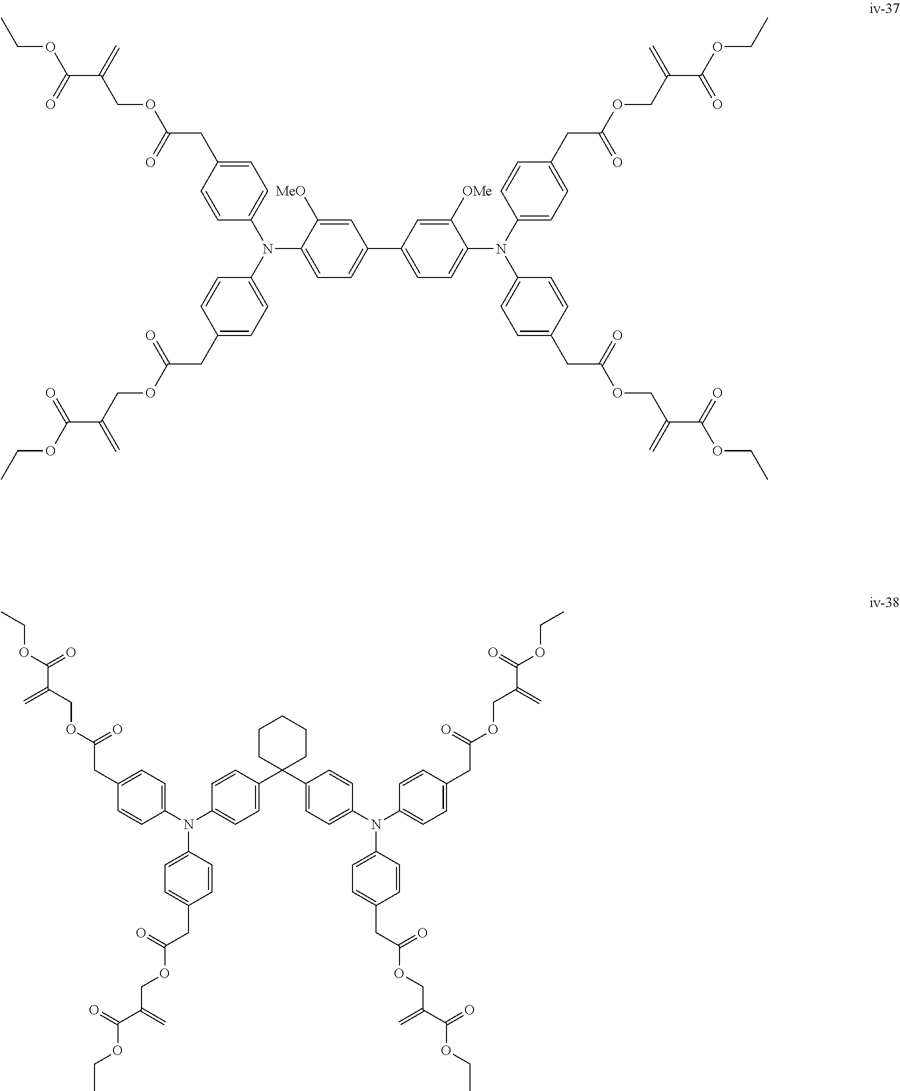

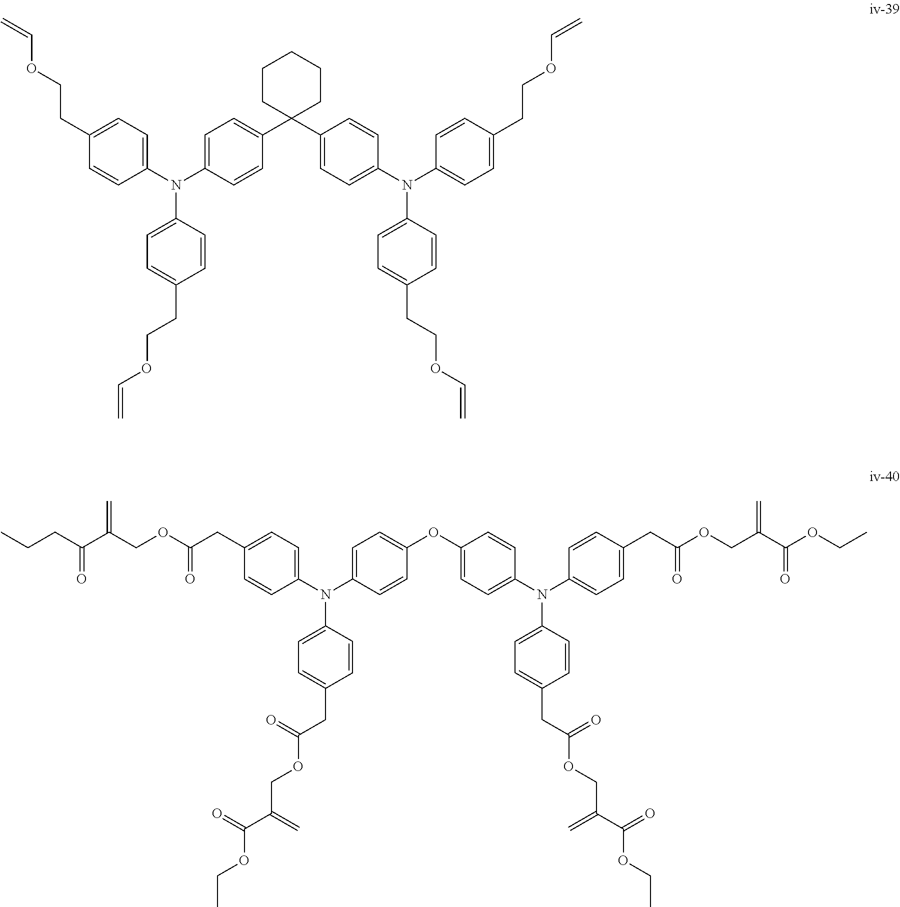

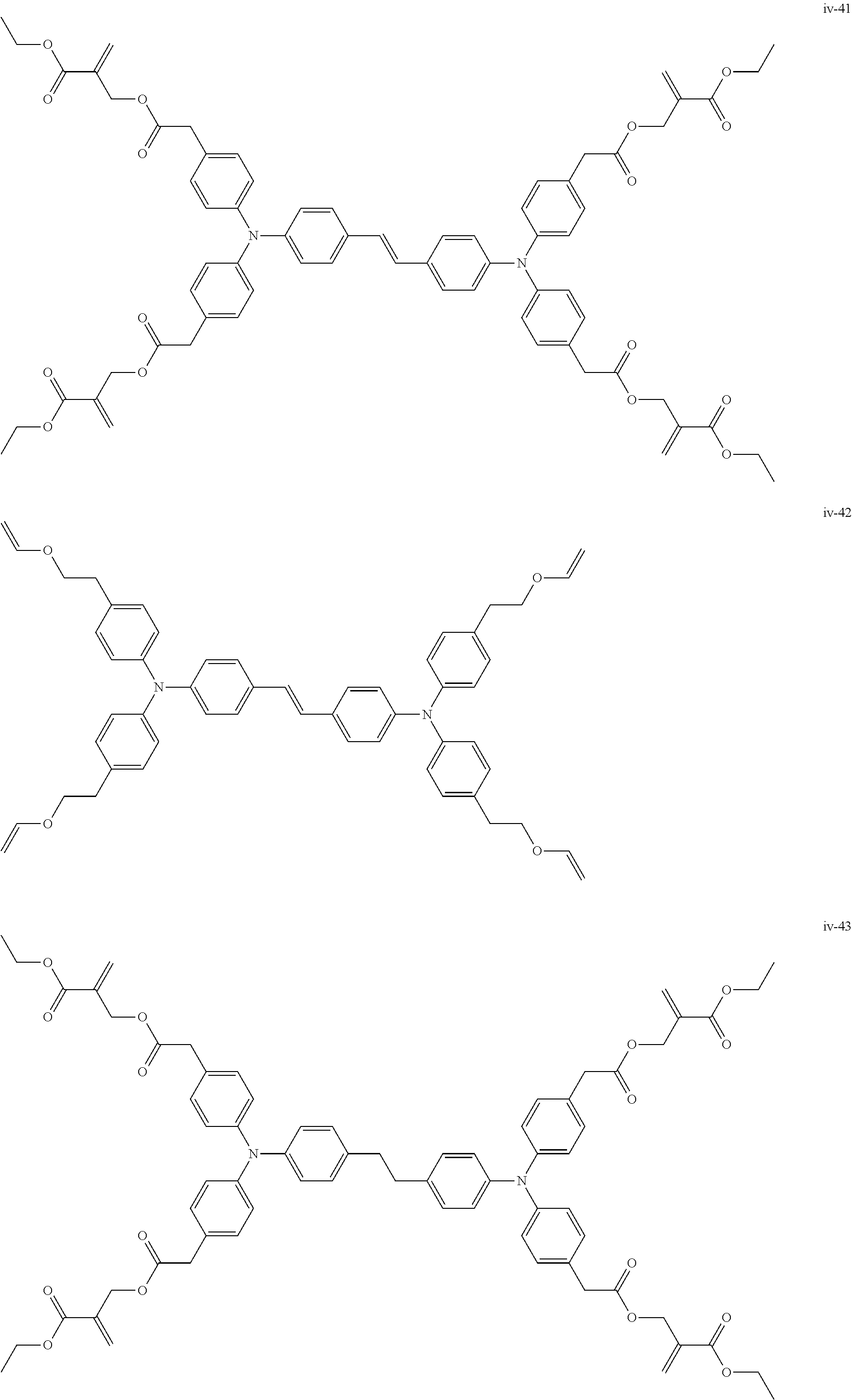

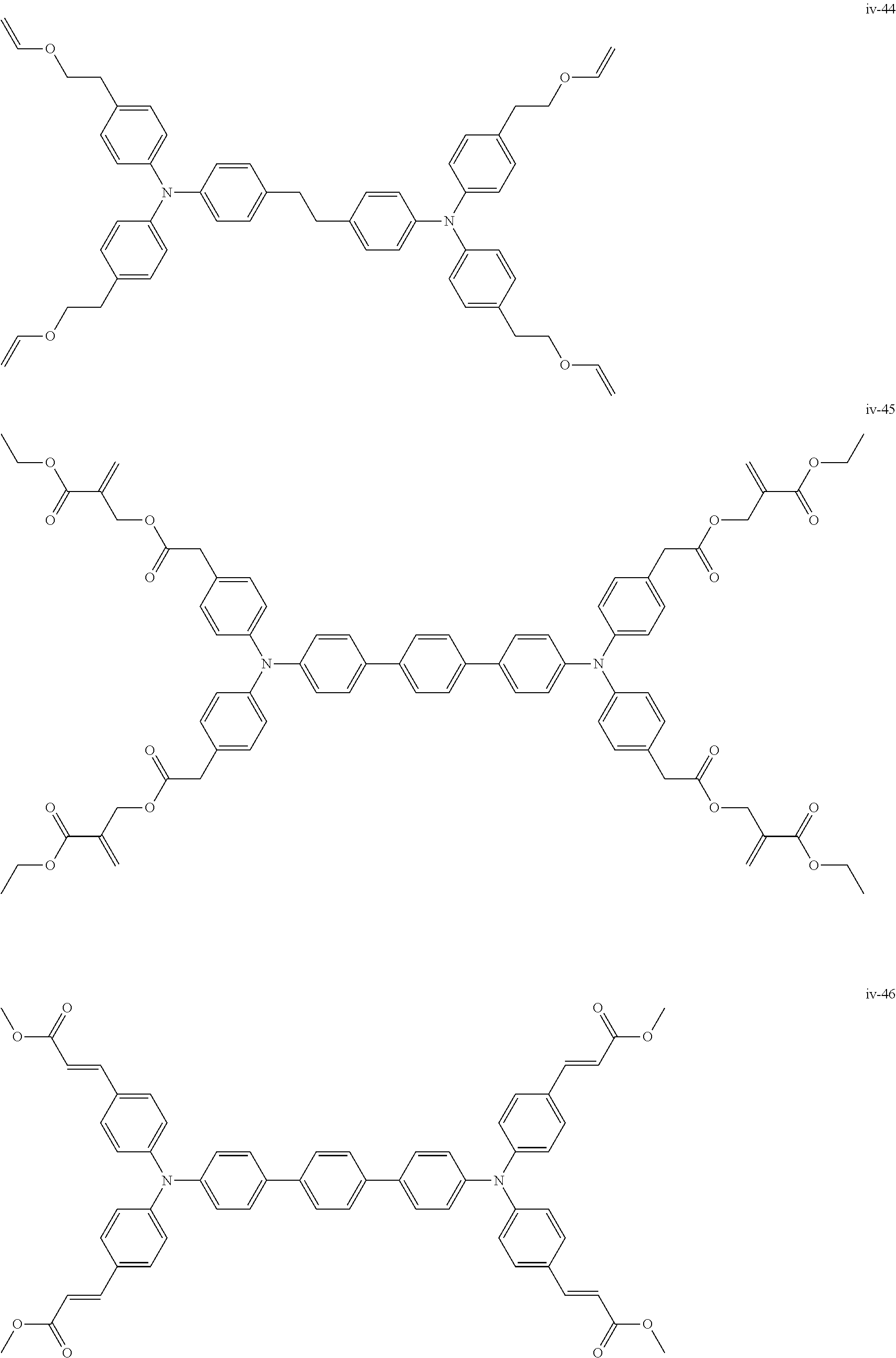

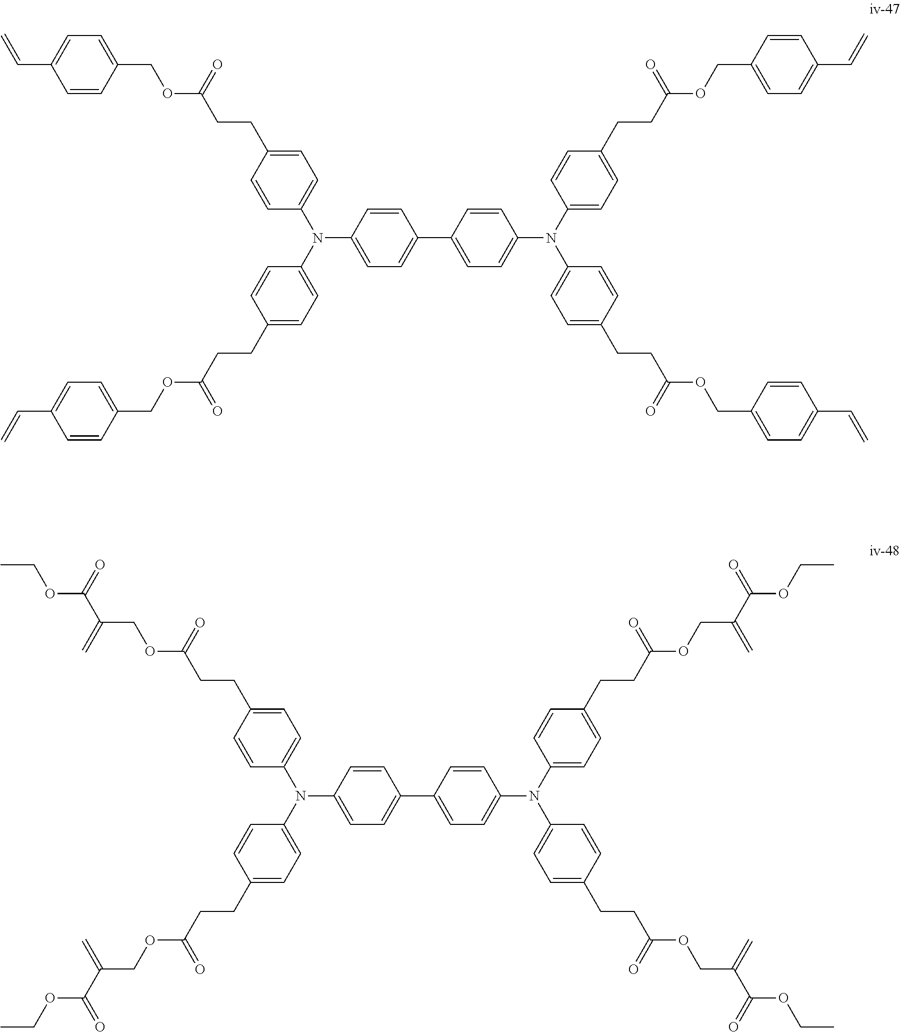

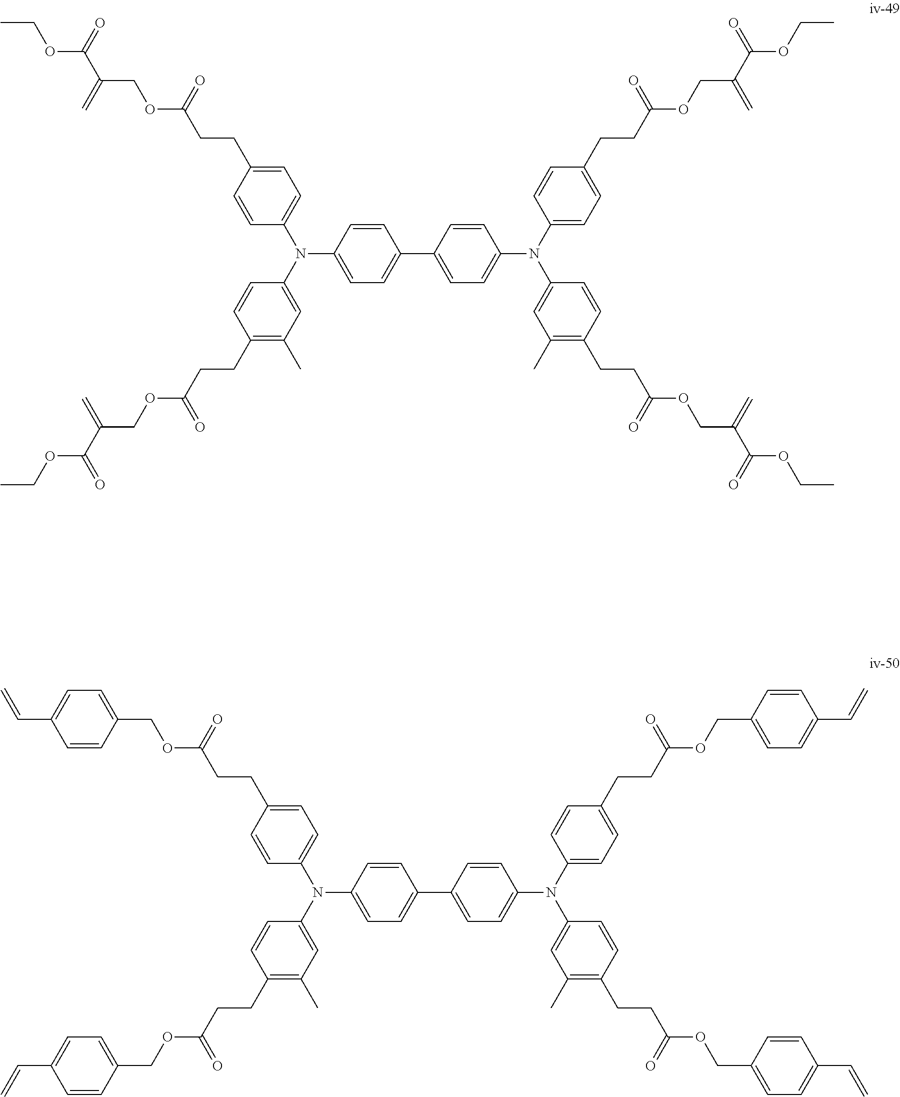

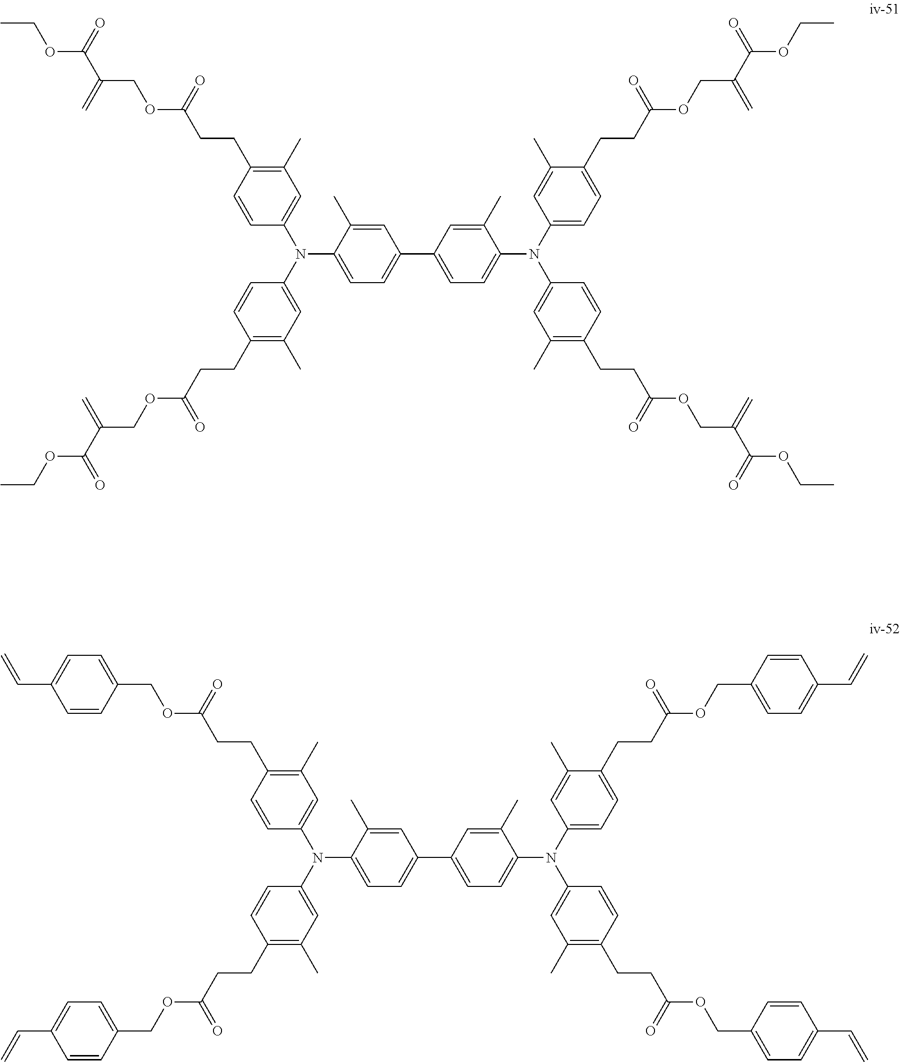

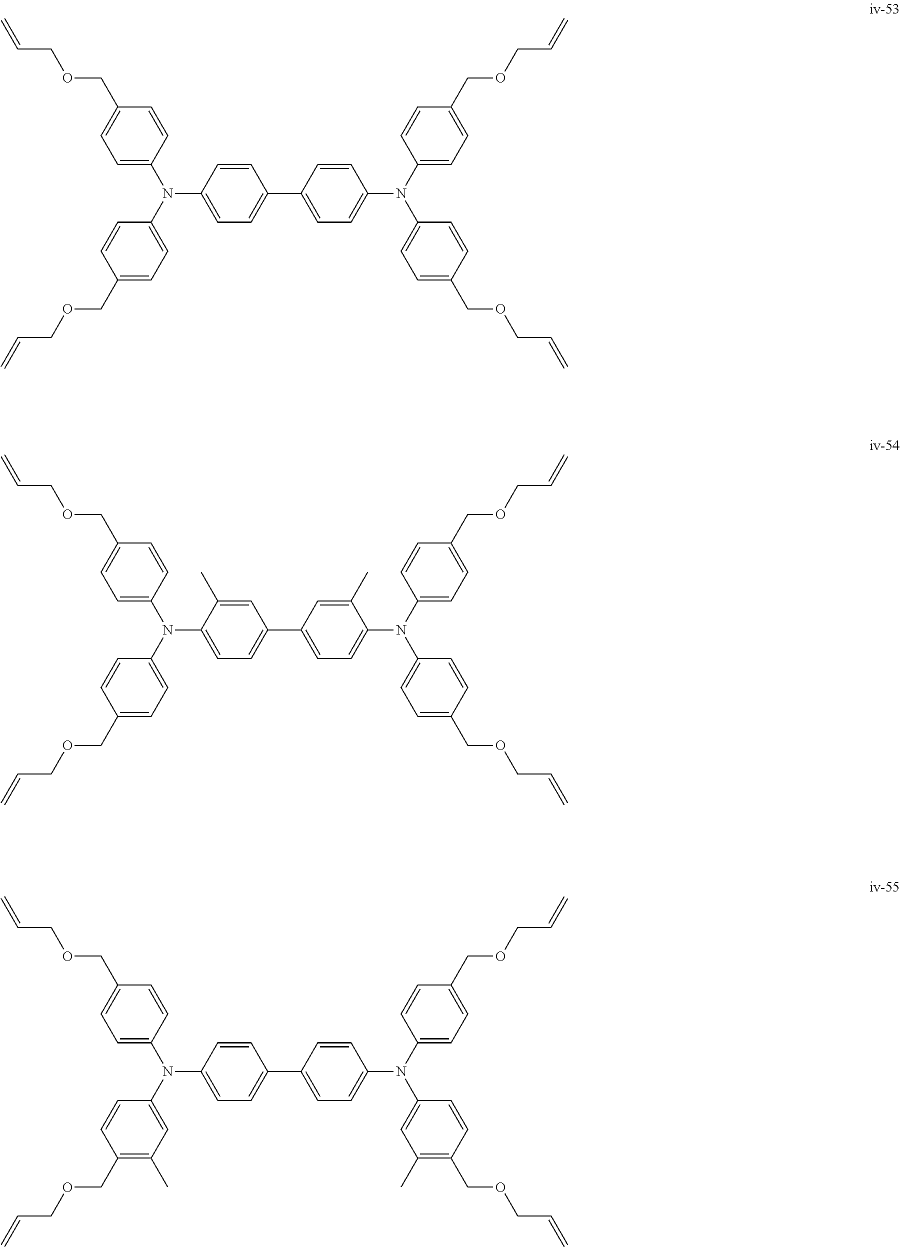

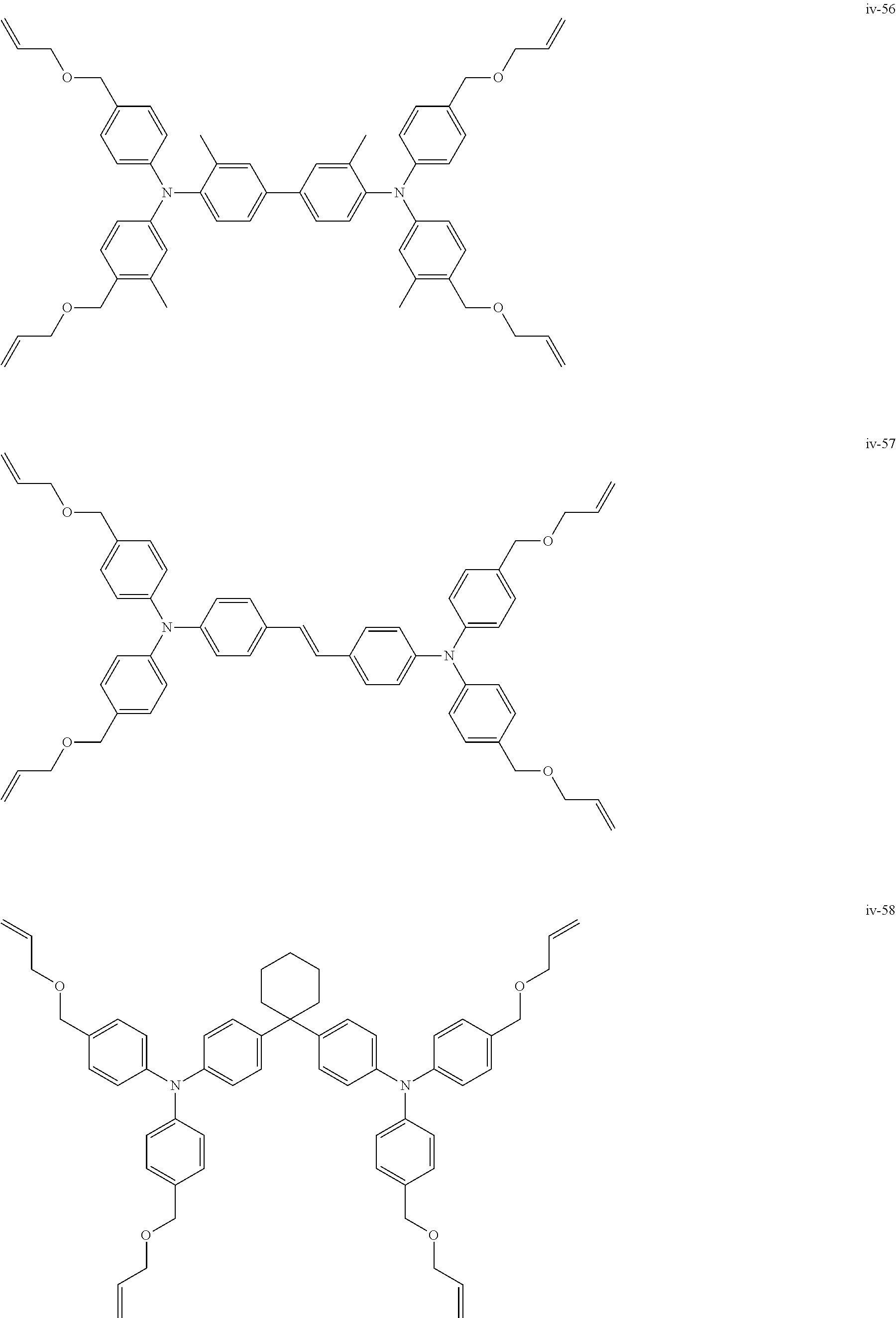

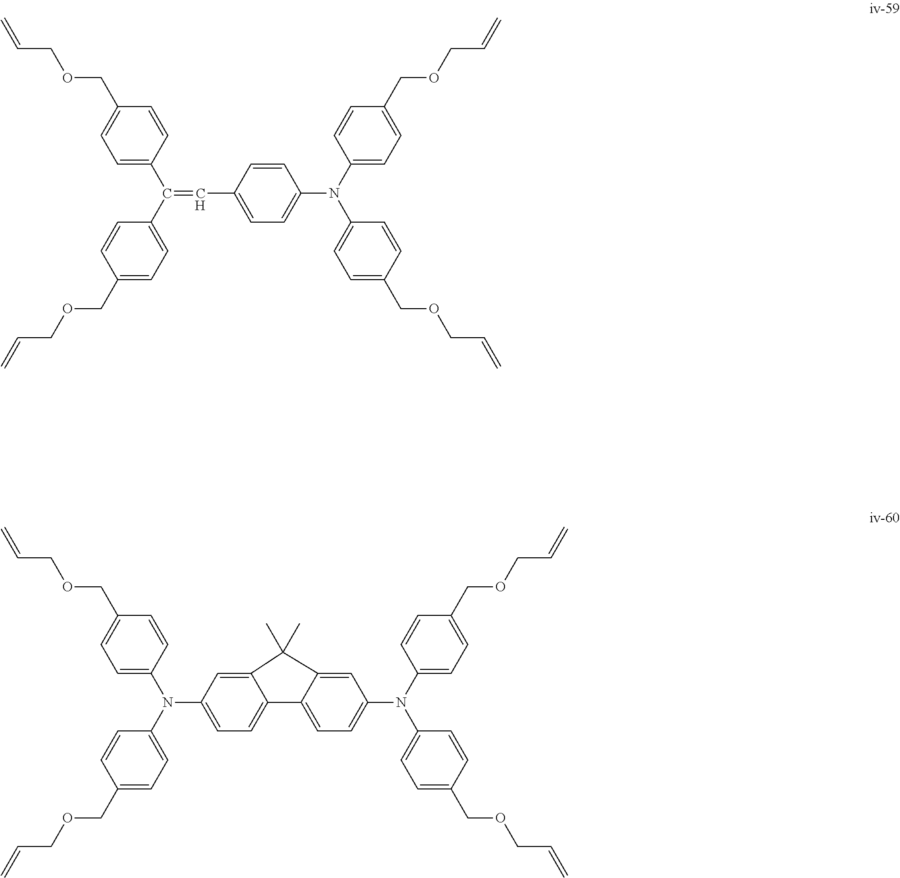

The compound of (I) is synthesized, for example, in the following manner.

That is, the compound of (I) is synthesized by, for example, condensing a precursor alcohol with a corresponding methacrylic acid or a methacrylic acid halide. A specific charge transporting material may be synthesized, for example, when the precursor alcohol has a benzyl alcohol structure, by dehydration etherification of the alcohol and a methacrylic acid derivative having a hydroxyl group, such as hydroxyethyl methacrylate.

The synthesis routes for the exemplary compound iv-4 and the exemplary compound iv-17 will be shown below as an example.

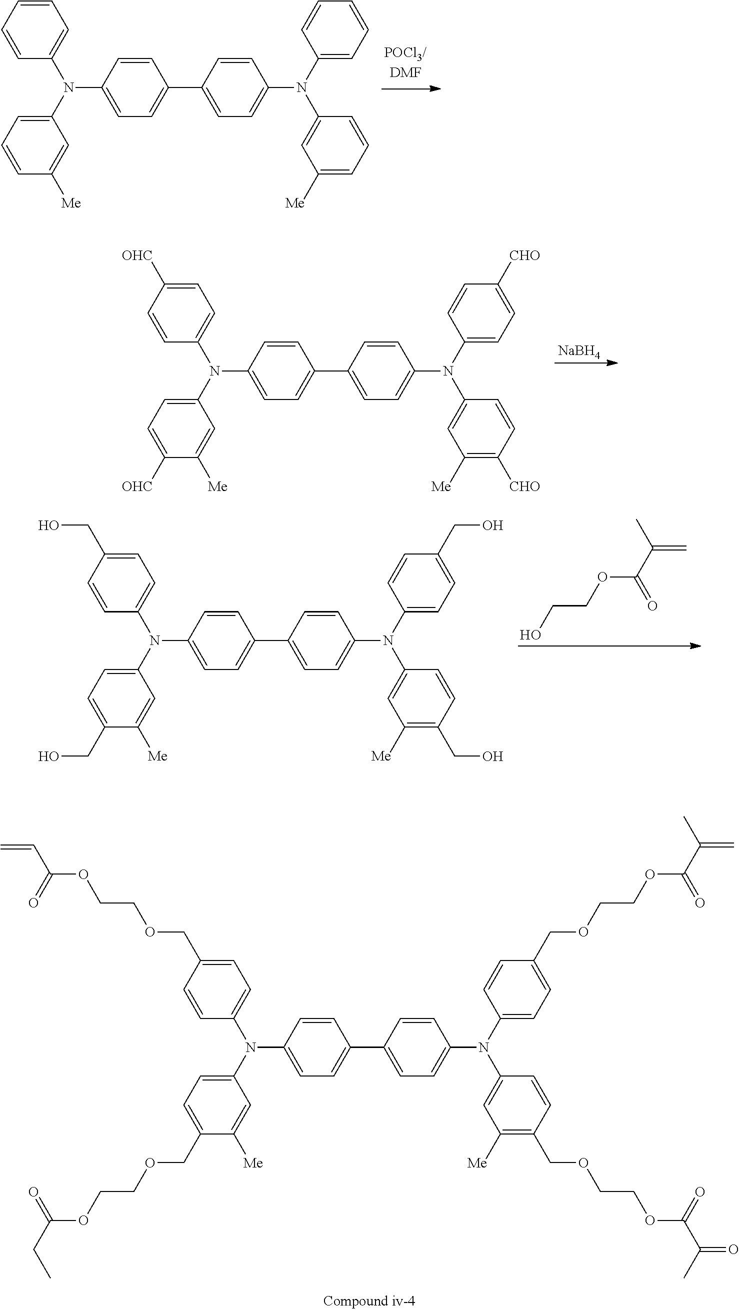

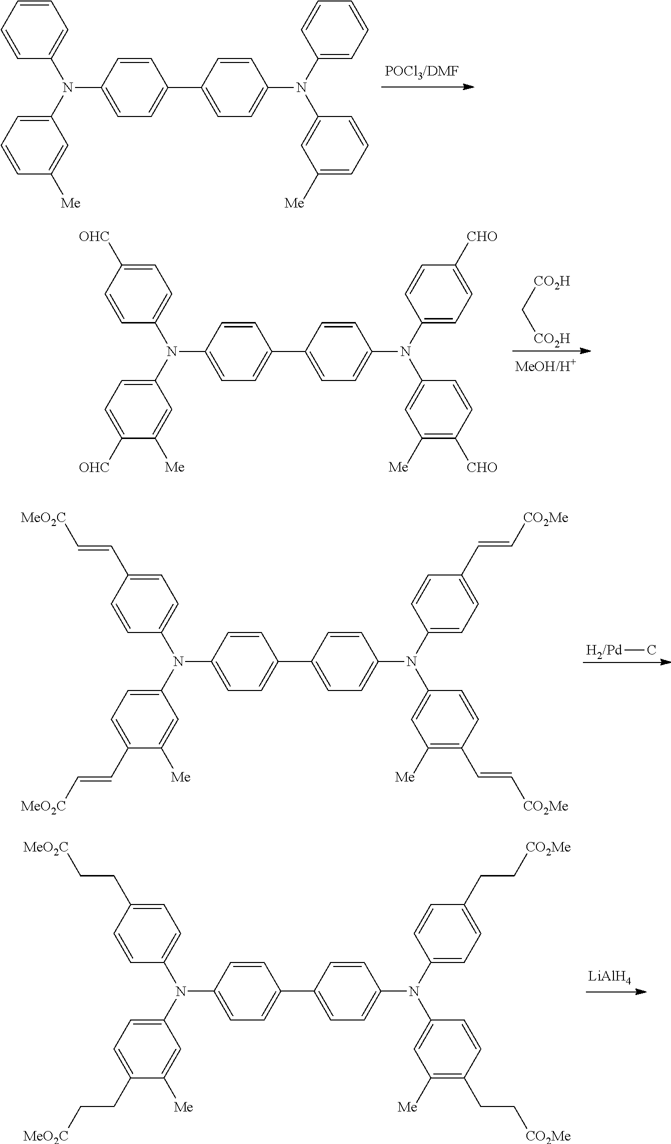

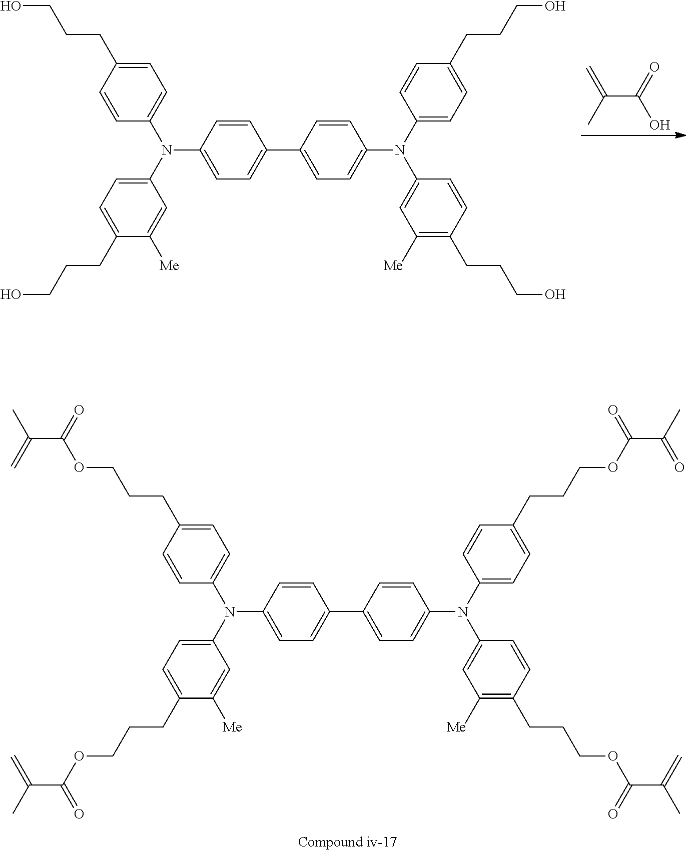

Other compounds of (I) are synthesized, for example, in the same manner as in the synthesis route for the compound iv-4 and the synthesis route for the compound iv-17.

As the compound of (I), it is desirable to use a compound containing 4 or more reactive functional groups each having a carbon double bond, from the viewpoint that the resulting film has improved mechanical strength, as described above.

Furthermore, a compound having 4 or more reactive functional groups each having a carbon double bond, and a compound containing from 1 to 3 reactive functional groups each having a carbon double bond may be used in combination as the compound of (I). When these compounds are used in combination, the strength of the film is adjusted while a decrease in the charge transport function is suppressed.

When a compound having 4 or more reactive functional groups each having a carbon double bond and a compound containing from 1 to 3 reactive functional groups each having a carbon double bond are used in combination as the compound of (I), the content of the compound having 4 or more reactive functional groups each having a carbon double bond may be adjusted to 5% by mass or greater, and particularly preferably 20% by mass or greater, based on the total content of the compounds of (I).

Next, other compounds of (I) will be described.

The compound of (I) may also be a polymer containing partial structures respectively represented by the following formulas (B) and (C).

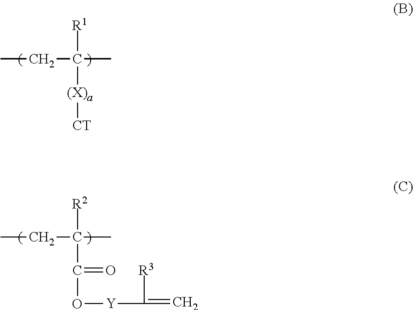

In the formulas (B) and (C), R¹, R² and R³ each independently represent a hydrogen atom or an alkyl group having from 1 to 4 carbon atoms; X and Y each independently represent a divalent organic group having from 1 to 20 carbon atoms; a represents 0 or 1; and CT represents an organic group having a charge transporting skeleton.

Here, the terminal group of the polymer containing partial structures respectively represented by the formulas (B) and (C) is a structure generated by a termination reaction resulting from a radical polymerization reaction.

In the formula (B), the organic group having a charge transporting skeleton as represented by CT may be the charge transporting skeleton described above, but suitable examples include organic groups having a triarylamine skeleton, a benzidine skeleton, an arylalkane skeleton, an aryl-substituted ethylene skeleton, a stilbene skeleton, an anthracene skeleton, and a hydrazone skeleton. However, among these, organic groups having a triarylamine skeleton, a benzidine skeleton and a stilbene skeleton are desirable.

In the formulas (B) and (C), the divalent organic group represented by X and Y may be, for example, a divalent group containing any one selected from an alkylene group, —C(═O)—, —O—C(═O)—, an aromatic ring, and linking groups combining these. It is desirable that the divalent organic group represented by X and Y does not have a hydroxyl group.

A specific example of the divalent organic group represented by X may be —C(═O)—O—(CH₂)ₙ— (provided that n represents 0 or an integer from 1 to 10).

Specific examples of the divalent organic group represented by Y include —(CH)ₙ— (provided that n represents an integer from 1 to 10), —(CH₂)ₙ—O—C(═O)— (provided that n represents 0 or an integer from 1 to 10, and a portion of the hydrogen atoms of “(CH₂)ₙ” may be substituted by hydroxyl groups), —(CH₂)ₙ—Ar— (provided that Ar represents an arylene group having from 1 to 5 aromatic rings, and n represents 0 or an integer from 1 to 10), —Ar—O—(CH₂)ₙ—O—C(═O)— (provided that Ar represents an arylene group having from 1 to 5 aromatic rings, and n represents 0 or an integer from 1 to 10).

Specific examples of the partial structure represented by the formula (B) include the following structures, but the examples are not limited to these. When the symbol “-” appears in the column for “(X)ₐ”, the symbol “-” represents that a=0; and when a group appears in the corresponding column, the group represents the group represented by X together with CT when a=1.

| | R¹ | (X)ₐ | CT |
|---|---|---|---|
| (B)-1 | H | — | 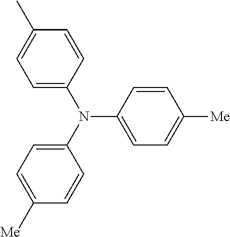 |
| (B)-2 | H | — | 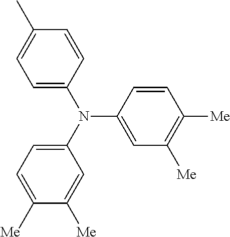 |
| (B)-3 | H | — | 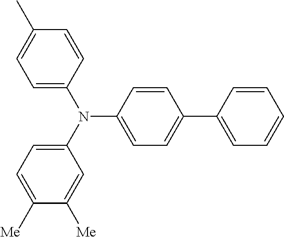 |
| (B)-4 | H | — | 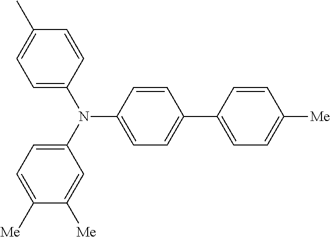 |
| (B)-5 | H | — | 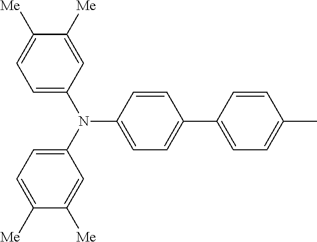 |
| (B)-6 | H | — | 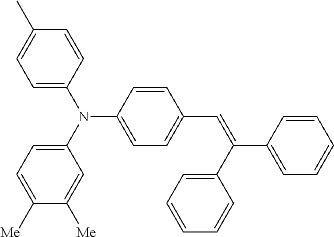 |
| (B)-7 | H | — | 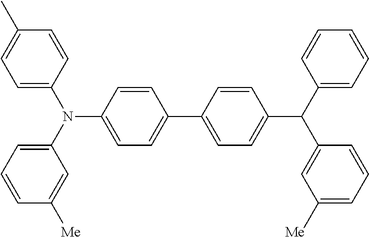 |
| (B)-8 | H | — | 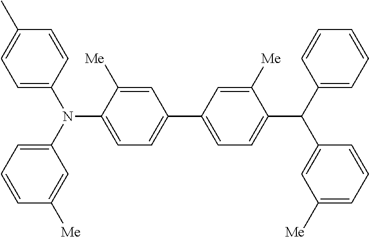 |
| (B)-9 | H | — | 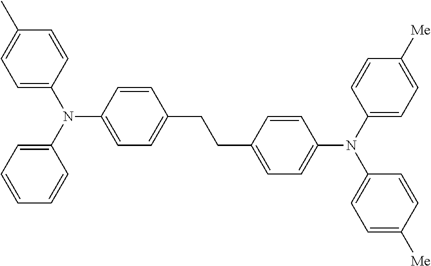 |
| (B)-10 | H | — | 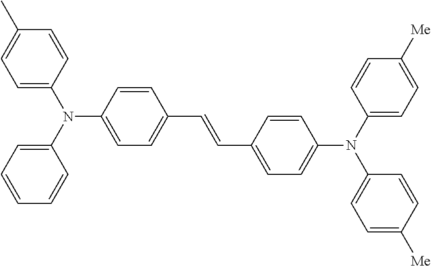 |
| (B)-11 | H | — | 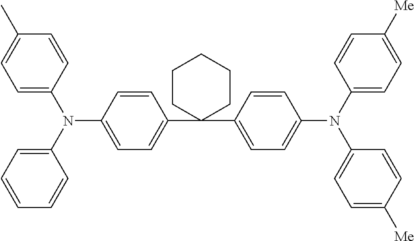 |
| (B)-12 | H | 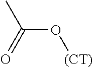 | 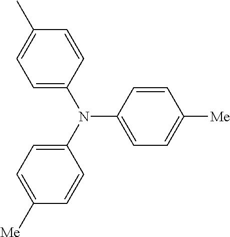 |
| (B)-13 | H | 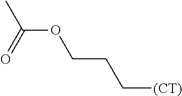 | 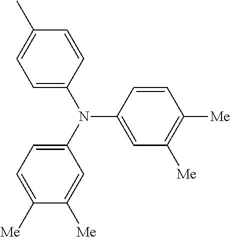 |
| (B)-14 | H | 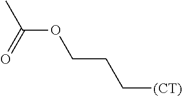 | 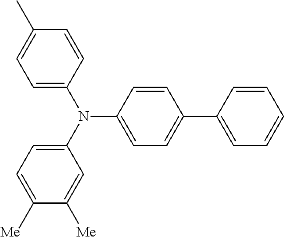 |
| (B)-15 | H | 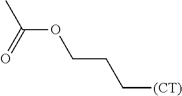 | 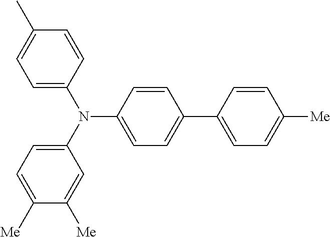 |
| (B)-16 | H | 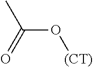 | 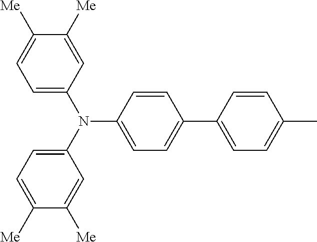 |
| (B)-17 | H | 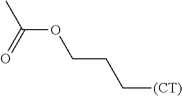 | 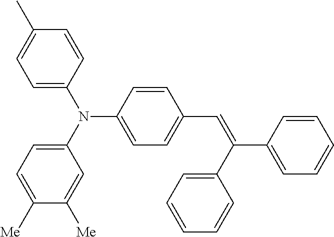 |
| (B)-18 | H | 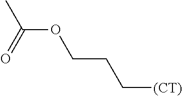 | 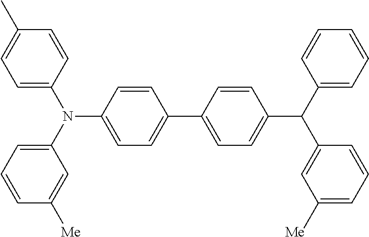 |
| (B)-19 | H | 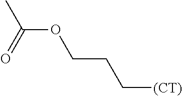 | 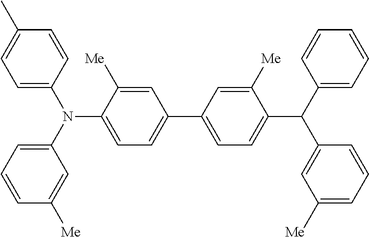 |
| (B)-20 | H | 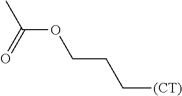 | 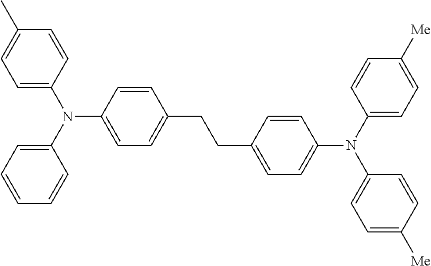 |
| (B)-21 | H | 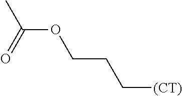 | 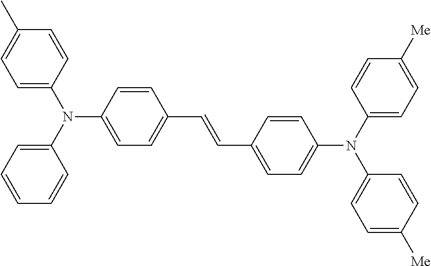 |
| (B)-22 | H | 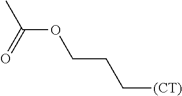 | 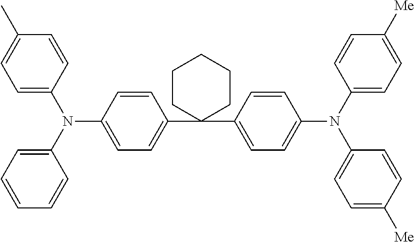 |
| (B)-23 | Me | 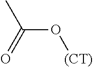 | 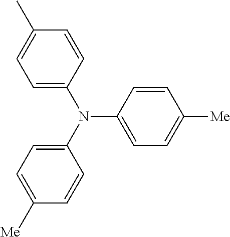 |
| (B)-24 | Me | 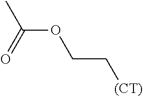 | 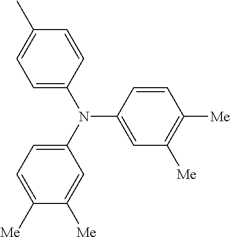 |
| (B)-25 | Me | 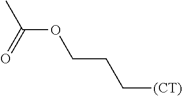 | 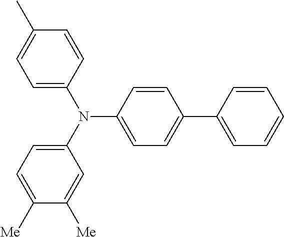 |
| (B)-26 | Me | 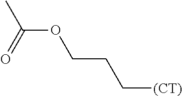 | 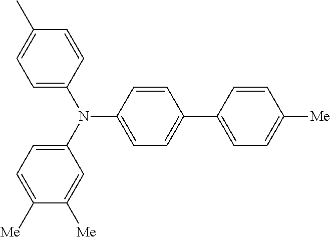 |
| (B)-27 | Me | 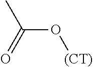 | 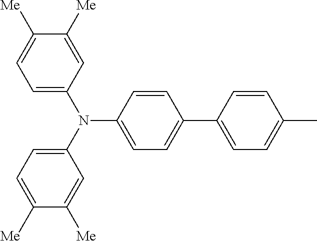 |
| (B)-28 | Me | 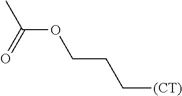 | 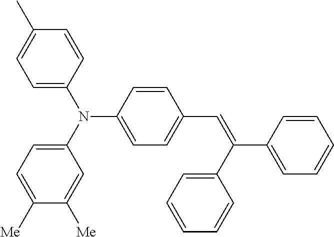 |
| (B)-29 | Me | 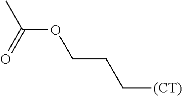 | 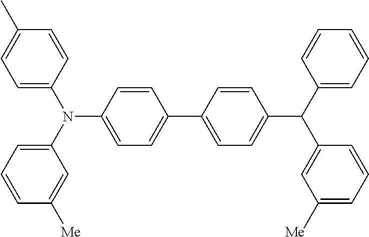 |
| (B)-30 | Me | 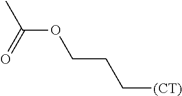 | 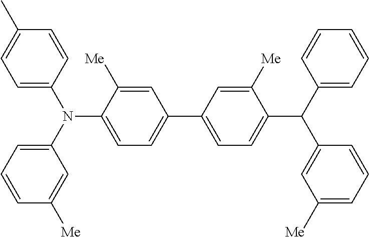 |
| (B)-31 | Me | 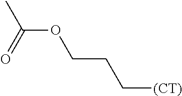 | 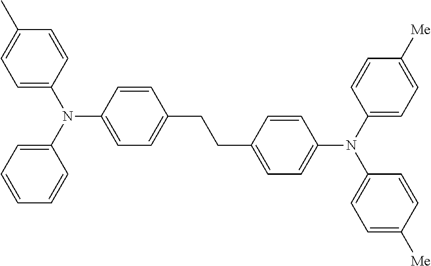 |
| (B)-32 | Me | 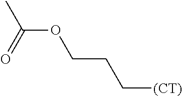 | 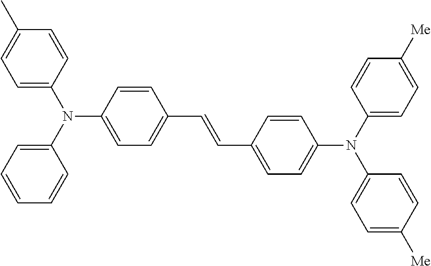 |
| (B)-33 | Me | 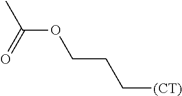 | 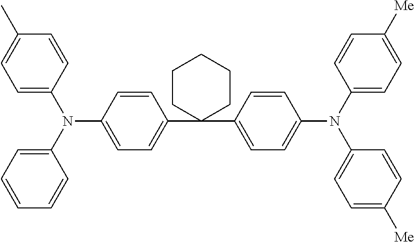 |

Furthermore, specific examples of the partial structure represented by the formula (C) include the following structures, but the examples are not limited to these.

| | R² | Y | R³ |
|---|---|---|---|
| (C)-1 | H | —CH₂— | H |
| (C)-2 | H | 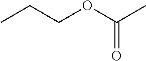 | H |
| (C)-3 | H | 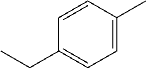 | H |
| (C)-4 | H | CH₂ | Me |
| (C)-5 | H | 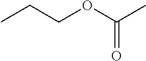 | Me |
| (C)-6 | H | 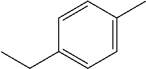 | Bu |
| (C)-7 | H | 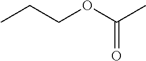 | Bu |
| (C)-8 | H | 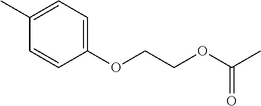 | Me |
| (C)-9 | H | 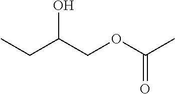 | H |
| (C)-10 | H | 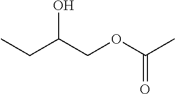 | Me |
| (C)-11 | H | 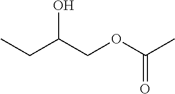 | Bu |
| (C)-12 | Me | CH₂ | H |
| (C)-13 | Me | 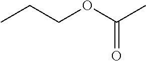 | H |
| (C)-14 | Me | 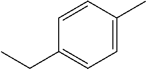 | H |
| (C)-15 | Me | CH₂ | Me |
| (C)-16 | Me | 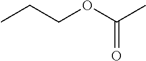 | Me |
| (C)-17 | Me | 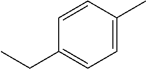 | Bu |
| (C)-18 | Me | 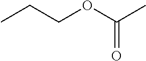 | Bu |
| (C)-19 | Me | 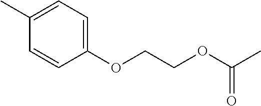 | Me |
| (C)-20 | Me | 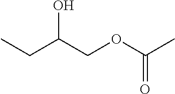 | H |
| (C)-21 | Me | 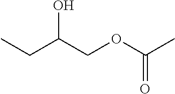 | Me |
| (C)-22 | Me | 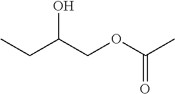 | Bu |

A polymer composed only of the partial structures represented by the formulas (B) and (C) is desirably a polymer having partial structures represented by the following formulas (B′) and (C′).

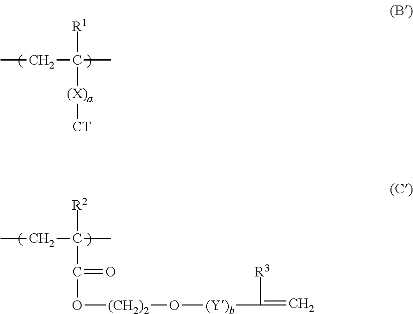

In the formulas (B′) and (C′), R¹, R² and R³ each independently represent a hydrogen atom or an alkyl group having from 1 to 4 carbon atoms; X represents a divalent organic group having from 1 to 20 carbon atoms; Y′ represents —C(═O)—, —O—C(═O)—, an alkylene group, an aromatic ring, or a linking group combining these, which does not have a hydroxyl group; a and b each independently represent 0 or 1; and CT represents an organic group having a charge transporting skeleton.

In the formulas (B′) and (C′), the divalent organic group represented by X, and the organic group having a charge transporting skeleton represented by CT have the same definitions as X and CT in the formulas (B) and (C).

Among these, a polymer represented by the following structural formula (D) is desirable due to its excellent solubility and film-forming properties.

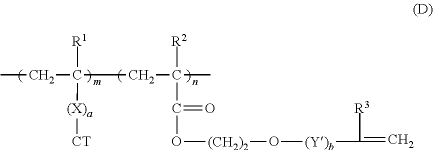

In the formula (D), R¹, R² and R³ each independently represent a hydrogen atom, or an alkyl group having from 1 to 4 carbon atoms; X represents a divalent organic group having from 1 to 20 carbon atoms; V represents —C(═O)—, —O—C(═O)—, an alkylene group, an aromatic ring, or a linking group combining these, which does not have a hydroxyl group; a and b each independently represent 0 or 1; and CT represents an organic group having a charge transporting skeleton.

m and n each represent an integer of 5 or greater, and 10<m+n<2000, while 0.2<m/(m+n)<0.95. From the viewpoints of strength, flexibility and electrical properties, it is desirable that 15<m+n<2000, and 0.3<m/(m+n)<0.95, and it is more desirable that 20<m+n<2000, and 0.4<m/(m+n)<0.95.

Furthermore, in the formula (D), the divalent organic group represented by X, and the organic group having a charge transporting skeleton represented by CT have the same definitions as X and CT in the formulas (B) and (C).

The polymer containing partial structures respectively represented by the formulas (B) and (C) is produced using, for example, the compound represented by the formula (A) as a monomer, according to a known method such as copolymerization of the compound represented by the formula (A) with methacrylic acid, acrylic acid, a glycidyl compound and derivatives thereof.

Furthermore, the polymer containing partial structures respectively represented by the formulas (B) and (C) may also be copolymerized with a monofunctional monomer, in addition to the monomers represented by the formulas (B) and (C), in order to impart solubility and flexibility.

Examples of the monofunctional monomer include acrylates and methacrylates such as isobutyl acrylate, t-butyl acrylate, isooctyl acrylate, lauryl acrylate, stearyl acrylate, isobornyl acrylate, cyclohexyl acrylate, 2-methoxyethyl acrylate, methoxytriethylene glycol acrylate, 2-ethoxyethyl acrylate, tetrahydrofurfuryl acrylate, benzyl acrylate, ethylcarbitol acrylate, phenoxyethyl acrylate, 2-hydroxyacrylate, 2-hydroxypropyl acrylate, 4-hydroxybutyl acrylate, methoxypolyethylene glycol acrylate, methoxypolyethylene glycol methacrylate, phenoxypolyethylene glycol acrylate, phenoxypolyethylene glycol methacrylate, hydroxyethyl o-phenylphenol acrylate, and o-phenylphenol glycidyl ether acrylate; and styrene derivatives such as styrene, α-methylstyrene, and 4-methylstyrene.

The amount (I) of these monofunctional monomers used in the copolymerization is desirably such that I/m<0.3, and more desirably such that I/m<0.2, with respect to m in the formula (D), from the viewpoint of imparting solubility and flexibility.

These compounds of (I) may be used individually, or two or more kinds may be used in combination.

Compound of (II)

The compound of (II) is a compound which has two or more thiol groups in the same molecule, and does not have a charge transporting skeleton.

The compound of (II) may be, for example, at least one polyfunctional thiol compound selected from a compound having two or more primary thiol groups, and a compound having two or more secondary thiol groups.

The number of thiol groups may be, for example, from 2 to 6.

Here, the primary thiol group is a thiol group having a structure represented by the formula: —CH₂—SH.

On the other hand, the secondary thiol group is a thiol group having a structure represented by the formula: CR—CH(SH)—CR (provided that R represents an organic group).

The compound having two or more primary thiol groups is not particularly limited as long as it is a compound which does not have a charge transporting skeleton and has two or more primary thiol groups. However, examples thereof include the following compounds.

Examples of a compound having two primary thiol groups include oligomer compounds such as 1,10-decanedithiol, 1,2-benzenedithiol, 1,2-ethanedithiol, 1,2-propanedithiol, 1,4-bis(3-mercaptobutyryloxy)butane, and tetraethylene glycol-bis(3-mercaptopropionate).

Examples of a compound containing three primary thiol groups include trimethylolpropanetris(3-mercaptopropionate), tris[(3-mercaptopropionyloxy)-ethyl]-isocyanurate, and 1,3,5-tris(3-mercaptobutyloxyethyl)-1,3,5-triazine-2,4,6(1H,3H,5H-trione).

Examples of a compound containing four primary thiol groups include pentaerythritol tetrakis(3-mercaptopropionate.

Examples of a compound containing six primary thiol groups include dipentaerythritol hexakis(3-mercaptopropionate).

The compound having two or more primary thiol groups is favorably a compound having three or more primary thiol groups, from the viewpoint that the resulting film has excellent mechanical strength.

On the other hand, the compound having two or more secondary thiol groups is not particularly limited as long as it is a compound which does not have a charge transporting skeleton and has two or more secondary thiol groups. However, examples thereof include 1,4-bis(3-mercaptobutyryloxy)butane, 1,3,5-tris(3-mercaptobutyloxyethyl)-1,3,5-triazine-2,4,6-(1H,3H,5H-trione), and pentaerythritol tetrakis(3-mercaptobutyrate).

Particularly, the compound having two or more secondary thiol groups is favorable from the viewpoint that when the compound is used in a solution of the raw material composition (coating liquid) for obtaining a film composed of the enethiol resin, the solution has excellent viscosity stability.

These compounds of (II) may be used individually, or two or more kinds may be used in combination.

Compound of (III)

The compound of (III) is a compound which has two or more reactive functional groups each having a carbon double bond in the same molecule, and does not have a charge transporting skeleton.

The compound of (III) is not particularly limited as long as it is a compound which does not have a charge transporting skeleton, and has two or more reactive functional groups each having a carbon double bond. However, examples thereof include the following compounds.

Examples of a compound having two reactive functional groups each having a carbon double bond include bifunctional compounds such as 1,4-butanediol diacrylate, 1,6-hexanediol diacrylate, 1,9-nonanediol diacrylate, 2-n-butyl-2-ethyl-1,3-propanediol diacrylate, tripropylene glycol diacrylate, tetraethylene glycol diacrylate, dioxane glycol diacrylate, polytetramethylene glycol diacryalte, ethoxylated bisphenol A diacrylate, ethoxylated bisphenol A dimethacrylate, tricyclodecanemethanol diacrylate, and tricyclodecanemethanol dimethacrylate.

Examples of a compound having three reactive functional groups each having a carbon double bond include trifunctional compounds such as trimethylolpropane triacrylate, trimethylolpropane trimethacrylate, pentaerythritol acrylate, trimethylolpropane EO-adduct triacrylate, glycerin PO-adduct triacrylate, trisacryloyloxyethyl phosphate, pentaerythritol tetraacrylate, and ethoxylated isocyanuric triacrylate.

In addition, a compound having 4 or more reactive functional groups each having a carbon double bond may be, for example, a polyfunctional acrylate having an isocyanuric acid skeleton, and specific examples include tetrafunctional or higher-functional compounds such as tris(2-hydroxyethyl)isocyanurate triacrylate, tris(2-hydroxyethyl)isocyanurate trimethacrylate, bis(2-hydroxyethyl)isocyanurate triacrylate, bis(2-hydroxyethyl)isocyanurate trimethacrylate, caprolactone-modified acrylate of bis(acryloxyethyl)isocyanurate, caprolactone-modified methacrylate of bis(acryloxyethyl)isocyanurate, caprolactone-modified acrylate of bis(methacryloxyethyl)isocyanurate, and caprolactone-modified methacrylate of bis(methacryloxyethyl)isocyanurate.

Among these, from the viewpoint that the resulting film has excellent mechanical properties, and from the viewpoint of suppressing phase separation occurring in the resulting film, the compound of (III) may be a compound having from 2 to 4 reactive functional groups each having a carbon double bond.

Compound of (IV) The compound of (IV) is a compound which has two or more thiol groups in the same molecule, and has a charge transporting skeleton.

Specifically, the compound of (IV) may be, for example, a compound represented by the following formula (AA).

F−[(G)ₐ₁−(X)ₐ₂−Y−SH]_{b} Formula (AA)

In the formula (AA), F represents an organic group derived from a charge transporting compound; G represents a divalent organic group having from 1 to 5 carbon atoms; X represents —CO—O—, or —O—; Y represents a divalent organic group having from 1 to 5 carbon atoms, which may be substituted with —SH as a substituent; a1 and a2 each independently represent 0 or 1; and b represents an integer from 2 to 6.

Here, in the formula (AA), the organic group derived from a charge transporting compound as represented by F, corresponds to a charge transporting skeleton. The charge transporting compound in the organic group derived from a charge transporting compound as represented by F, is a known organic compound having at least one of an electron transportability and a hole transportability. There are no particular limitations, but examples include a phthalocyanine-based compound, a porphyrin-based compound, an azobenzene-based compound, a triarylamine-based compound, a benzidine-based compound, an arylalkane-based compound, an aryl-substituted ethylene-based compound, a stilbene-based compound, an anthracene-based compound, a hydrazone-based compound, a quinone-based compound, and a fluorenone-based compound. Among these, a triarylamine-based compound is favorable from the viewpoint that the resulting film has excellent charge transportability and mechanical properties.

Furthermore, b is from 2 to 6, but b is desirably from 4 to 6, from the viewpoint that the resulting film has excellent charge transportability and mechanical strength. In the formula (AA), G, X, Y, a1 and a2 have the same definitions as the groups represented by D¹ in the formula (AAA), and thus further explanation will not be repeated.

Specifically, the compound represented by the formula (AA) is suitably, for example, a compound represented by the following formula (AB), from the viewpoint that the resulting film has excellent charge transportability and mechanical properties.

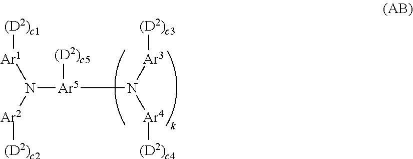

In the formula (AB), Ar¹ to Ar⁴ each independently represent a substituted or unsubstituted aryl group; Ar⁵ represents a substituted or unsubstituted aryl group, or a substituted or unsubstituted arylene group; D² represents (G)ₐ₁-(X)ₐ₂—Y—SH; c1 to c5 each independently represent 0, 1 or 2; k represents 0 or 1; and the total number of D is 2 or greater.

In the formula (AB), the total number of D is desirably from 4 to 6, for example, from the viewpoint that the resulting film has excellent charge transportability and mechanical properties.

In the formula (AB), Ar¹ to Ar⁵ have the same definitions as Ar¹ to Ar⁵ in the formula (A), and therefore, further explanation will not be repeated.

Furthermore, G, X, Y, a1 and a2 in the groups represented by D² have the same definitions as those in the formula (AA), and therefore, further explanation will not be repeated.

Specific examples of the compound represented by the formula (AA) (compound of (IV)) will be shown below. However, the compound represented by the formula (AA) is not limited to these examples.

| Compound | F—G— | a1/a2 | X | Y—SH | b |
|---|---|---|---|---|---|
| (AA-1) | 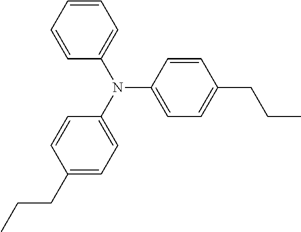 | 1/1 | 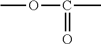 | 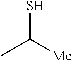 | 2 |
| (AA-2) | 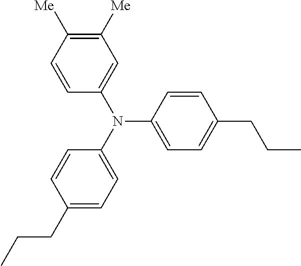 | 1/1 | 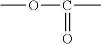 | 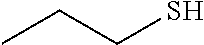 | 2 |
| (AA-3) | 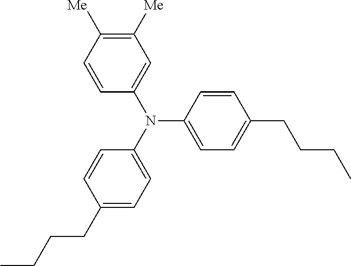 | 1/1 | 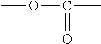 | 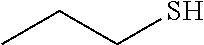 | 2 |
| (AA-4) | 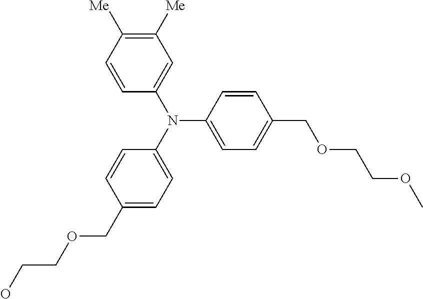 | 1/1 | 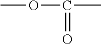 | 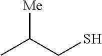 | 2 |
| (AA-5) | 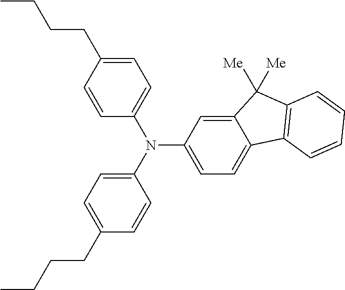 | 1/1 | 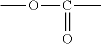 | 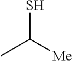 | 2 |
| (AA-6) | 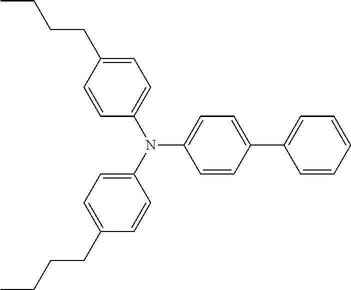 | 1/1 | 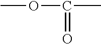 | 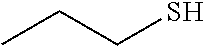 | 2 |
| (AA-7) | 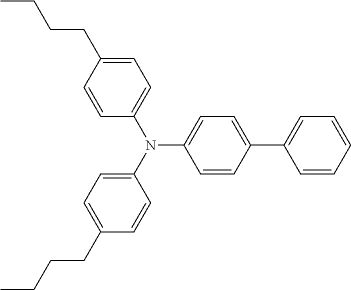 | 1/1 | 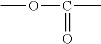 | 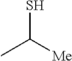 | 2 |
| (AA-8) | 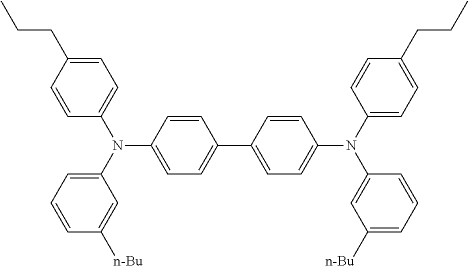 | 1/1 | 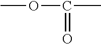 | 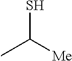 | 2 |
| (AA-9) | 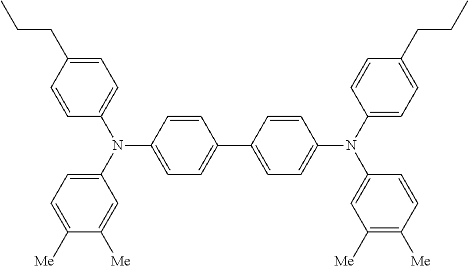 | 1/1 | 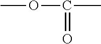 | 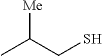 | 2 |
| (AA-10) | 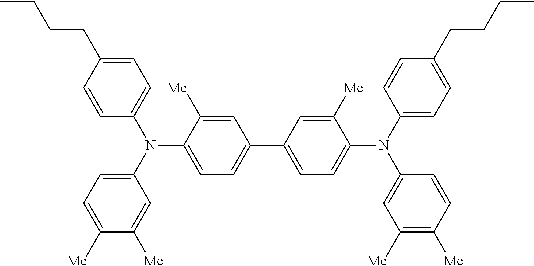 | 1/1 | 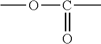 | 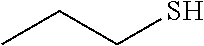 | 2 |
| (AA-11) | 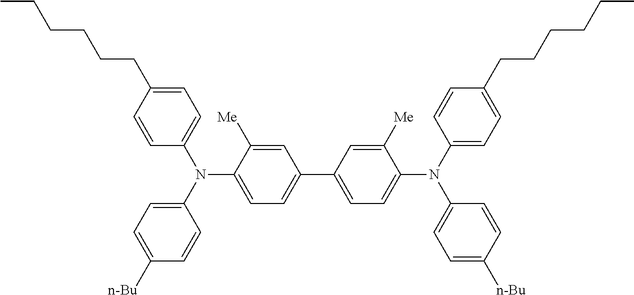 | 1/1 | 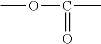 | 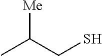 | 2 |
| (AA-12) | 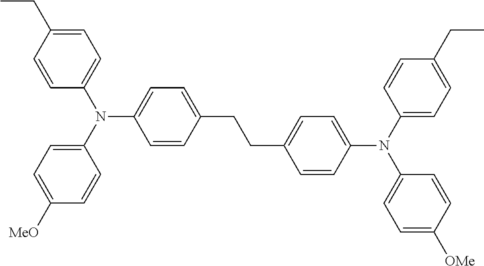 | 1/1 | 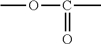 | 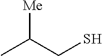 | 2 |
| (AA-13) | 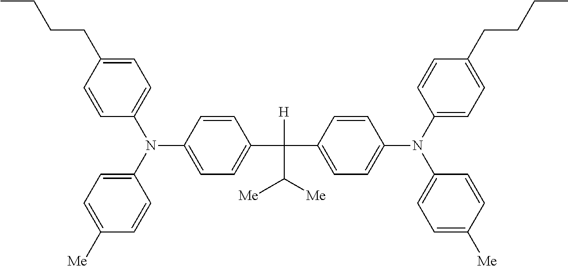 | 1/1 | 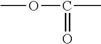 | 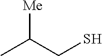 | 2 |
| (AA-14) | 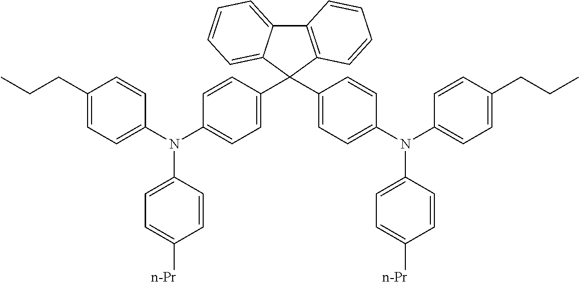 | 1/1 | 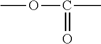 | 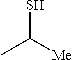 | 2 |
| (AA-15) | 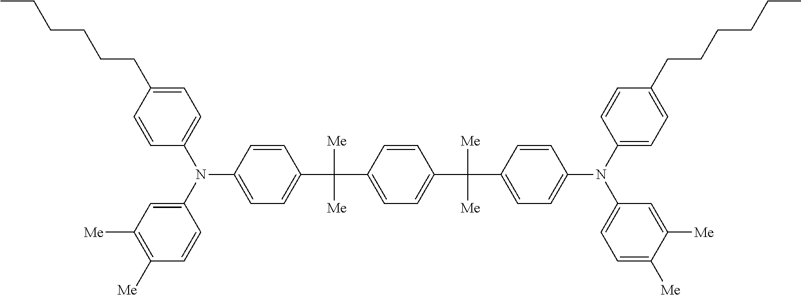 | 1/1 | 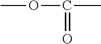 | 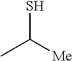 | 2 |
| (AA-16) | 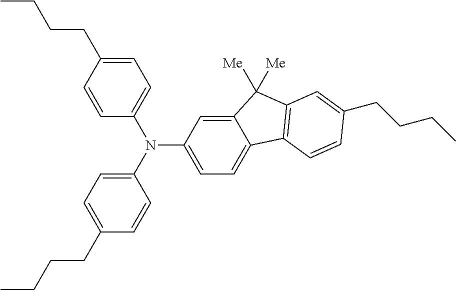 | 1/1 | 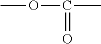 | 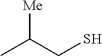 | 3 |
| (AA-17) | 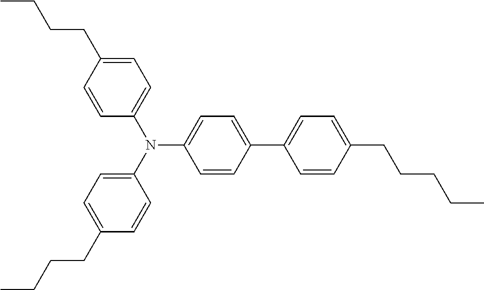 | 1/1 | 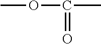 | 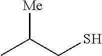 | 3 |
| (AA-18) | 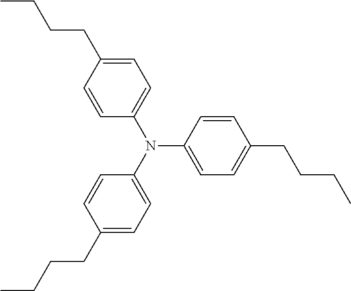 | 1/1 | 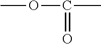 | 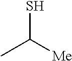 | 3 |
| (AA-19) | 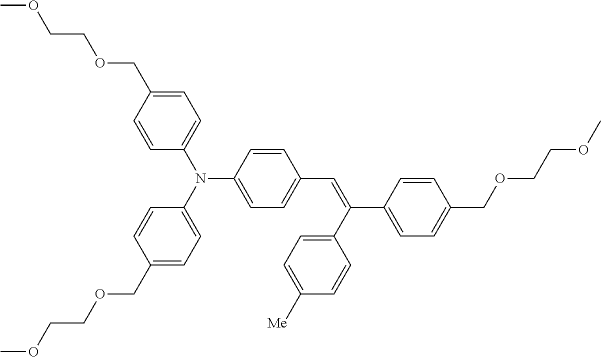 | 1/1 | 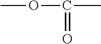 | 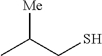 | 3 |
| (AA-20) | 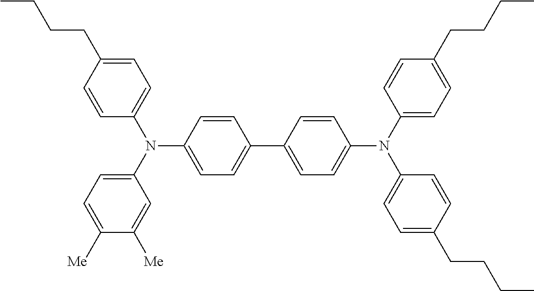 | 1/1 | 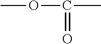 | 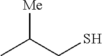 | 3 |
| (AA-21) | 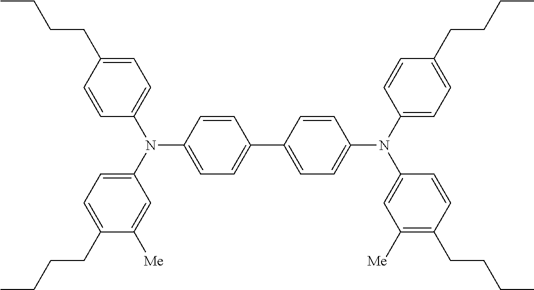 | 1/1 | 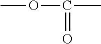 | 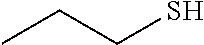 | 4 |
| (AA-22) | 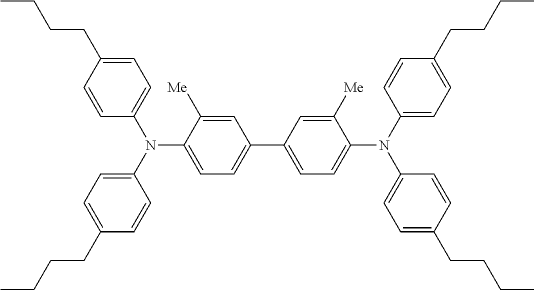 | 1/1 | 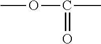 | 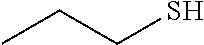 | 4 |
| (AA-23) | 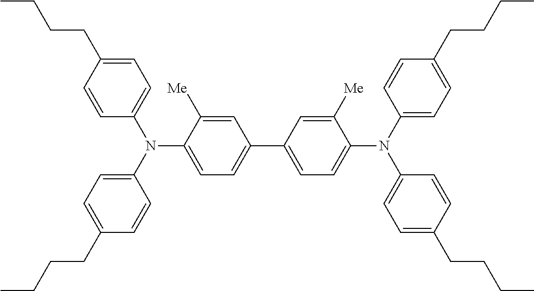 | 1/1 | 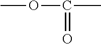 | 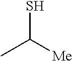 | 4 |
| (AA-24) | 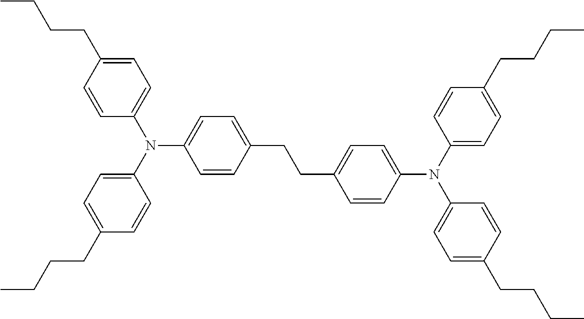 | 1/1 | 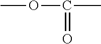 | 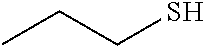 | 4 |
| (AA-25) | 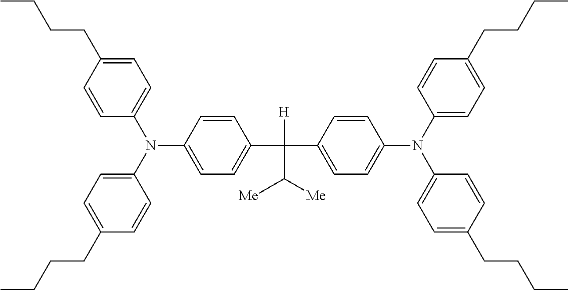 | 1/1 | 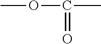 | 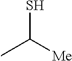 | 4 |
| (AA-26) | 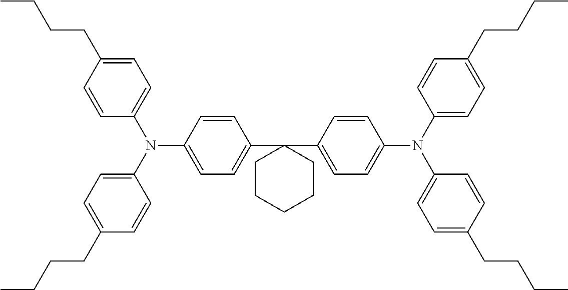 | 1/1 | 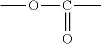 | 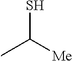 | 4 |
| (AA-27) | 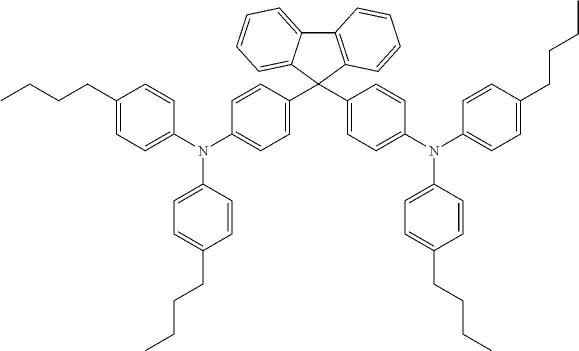 | 1/1 | 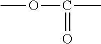 | 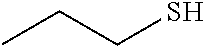 | 4 |
| (AA-28) | 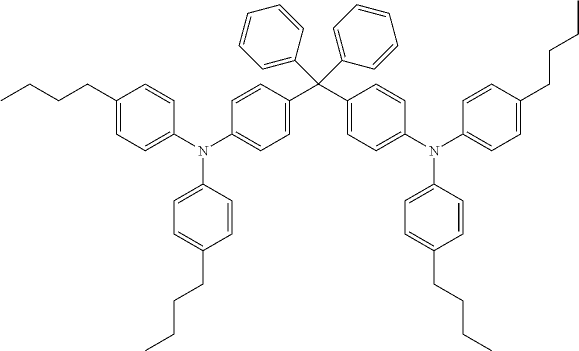 | 1/1 | 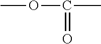 | 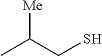 | 4 |
| (AA-29) | 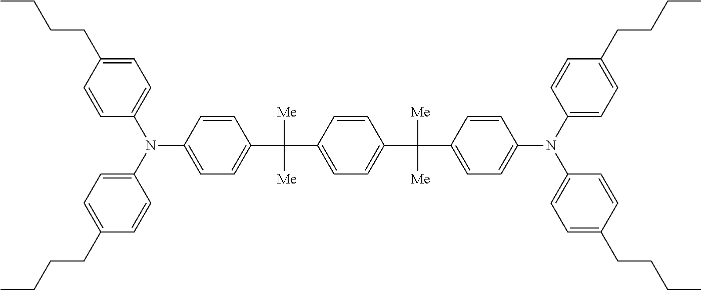 | 1/1 | 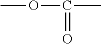 | 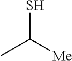 | 4 |
| (AA-30) | 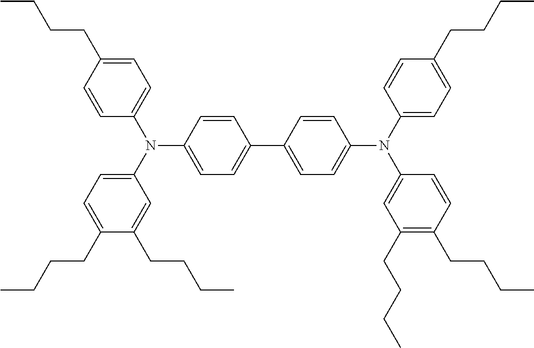 | 1/1 | 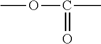 | 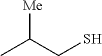 | 6 |
| (AA-31) | 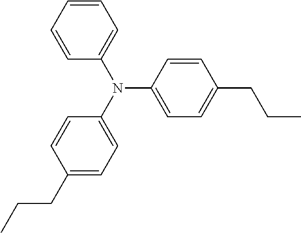 | 1/1 | 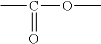 | 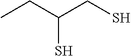 | 2 |
| (AA-32) | 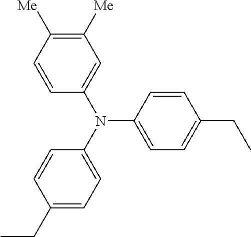 | 1/1 | 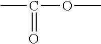 | 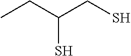 | 2 |
| (AA-33) | 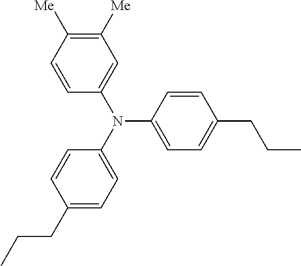 | 1/1 | 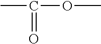 | 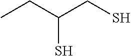 | 2 |
| (AA-34) | 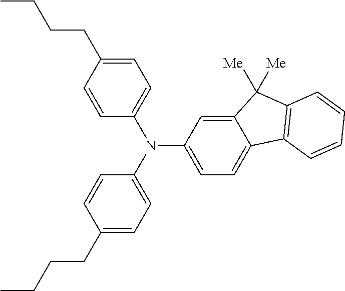 | 1/1 | 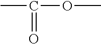 | 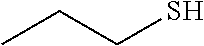 | 2 |
| (AA-35) | 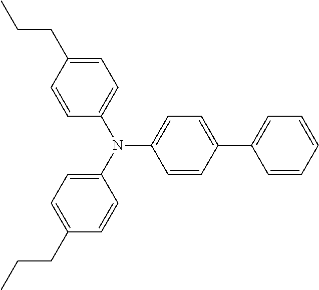 | 1/1 | 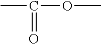 | 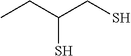 | 2 |
| (AA-36) | 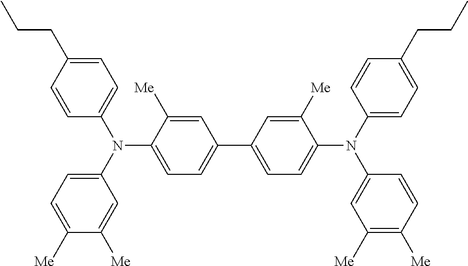 | 1/1 | 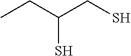 | 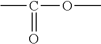 | 2 |
| (AA-37) | 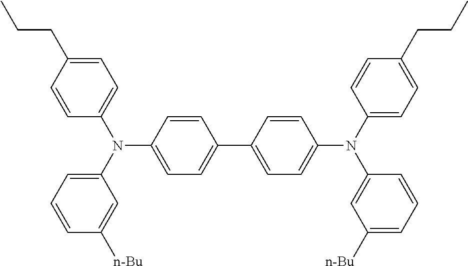 | 1/1 | 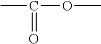 | 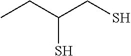 | 2 |
| (AA-38) | 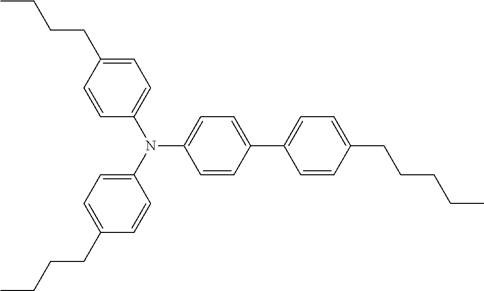 | 1/1 | 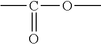 | 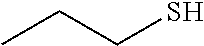 | 3 |
| (AA-39) | 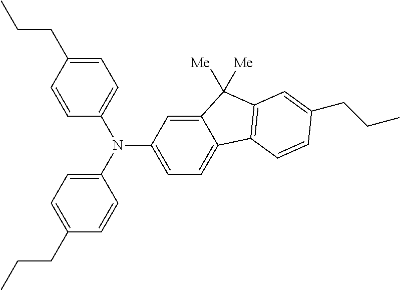 | 1/1 | 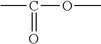 | 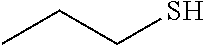 | 3 |
| (AA-40) | 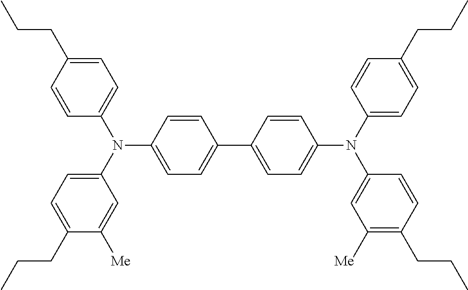 | 1/1 | 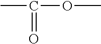 | 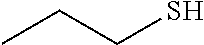 | 4 |
| (AA-41) | 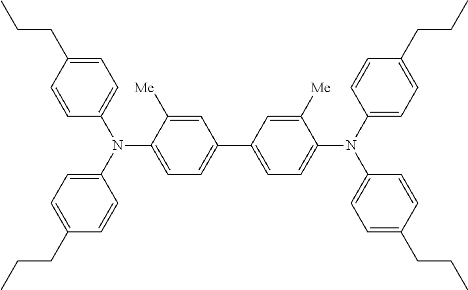 | 1/1 | 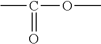 | 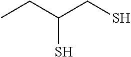 | 4 |
| (AA-42) | 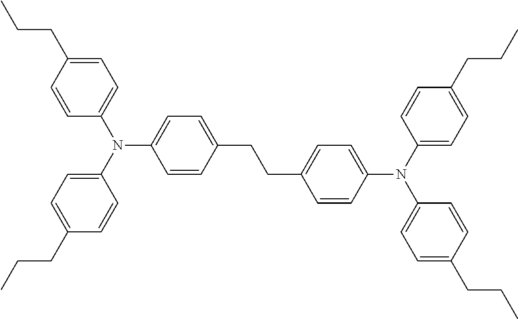 | 1/1 | 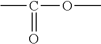 | 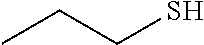 | 4 |
| (AA-43) | 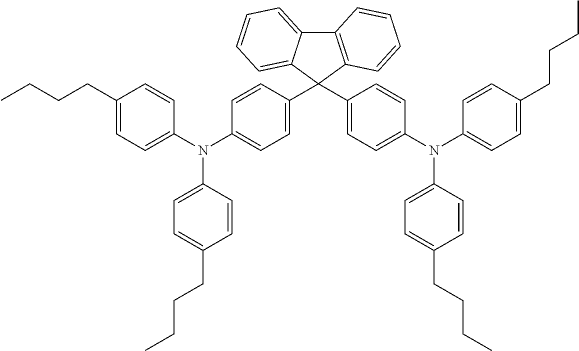 | 1/1 | 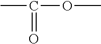 | 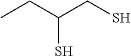 | 4 |
| (AA-44) | 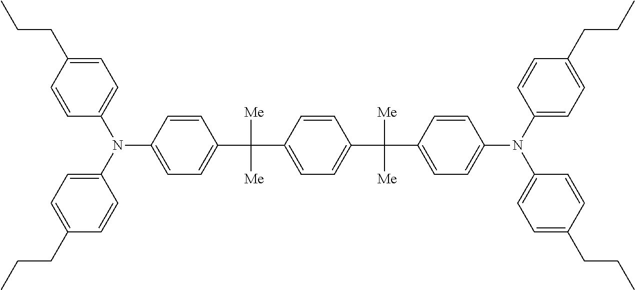 | 1/1 | 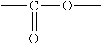 | 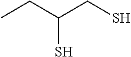 | 4 |

Next, the method for synthesizing the compound represented by the formula (AA) will be described.

The compound represented by the formula (AA) can be synthesized by, for example, a conventional esterification reaction.

Examples of the method for synthesizing the compound represented by the formula (AA) include the synthesis methods described below, but the method is not limited to these.

1) A method of carrying out synthesis by subjecting a combination of an alcohol represented by the following formula (AC) and a carboxylic acid represented by the following formula (AD), or a combination of a carboxylic acid represented by the following formula (AE) and an alcohol represented by the following formula (AF), to esterification using an acid catalyst (for example, sulfuric acid, p-toluenesulfonic acid, or the like) (provided that a corresponding carboxylic acid chloride may be used instead of the carboxylic acid).

F−[(G)ₐ₁−OH]_{b} Formula (AC)

HOOC—Y—SH Formula (AD)

F−[(G)ₐ₁−COOH]_{b} Formula (AE)

HO—Y—SH Formula (AF)

In the formulas (AC), (AD), (AE) and (AF), F represents an organic group derived from a charge transporting compound; G represents a divalent organic group having from 1 to 5 carbon atoms; Y represents a divalent organic group having from 1 to 5 carbon atoms; a1 represents 0 or 1; and b represents an integer from 1 to 6.

Here, in the formulas (AC), (AD), (AE) and (AF), F, G, Y, a1 and b have the same definitions as F, G, Y, a1 and b in the formula (AA).

In addition, the synthesis method described above produces a compound represented by the formula (AA), in which a2 represents 1, and X represents —CO—O—.

2) A method of carrying out synthesis by allowing a combination of an alcohol represented by the following formula (AC) and an alcohol represented by the following formula (AG) or a halide, or a combination of an alcohol represented by the following formula (AH) or a halide and an alcohol represented by the following formula (AF), to react.

F−[(G)ₐ₁−OH]_{b} Formula (AC)

J−Y—SH Formula (AG)

F−[(G)ₐ₁−J]_{b} Formula (AH)

HO—Y—SH Formula (AF)

In the formulas (AC), (AF), (AG) and (AH), F represents an organic group derived from a charge transporting compound; G represents a divalent organic group having from 1 to 5 carbon atoms; Y represents a divalent organic group having from 1 to 5 carbon atoms; a1 represents 0 or 1; b represents an integer from 1 to 6; and J represents a hydroxyl group, chlorine, bromine, or iodine.

Here, in the formulas (AC), (AF), (AG) and (AH), F, G, Y, a1 and b have the same definitions as F, G, Y, a1 and b in the formula (AA).

In addition, the synthesis method described above produces a compound represented by the formula (AA), in which a2 represents 1, and X represents —O—.

Here, more specific examples of the method for synthesizing the compound represented by the formula (AA) in the case of using an arylamine compound as a raw material, include a method of carrying out the synthesis by subjecting the charge transporting compound containing an ester group described in JP-A-9-31039 or the like, and a thiol-containing alcohol to a transesterification reaction; and a method of carrying out the synthesis by converting a charge transporting compound containing an ester group into a free carboxylic acid by hydrolysis, and then esterifying the product with a thiol-containing alcohol, or a chloride, bromide or iodide of a thiol-containing hydrocarbon.

On the other hand, another specific example of the method for synthesizing the compound represented by the formula (AA) may be a method of reducing the ester group of an arylamine compound containing an ester group into a corresponding alcohol using, for example, lithium aluminum hydride, sodium borohydride or the like as described in “Lectures on Experimental Chemistry, 4^{th} edition”, Vol. 20, p. 10, and esterifying the product with a thiol-containing carboxylic acid.

The transesterification reaction is carried out, for example, as described in “Lectures on Experimental Chemistry, 4^{th} edition”, Vol. 28, p. 217, by using an excess amount of a thiol-containing alcohol and an organometallic compound (organometallic compound of titanium, tin or zinc), and heating the compounds.

The thiol-containing alcohol may be added in an amount of 1 equivalent or more, preferably 1.2 equivalents or more, and more preferably 1.5 equivalents or more, based on the ester group of the arylamine compound.

An inorganic acid (for example, sulfuric acid, or phosphoric acid), an acetate (for example, acetate of titanium alkoxide, calcium, or cobalt), a carbonate (for example, carbonate of titanium alkoxide, calcium, or cobalt), or an oxide (for example, oxide of zinc or lead) may be added as a catalyst.

The catalyst may be used in an amount of from 1/10000 part by mass to 1 part by mass, and preferably from 1/1000 part by mass to ½ part by mass, based on 1 part by mass of the arylamine compound.

The reaction is carried out at, for example, a reaction temperature of from 100° C. to 300° C., and desirably, may be carried out at or above the boiling point of the detaching alcohol.

The ester group of the arylamine compound may be an ester with a low-boiling point alcohol such as methanol or ethanol, in order to accelerate the transesterification reaction. The reaction may be carried out in an inert gas such as nitrogen or argon, and the reaction may also be carried out using a high-boiling point solvent such as p-cymene or 1-chloronaphthalene.

A carboxylic acid of an arylamine compound may be obtained by hydrolyzing the ester group of the arylamine compound using, for example, a basic catalyst (NaOH, K₂CO₃, or the like), or an acidic catalyst (for example, phosphoric acid, or sulfuric acid), as described in Lectures on Experimental Chemistry, 4^{th} edition, Vol. 20, p. 51.

At this time, various solvents may be used, but it is desirable to use an alcohol such as methanol, ethanol or ethylene glycol, or to use a mixture of such an alcohol with water.

When the arylamine compound has low solubility, methylene chloride, chloroform, toluene, dimethyl sulfoxide, ether, tetrahydrofuran, or the like may be added.

The amount of the solvent is not particularly limited, but the solvent may be used, for example, in an amount of from 1 part by mass to 100 parts by mass, and preferably from 2 parts by mass to 50 parts by mass, based on 1 part by mass of the arylamine compound containing an ester group.

The reaction temperature is set in the range of, for example, from room temperature (for example, 25° C.) to the boiling point of the solvent, and is desirably 50° C. or higher, in view of the reaction rate.

The amount of the catalyst is not particularly limited, but the catalyst may be used in an amount of, for example, from 0.001 parts by mass to 1 part by mass, and preferably from 0.01 part by mass to 0.5 part by mass, based on 1 part by mass of the charge transporting compound containing an ester group.

After the hydrolysis reaction, in a case where hydrolysis has been performed using a basic catalyst, the produced salt is neutralized with an acid (for example, hydrochloric acid) and is isolated. The salt is further washed with water sufficiently, and then dried for use. If necessary, the salt is subjected to recrystallization purification from an appropriate solvent such as methanol, ethanol, toluene, ethyl acetate or acetone, and then dried for use.

It is desirable to add, for example, a thiol-containing alcohol to the arylamine compound carboxylic acid in an amount of 1 equivalent or more, preferably 1.2 equivalents or more, and more preferably 1.5 equivalents or more.

An inorganic acid (for example, sulfuric acid or phosphoric acid), or an organic acid (for example, p-toluenesulfonic acid) may be added as a catalyst.

The catalyst may be used in an amount of, for example, from 1/10000 part by mass to 1 part by mass, and preferably from 1/1000 part by mass to ½ part by mass, based on 1 part by weight of the arylamine compound.

For the solvent, it is desirable to use a solvent that is capable of azeotropic distillation with water, for example, in order to remove the water produced during polymerization. Examples of the solvent that may be used effectively include toluene, chlorobenzene, and chloronaphthalene.

The solvent may be used in an amount in the range of from 1 part by mass to 100 parts by mass, and preferably from 2 parts by mass to 50 parts by mass, based on 1 part by mass of the arylamine compound carboxylic acid.

The reaction temperature may be arbitrarily set up, but it is desirable to perform the reaction at the boiling point of the solvent in order to remove the water produced during polymerization.

After completion of the reaction, the reaction liquid is poured into water, extraction is performed using a solvent such as toluene, hexane or ethyl acetate, and the organic phase is washed with water. Furthermore, if necessary, purification of the product may be carried out using an adsorbent such as activated carbon, silica gel, porous alumina, or activated white clay.

Furthermore, in the case of the method of carrying out synthesis by esterifying with a chloride, bromide or iodide of a thiol-containing hydrocarbon, synthesis is carried out by allowing a thiol-containing hydrocarbon having a halogen group (Cl, Br, I or the like) to react with a base (for example, pyridine, piperidine, triethylamine, dimethylaminopyridine, trimethylamine, DBU, sodium hydride, sodium hydroxide, or potassium hydroxide) in an amount of, for example, from 1 equivalent to 5 equivalents, and preferably from 1.1 equivalents to 3 equivalents, based on the acid group of the arylamine compound carboxylic acid, in an organic solvent (an aprotic polar solvent such as N-methylpyrrolidone, dimethyl sulfoxide, or N,N-dimethylformamide; a ketone-based solvent such as acetone, or methyl ethyl ketone; an ether-based solvent such as diethyl ether or tetrahydrofuran; or the like).

The base may be used in an amount of from 1 equivalent to 3 equivalents, and preferably from equivalent to 2 equivalents, based on the arylamine compound carboxylic acid.

The aprotic organic solvent may be used in an amount of, for example, from 1 part by mass to 50 parts by mass, and preferably from 1.5 parts by mass to 30 parts by mass, based on the carboxylic acid derivative.

The reaction temperature is set between, for example, 0° C. and the boiling point of the solvent, and is desirably from 0° C. to 150° C.

After completion of the reaction, the reaction liquid is poured into water, the mixture is extracted with a solvent such as toluene, hexane, or ethyl acetate, and the organic phase is washed with water. Furthermore, if necessary, purification may be carried out using an adsorbent such as activated carbon, silica gel, porous alumina, or activated white clay.

Method for Forming Charge Transport Film (Method For Forming an Enethiol Resin)

There are no particular limitations, but the charge transport film according to the exemplary embodiment of the invention is obtained by applying a coating liquid obtained by solubilizing the raw materials for forming the enethiol resin in a solvent, on an object to be coated (for example, a substrate, or a mold) by a well-known coating method (for example, a blade coating method, a wire bar coating method, a spray coating method, a dipping coating method, a bead coating method, an air knife coating method, or a curtain coating method), subsequently polymerizing the raw materials by irradiation with an electron beam, light irradiation, or heating, and thereby forming an enethiol resin.

At this time, known additives may be mixed and added into the coating liquid, as necessary. Examples of these additives include a curing agent (for example, an epoxy compound, or an isocyanate compound), a binder resin (for example, a polycarbonate resin, an ester resin, or a styrene resin), as well as a coupling agent, a hard coating agent, a fluorine-containing compound, an antioxidant, a silicone oil, and an inorganic filler.

Here, the method for polymerizing the raw materials for forming the charge transport film (the enethiol resin constituting the film) according to the exemplary embodiment of the invention, will be specifically described.

The method for polymerizing of the raw materials for forming the charge transport film (the enethiol resin constituting the resin) according to the exemplary embodiment of the invention may be carried out by various treatments based on electron beam irradiation, light irradiation, and heating.

In the case of performing an electron beam irradiation treatment, the accelerating voltage used during the treatment is, for example, preferably 300 kV or less, and optimally 150 kV or less. The radiation dose is preferably in the range of from 1 Mrad to 10 Mrad, and more preferably in the range of from 3 Mrad to 50 Mrad. If the accelerating voltage is greater than 300 kV, damage of electron beam irradiation to the charge transportability of the charge transport film tends to increase. Furthermore, if the radiation dose is less than 1 Mrad, cross-linking is likely to be insufficient, and if the radiation dose is greater than 100 Mrad, deterioration of the charge transport film tends to occur easily.

Electron beam irradiation is carried out in an inert gas atmosphere such as nitrogen or argon, at an oxygen concentration of 1000 ppm or less, and preferably 500 ppm or less, and furthermore, heating may be carried out during the irradiation, or after the irradiation, at a temperature of from 50° C. to 150° C.

Furthermore, in the case of performing a light irradiation treatment, a high pressure mercury lamp, a low pressure mercury lamp, a metal halide lamp or the like is used as the light source, and a suitable wavelength of the light to be irradiated may be selected by using a filter such as a band-pass filter. There are no particular limitations on the irradiation time and the light intensity, but for example, the illumination (365 nm) is preferably from 300 mW/cm² to 1000 mW/cm², and for example, in the case of irradiating with UV light at 600 mW/cm², the duration of the irradiation may be from 5 seconds to 360 seconds.

Photo-irradiation is carried out in an inert gas atmosphere such as nitrogen or argon, at an oxygen concentration of 1000 ppm or less, and preferably 500 ppm or less, and furthermore, heating may be carried out during the irradiation, or after the irradiation, at a temperature of from 50° C. to 150° C.

At this time, a photopolymerization catalyst may also be used for the purpose of further carrying out polymerization and obtaining a charge transport film having higher mechanical strength. The amount of the photopolymerization catalyst used is not particularly limited, but the amount of use is preferably from 0.01% by mass to 10% by mass, more preferably from 0.03% by mass to 8% by mass, and most preferably from 0.05% by mass to 5% by mass, based on the total amount of the raw materials.

Here, examples of the photopolymerization catalyst include, as an intramolecular cleavage type, benzyl ketal-based, alkylphenone-based, aminoalkylphenone-based, phosphine oxide-based, titanocene-based, and oxime-based catalysts.

More specifically, an example of the benzyl ketal-based catalyst may be 2,2-dimethoxy-1,2-diphenylethan-1-one.

Examples of the alkylphenone-based catalyst include 1-hydroxy-cyclohexyl-phenyl ketone, 2-hydroxy-2-methyl-1-phenylpropan-1-one, 1-[4-(2-hydroxyethoxy)-phenyl]-2-hydroxy-2-methyl-1-propan-1-one, 2-hydroxy-1-{4-[4-(2-hydroxy-2-methylpropionyl)-benzyl]phenyl}-2-methylpropan-1-one, acetophenone, and 2-phenyl-2-(p-toluenesulfonyloxy)acetophenone.

Examples of the aminoalkylphenone-based catalyst include p-dimethylaminoacetophenone, p-dimethylaminopropiophenone, 2-methyl-1-(4-methylthiophenyl)-2-morpholinopropan-1-one, 2-benzyl-2-dimethylamino-1-(4-morpholinophenyl)-butanone, and 1,2-(dimethylamino)-2-[(4-methylphenyl)methyl]-1-[4-(4-morpholinyl)phenyl]-1-butanone.

Examples of the phosphine oxide catalyst include 2,4,6-trimethylbenzoyl-diphenyl-phosphine oxide, and bis(2,4,6-trimethylbenzoyl)-phenylphosphine oxide.

Examples of the titanocene-based catalyst include bis(η5-2,4-cyclopentadien-1-yl)-bis(2,6-difluoro-3-(1H-pyrrol-1-yl)-phenyl)titanium.

Examples of the oxime-based catalyst include 1,2-octanedione, 1-[4-(phenylthio)-2-(O-benzoyloxime)], methanone, and 1-[9-ethyl-6-(2-methylbenzoyl)-9H-carbazol-3-yl]-1-(O-acetyloxime).

Examples of hydrogen-withdrawing catalyst include benzophenone-based, thioxanthone-based, benzyl-based, and Michler's ketone-based catalysts.

More specific examples include, as benzophenone-based catalysts, 2-benzoylbenzoic acid, 2-chlorobenzophenone, 4,4′-dichlorobenzophenone, 4-benzoyl-4′-methyldiphenyl sulfide, and p,p′-bisdiethylaminobenzophenone.

Examples of the thioxathone-based catalysts include 2,4-diethylthioxanthen-9-one, 2-chlorothioxanthone, and 2-isopropylthioxanthone.

Examples of the benzil-based catalysts include benzyl, (±)-camphorquinone, and p-anisil.

These photopolymerization initiatiors may be used individually, or in combination of two or more kinds.

Furthermore, in the case of performing a heat treatment (heating treatment), the desirable reaction temperature is from 30° C. to 180° C., more desirably from 80° C. to 170° C., and most desirably from 100° C. o 160° C., from the viewpoints of the production efficiency, control of side reactions, and suppression of deterioration of the composition.

The reaction time may be selected depending on the reaction temperature, but the reaction time is desirably from 5 minutes to 1000 minutes, more preferably from 15 minutes to 500 minutes, and most preferably from 30 minutes to 120 minutes.

The heat treatment may be carried out in a vacuum or inert gas atmosphere (for example, in an atmosphere at an oxygen concentration of preferably from 1 ppm to 5%, more preferably from 5 ppm to 3%, and most preferably from 10 ppm to 500 ppm).

At this time, a thermal polymerization catalyst may be used for the purpose of further carrying out polymerization and obtaining a film having higher mechanical strength. The amount of the thermal polymerization catalyst used is not particularly limited, but the amount of use is desirably in the range of from 0.01% by mass to 10% by mass, more preferably from 0.03% by mass to 8% by mass, and most preferably from 0.03% by mass to 5% by mass, based on the total amount of the raw materials.

Here, examples of the thermal polymerization initiator include azo-based initiators such as V-30 (10 hour half-life temperature: 104° C.), V-40 (10 hour half-life temperature: 88° C.), V-59 (10 hour half-life temperature: 67° C.), V-601 (10 hour half-life temperature: 66° C.), V-65 (10 hour half-life temperature: 51° C.), V-70 (10 hour half-life temperature: 30° C.), VF-096 (10 hour half-life temperature: 96° C.), Vam-110 (10 hour half-life temperature: 111° C.), Vam-111 (10 hour half-life temperature: 111° C.) (all manufactured by Wako Pure Chemical Industries, Ltd.), OTazo-15 (10 hour half-life temperature: 61° C.), OTazo-30, AIBM (10 hour half-life temperature: 65° C.), AMBN (10 hour half-life temperature: 67° C.), ADVN (10 hour half-life temperature: 52° C.), and ACVA (10 hour half-life temperature: 68° C.) (all manufactured by Otsuka Chemical Co., Ltd.); Pertetra A, Perhexa HC, Perhexa C, Perhexa V, Perhexa 22, Perhexa MC, Perbutyl H, Percumyl H, Percumyl P, Permentor H, Perocta H, Perbutyl C, Perbutyl D, Perhexyl D, Peroyl IB, Peroyl 355, Peroyl L, Peroyl SA, Nyper BW, Nyper BMT-K40/M, Peroyl IPP, Peroyl NPP, Peroyl TCP, Peroyl OPP, Peroyl SBP, Percumyl ND, Perocta ND, Perhexyl ND, Perbutyl ND, Perbutyl NHP, Perhexyl PV, Perbutyl PV, Perhexa 250, Perocta O, Perhexyl O, Perbutyl O, Perbutyl L, Perbutyl 355, Perhexyl I, Perbutyl I, Perbutyl F, Perhexa 25Z, Perbutyl A, Perhexyl Z, Perbutyl ZT, Perbutyl Z (all manufactured by NOF Corp.); Kayaketal AM-055, Trigonox 36-C75, Laurox, Percadox L-W75, Percadox CH-50L, Trigonox TMBH, Kayacumene H, Kayabutyl H-70, Percadox BC-FF, Kayahexa AD, Percadox 14, Kayabutyl C, Kayabutyl D, Kayahexa YD-E85, Percadox 12-XL25, Percadox 12-EB20, Trigonox 22-N70, Trigonox 22-70E, Trigonox D-T50, Trigonox 423-C70, Kayaester CND-C70, Kayaester CND-W50, Trigonox 23-C70, Trigonox 23-W50N, Trigonox 257-C70, Kayaester P-70, Kayaester TMPO-70, Trigonox 121, Kayaester O, Kayaester HTP-65W, Kayaester AN, Trigonox 42, Trigonox F-050, Kayabutyl B, Kayacarbon EH-C70, Kayacarbon EH-W60, Kayacarbon 1-20, Kayacarbon BIC-75, Trigonox 117 and Kayalene 6-70 (all manufactured by Kayaku Akzo Co., Ltd.); Luperox LP (10 hour half-life temperature: 64° C.), Luperox 610 (10 hour half-life temperature: 37° C.), Luperox 188 (10 hour half-life temperature: 38° C.), Luperox 844 (10 hour half-life temperature: 44° C.), Luperox 259 (10 hour half-life temperature: 46° C.), Luperox 10 (10 hour half-life temperature: 48° C.), Luperox 701 (10 hour half-life temperature: 53° C.), Luperox 11 (10 hour half-life temperature: 58° C.), Luperox 26 (10 hour half-life temperature: 77° C.), Luperox 80 (10 hour half-life temperature: 82° C.), Luperox 7 (10 hour half-life temperature: 102° C.), Luperox 270 (10 hour half-life temperature: 102° C.), Luperox P (10 hour half-life temperature: 104° C.), Luperox 546 (10 hour half-life temperature: 46° C.), Luperox 554 (10 hour half-life temperature: 55° C.), Luperox 575 (10 hour half-life temperature: 75° C.), Luperox TANPO (10 hour half-life temperature: 96° C.), Luperox 555 (10 hour half-life temperature: 100° C.), Luperox 570 (10 hour half-life temperature: 96° C.), Luperox TAP (10 hour half-life temperature: 100° C.), Luperox TBIC (10 hour half-life temperature: 99° C.), Luperox TBEC (10 hour half-life temperature: 100° C.), Luperox JW (10 hour half-life temperature: 100° C.), Luperox TAIC (10 hour half-life temperature: 96° C.), Luperox TAEC (10 hour half-life temperature: 99° C.), Luperox DC (10 hour half-life temperature: 117° C.), Luperox 101 (10 hour half-life temperature: 120° C.), Luperox F (10 hour half-life temperature: 116° C.), Luperox DI (10 hour half-life temperature: 129° C.), Luperox 130 (10 hour half-life temperature: 131° C.), Luperox 220 (10 hour half-life temperature: 107° C.), Luperox 230 (10 hour half-life temperature: 109° C.), Luperox 233 (10 hour half-life temperature: 114° C.), and Luperox 531 (10 hour half-life temperature: 93° C.) (all manufactured by Arkema Yoshitomi, Ltd.).

The thermal polymerization initiators may be used individually, or as mixtures of two or more kinds.

Among the electron beam irradiation, light irradiation and a heat treatment, for the purpose of obtaining a charge transport film that does not deteriorate the charge transport skeleton through side reactions and the like and has excellent charge transportability, and from the viewpoint of obtaining a film more efficiently, a heat treatment is desirable.

[Organic Electronic Device]

The organic electronic device according to an exemplary embodiment of the invention has the charge transport film according to the exemplary embodiment of the invention described above. The charge transport film according to the exemplary embodiment has the characteristics described above, and is therefore useful as a charge transport film for organic electronic devices.

Examples of the organic electronic devices according to the exemplary embodiment of the invention include those organic devices used in display materials such as an electrophotographic photoreceptor, an organic electroluminescent system, and an electronic paper, and for solar cells; other memory elements, and wavelength conversion elements.

Specifically, for example, in the case of an organic electroluminescent system, the charge transport film is applied to the charge transport layer (hole transport layer or electron transport layer) that is interposed between a pair of electrodes and a light emitting layer.

Furthermore, for example, in the case of an electronic paper, the charge transport film is applied to the charge transport layer (hole transport layer or electron transport layer) that is interposed between a pair of electrodes and a display layer.

Also, for example, in the case of a solar cell, the charge transport film is applied to the charge transport layer (hole transport layer or electron transport layer) that is interposed between a pair of electrodes and a photoelectric conversion layer.

Hereinafter, as a representative, an electrophotographic photoreceptor (hereinafter, referred to as an electrophotographic photoreceptor according to the exemplary embodiment of the invention) will be described in detail.

The electrophotographic photoreceptor according to the exemplary embodiment of the invention has the charge transport film according to the exemplary embodiment of the invention as an outermost layer.

Specifically, the electrophotographic photoreceptor according to the exemplary embodiment of the invention is, for example, an electrophotographic photoreceptor which includes a conductive substrate, a photosensitive layer provided on the conductive substrate, and optionally a protective layer provided on the photosensitive layer, and has an outermost layer constructed from the charge transport film according to the exemplary embodiment of the invention, as an outermost layer that is provided at the farthest position to the outside from the conductive substrate among the layers provided on the conductive substrate.

It is desirable that the outermost layer be provided particularly as a layer functioning as a protective layer, or as a layer functioning as a charge transport layer.

When the outermost layer is a layer that functions as a protective layer, the electrophotographic photoreceptor may have a configuration having a photosensitive layer, and a protective layer as the outermost layer on a conductive substrate, in which the protective layer is formed from the charge transport film according to the exemplary embodiment of the invention described above.

On the other hand, when the outermost layer is a layer that functions as a charge transport layer, the electrophotographic photoreceptor may have a configuration having a charge generating layer, and a charge transport layer as the outermost layer on a conductive substrate, in which the charge transport layer is formed from the charge transport film according to the exemplary embodiment of the invention described above.

Hereinafter, the electrophotographic photoreceptor according to the exemplary embodiment of the invention will be described in detail with reference to the attached drawings. In the drawings, identical or corresponding parts will be assigned with identical symbols, and overlapping explanations will not be repeated.

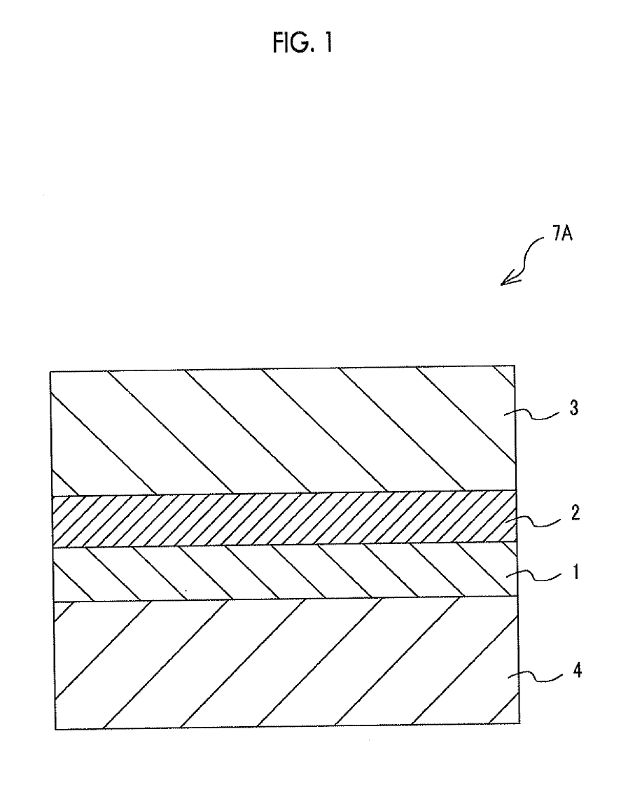

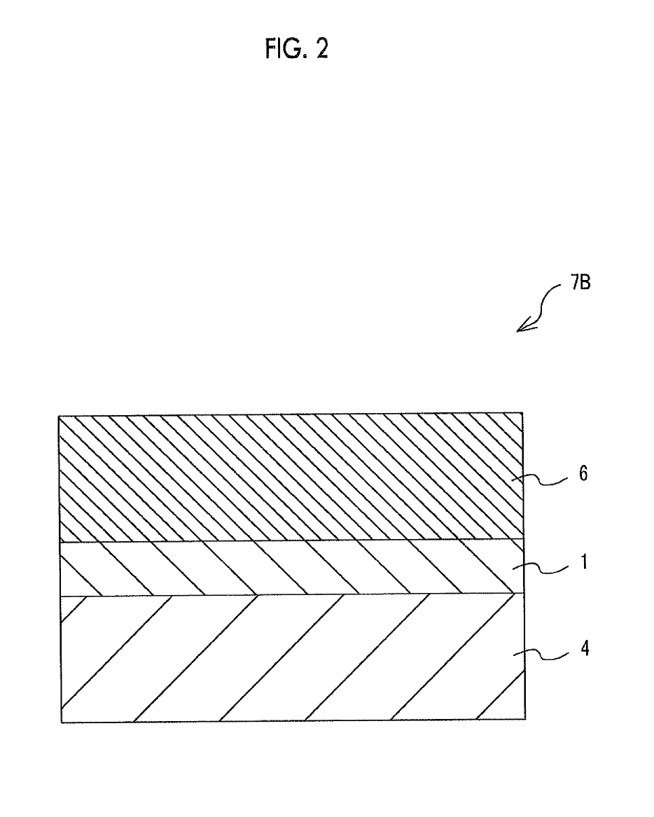

FIG. 1 is a schematic partial cross-sectional diagram showing the electrophotographic photoreceptor according to the exemplary embodiment of the invention. FIG. 2 to FIG. 4 are respectively schematic partial cross-sectional diagrams showing the electrophotographic photoreceptors of other exemplary embodiments of the invention.

The electrophotographic photoreceptor 7A shown in FIG. 1 is a so-called functionally separated photoreceptor (or laminated type photoreceptor), and has a structure in which an undercoat layer 1 is provided on a conductive substrate 4, and a charge generating layer 2 and a charge transport layer 3 are sequentially formed thereon. In the electrophotographic photoreceptor 7A, a photosensitive layer is composed of the charge generating layer 2 and the charge transport layer 3.

The electrophotographic photoreceptor 7B shown in FIG. 2 has a structure in which an undercoat layer 1 is provided on a conductive substrate 4, and a single layer type photosensitive layer 6 is formed thereon. That is, the electrophotographic photoreceptor 7C shown in FIG. 2 contains a charge generating material and a charge transporting material in the same layer (single layer type photosensitive layer 6 (charge generating/charge transport layer)).

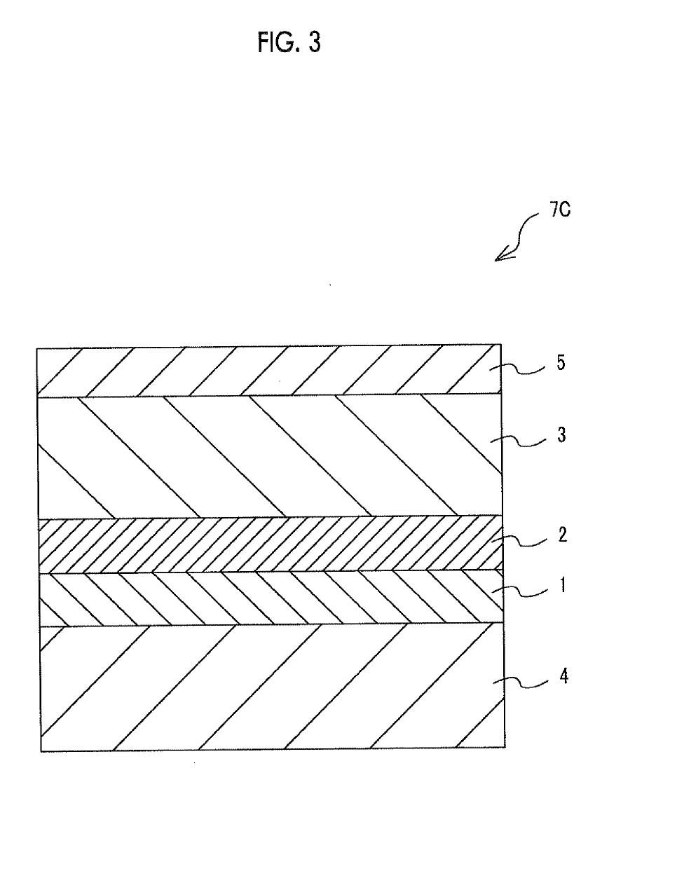

The electrophotographic photoreceptor 7C shown in FIG. 3 has a structure in which a protective layer 5 is provided on the electrophotographic photoreceptor 7A shown in FIG. 1, that is, a structure in which an undercoat layer 1 is provided on a conductive substrate 4, and a charge generating layer 2, a charge transport layer 3 and a protective layer 5 are sequentially formed thereon.

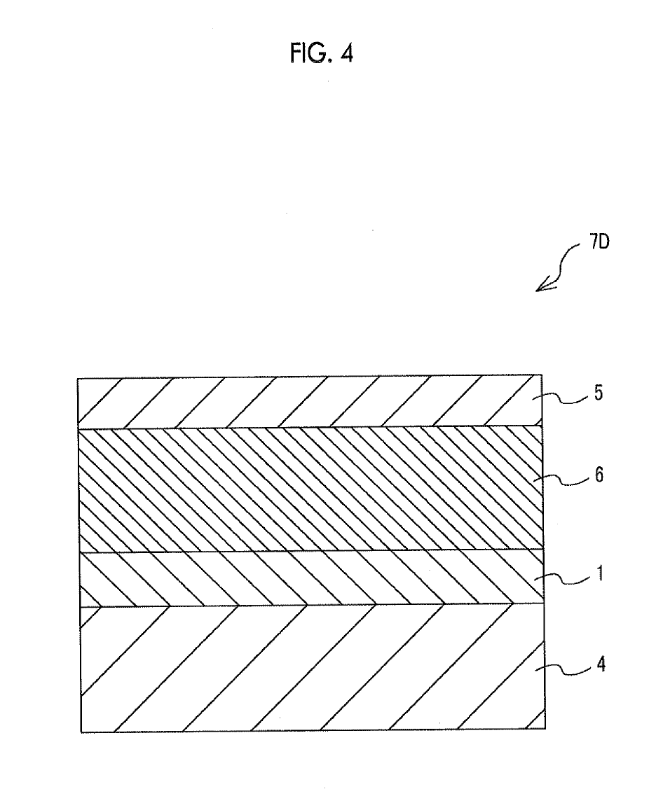

The electrophotographic photoreceptor 7D shown in FIG. 4 has a structure in which a protective layer 5 is provided on the electrophotographic photoreceptor 7B shown in FIG. 2, that is, a structure in which an undercoat layer 1 is provided on a conductive substrate 4, and a single layer type photosensitive layer 6 and a protective layer 5 are sequentially formed thereon.

In the electrophotographic photoreceptor 7A shown in FIG. 1, the charge transport layer 3 is disposed on the farthest side from the conductive substrate 4 as the outermost layer, so that the electrophotographic photoreceptor has a configuration in which the outermost layer is composed of the charge transport film according to the exemplary embodiment of the invention.

In the electrophotographic photoreceptor 7B shown in FIG. 2, the single layer type photosensitive layer 6 is disposed on the farthest side from the conductive substrate 4 as the outermost layer, so that the electrophotographic photoreceptor has a configuration in which the outermost layer is composed of the charge transport film according to the exemplary embodiment of the invention.

In the electrophotographic photoreceptors 7C and 7D shown in FIG. 3 and FIG. 4, the protective layer 5 is disposed on the farthest side from the conductive substrate 4 as the outermost layer, so that the electrophotographic photoreceptor has a configuration in which the outermost layer is composed of the charge transport film according to the exemplary embodiment of the invention.

In the electrophotographic photoreceptors shown in FIG. 1 to FIG. 4, the undercoat layer 1 may or may not be provided.

Hereinafter, the respective elements will be described based on the electrophotographic photoreceptor 7A shown in FIG. 1 as a representative example.

(Conductive Substrate)

There are no particular limitations on the conductive substrate, and for example, a cylindrical substrate made of a metal may be used as a representative substrate. However, other examples include resin films provided with electrically conductive films (for example, metals such as aluminum, nickel, chromium, and stainless steel; and films of aluminum, titanium, nickel, chromium, stainless steel, gold, vanadium, tin oxide, indium oxide, and indium tin oxide (ITO)); paper coated with or impregnated with a conductivity imparting agent, and resin films coated with or impregnated with a conductivity imparting agent. The shape of the substrate is not limited to a cylindrical shape, and may be a sheet form or a plate form.

It is desirable that the conductive substrate have conductivity to the extent that, for example, the volume resistance of the conductive area is less than 10⁷ Ω·cm.

When a cylindrical body made of a metal is used as the conductive substrate, the surface may be in the state of plain tube, or may be treated in advance by mirror surface cutting, etching, anodization, coarse cutting, centerless polishing, sand blasting, wet honing, or the like.

(Undercoat Layer)

The undercoat layer is provided as necessary, for the purpose of preventing light reflection at the surface of the conductive substrate, preventing incorporation of unnecessary carriers from the conductive substrate to the photosensitive layer, and the like.

The undercoat layer is composed of, for example, a binding resin and optionally other additives.

Examples of the binding resin contained in the undercoat layer include known resins (for example, an acetal resin such as polyvinyl butyral, a polyvinyl alcohol resin, casein, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol resin, a phenol-formaldehyde resin, a melamine resin, and a urethane resin), and conductive resins (for example, a charge transporting resin having a charge transporting group, or polyaniline). Among these, the binding resin is desirably a resin which is insoluble in the coating solvent of the upper layer, and specifically, a phenolic resin, a phenol-formaldehyde resin, a melamine resin, a urethane resin, an epoxy resin and the like are desirable.

It is desirable that the conductive resin have conductivity to the extent that, for example, the volume resistance is less than 10⁷ Ω·cm.

The undercoat layer may contain, for example, a metal compound such as a silicon compound, an organozirconium compound, an organotitanium compound, or an organoaluminum compound.

The ratio between the metal compound and the binding resin is not particularly limited, and is set in the range by which the intended electrophotographic photoreceptor characteristics may be obtained.

The undercoat layer may have, for example, resin particles added into the undercoat layer for the regulation of the surface roughness. Examples of the resin particles include silicone resin particles, and cross-linked polymethyl methacrylate (PMMA) resin particles. Furthermore, an undercoat layer may be formed for the regulation of the surface roughness, and then the surface may be polished. Examples of the method for polishing include buff polishing, sand blast treatment, wet honing, and grinding treatment.

Here, an example of the constitution of the undercoat layer may be a constitution containing at least a binding resin and conductive particles.

It is desirable that the conductive particles have conductivity to the extent that the volume resistance is less than 10⁷ Ω·cm.

Examples of the conductive particles include metal particles (particles of aluminum, copper, nickel, or silver), conductive metal oxide particles (particles of antimony oxide, indium oxide, tin oxide, or zinc oxide), and conductive substance particles (particles of carbon fiber, carbon black, or graphite powder). Among these, conductive metal oxide particles are favorable. The conductive particles may be used as mixtures of two or more kinds.

Furthermore, the conductive particles may be used, for example, after being subjected to a surface treatment with a hydrophobizing agent (for example, a coupling agent) and resistance adjustment.

The content of the conductive particles is, for example, in the range of from 10% by mass to 80% by mass, and preferably in the range of from 40% by mass to 80% by mass, based on the mass of the binding resin.

At the time of forming the undercoat layer, for example, a coating liquid for undercoat layer formation prepared by adding the components described above to a solvent is used.

As the method of dispersing particles in the coating liquid for undercoat layer formation, for example, a media dispersing machine such as a ball mill, a vibrating ball mill, an attriter, or a sand mill; or a medialess dispersing machine such as a stirrer, an ultrasonic dispersing machine, a roll mill, or a high pressure homogenizer is used. Here, examples of the high pressure homogenizer include a collision system which disperses a dispersing liquid in a high pressure state through liquid-liquid collision or liquid-wall collision, or a penetration system which disperses by making a dispersion liquid in a high pressure state pass through a flow channel.

Examples of the method of applying the coating liquid for undercoat layer formation on a conductive substrate include a dipping coating method, a toss coating method, a wire bar coating method, a spray coating method, a blade coating method, a knife coating method, and a curtain coating method.

The thickness of the undercoat layer is, for example, in the range of 15 μm or greater, and preferably in the range of from 20 μm to 50 μm.

Here, although not depicted, for example, an intermediate layer may be further provided between the undercoat layer and the photosensitive layer. Examples of the binding resin that is used in the intermediate layer include polymer resin compounds such as an acetal resin (for example, polyvinyl butyral), a polyvinyl alcohol resin, casein, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin, and other examples include organometallic compounds containing zirconium, titanium, aluminum, manganese and silicon atoms. These compounds may be used individually, or as mixtures or polycondesation products of plural compounds. Among them, when an organometallic compound containing zirconium or silicon is used, it is likely to obtain a photoreceptor having a lower residual potential, less change in potential due to environmental factors, and less change in potential due to repeated use, as compared with the case of using other binding resins.

At the time of forming an intermediate layer, for example, a coating liquid for intermediate layer formation prepared by adding the components described above to a solvent is used.

Examples of the method of applying the coating liquid for intermediate layer formation include a dipping coating method, a toss coating method, a wire bar coating method, a spray coating method, a blade coating method, a knife coating method, and a curtain coating method.

In addition to an improvement of application properties of the upper layer, the intermediate layer also plays the role of, for example, an electrical blocking layer. However, if the layer thickness is too large, the electrical barrier becomes excessively strong and may cause an increase in potential due to desensitization or repetition.

Therefore, in the case of forming an intermediate layer, for example, it is desirable to adjust the thickness in the range of from 0.1 μm to 3 μm. Also, in this case, the intermediate layer may be used as the undercoat layer.

(Charge Generating Layer)

The charge generating layer contains, for example, a charge generating material and a binding resin.

Examples of a charge generating material that constitutes the charge generating layer include phthalocyanine pigments such as metal-free phthalocyanine, chlorogallium phthalocyanine, hydroxygallium phthalocyanine, dichlorotin phthalocyanine, and titanyl phthalocyanine. Particularly, a chlorogallium phthalocyanine crystal having strong diffraction peaks at Bragg's angles (2θ±0.2°) of at least 7.4°, 16.6°, 25.5° and 28.3° with respect to the CuKα characteristic X-ray; a metal-free phthalocyanine crystal having strong diffraction peaks at Bragg's angles (2θ±0.2°) of at least 7.7°, 9.3°, 16.9°, 17.5°, 22.4° and 28.8° with respect to the CuKα characteristic X-ray; a hydroxygallium phthalocyanine crystal having strong diffraction peaks at Bragg's angles (2θ±0.2°) of at least 7.5°, 9.9°, 12.5°, 16.3°, 18.6°, 25.1°, and 28.3° with respect to the CuKα characteristic X-ray; and a titanyl phthalocyanine crystal having strong diffraction peaks at Bragg's angles (2θ±0.2°) of at least 9.6°, 24.1° and 27.2° with respect to the CuKα characteristic X-ray. Other examples of the charge generating material include a quinone pigment, a perylene pigment, an indigo pigment, a bisbenzimidazole pigment, an anthrone pigment, and a quinacridone pigment. These charge generating materials may be used individually, or as mixtures of two or more kinds.

Examples of the binding resin that constitutes the charge generating layer include a polycarbonate resin (for example, bisphenol A type, and bisphenol Z type), an acrylic resin, a methacrylic resin, a polyallylate resin, a polyester resin, a polyvinyl chloride resin, a polystyrene resin, an acrylonitrile-styrene copolymer resin, an acrylonitrile-butadiene copolymer, a polyvinyl acetate resin, a polyvinylformal resin, a polysulfone resin, a styrene-butadiene copolymer resin, a vinylidene chloride-acrylonitrile copolymer resin, a vinyl chloride-vinyl acetate-maleic anhydride resin, a silicone resin, a phenol-formaldehyde resin, a polyacrylamide resin, a polyamide resin, and a poly-N-vinylcarbazole resin. These binding resins may be used individually, or as mixtures of two or more kinds.

The mixing ratio of the charge generating material and the binding resin (charge generating material:binding resin) may be, for example, in the range of 10:1 to 1:10 on a mass basis.

At the time of forming the charge generating layer, for example, a coating liquid for charge generating layer formation prepared by adding the components described above to a solvent, is used.

As the method of dispersing particles (for example, a charge generating material) in the coating liquid for charge generating layer formation, for example, a media dispersing machine such as a ball mill, a vibrating ball mill, an attriter, or a sand mill; or a medialess dispersing machine such as a stirrer, an ultrasonic dispersing machine, a roll mill, or a high pressure homogenizer is used. Examples of the high pressure homogenizer include a collision system which disperses a dispersing liquid in a high pressure state through liquid-liquid collision or liquid-wall collision, or a penetration system which disperses by making a dispersion liquid in a high pressure state pass through a flow channel.

Examples of the method of applying the coating liquid for charge generating layer formation on the undercoat layer include a dipping coating method, a toss coating method, a wire bar coating method, a spray coating method, a blade coating method, a knife coating method, and a curtain coating method.

The thickness of the charge generating layer may be, for example, in the range of from 0.01 μm to 5 μm, and preferably in the range of from 0.05 μm to 2.0 μm.

(Charge Transport Layer)

The charge transport layer is formed by applying the charge transport film according to the exemplary embodiment of the invention.

The thickness of the charge transport layer may be, for example, in the range of from 5 μm to 50 μm, and preferably in the range of from 10 μm to 40 μm.

Thus, an example of a functionally separated type electrophotographic photoreceptor according to the exemplary embodiment of the invention has been described. However, in the case of the layer configuration of the electrophotographic photoreceptor shown in FIG. 2, the single layer type photosensitive layer (charge generating/charge transport layer) is positioned at the outermost part in the layer configuration as the outermost layer, and the charge transport film according to the exemplary embodiment of the invention is applied to this single layer type photosensitive layer. In this case, the charge transport film according to the exemplary embodiment of the invention contains a charge generating material, and the content of the material may be, for example, in the range of from 10% by mass to 85% by mass, and preferably in the range of from 20% by mass to 50% by mass, based on the total solids content by mass. The thickness of the single layer type photosensitive layer (charge generating/charge transport layer) may be, for example, in the range of from 5.1 μm to 50 μm, and preferably in the range of from 10 μm to 40 μm.

In this exemplary embodiment, an electrophotographic photoreceptor in which the outermost layer formed from the charge transport film according to the exemplary embodiment of the invention as a charge transport layer has been described. However, in the case of a layer configuration having a protective layer as in the electrophotographic photoreceptors shown in FIG. 3 and FIG. 4, the protective layer is positioned at the outermost part of the layer configuration as the outermost layer, and the charge transport film according to the exemplary embodiment of the invention is applied to this protective layer. The thickness of the protective layer may be, for example, in the range of from 1 μm to 15 μm, and preferably in the range of from 3 μm to 10 μm.

For the compositions of the charge transport layer and the single layer type photosensitive layer in the case of having a protective layer, well-known compositions are employed.

[Image Forming Apparatus/Process Cartridge]

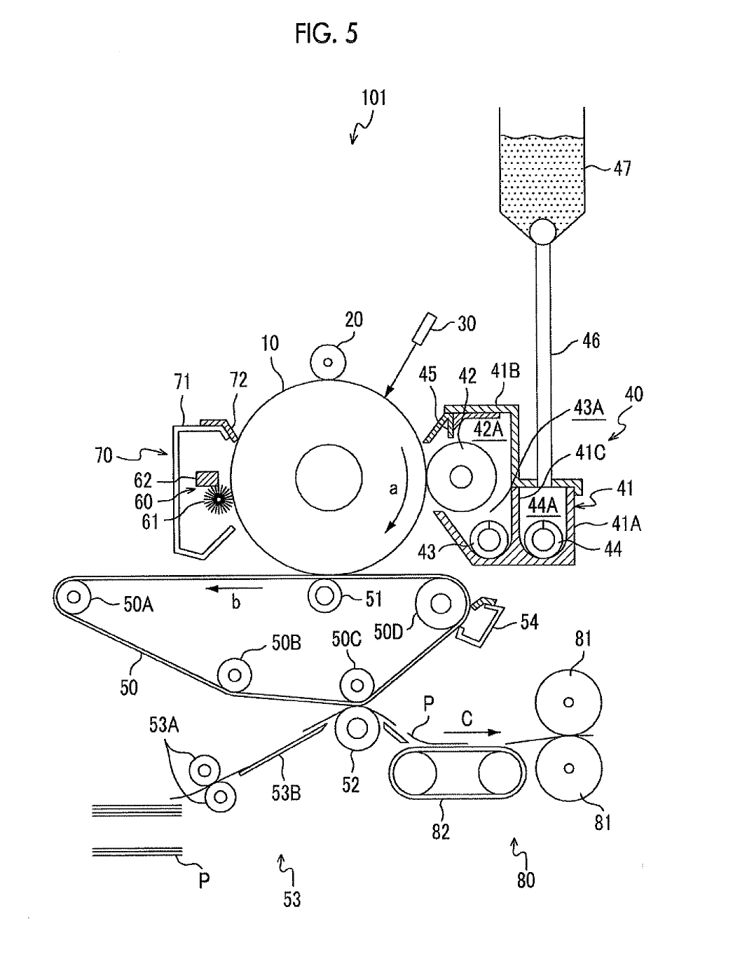

FIG. 5 is a schematic configuration diagram showing an example of an image forming apparatus according to an exemplary embodiment of the invention.

The image forming apparatus 101 according to the exemplary embodiment of the invention includes, as shown in FIG. 5, for example, an electrophotographic photoreceptor 10 (the electrophotographic photoreceptor according to the exemplary embodiment of the invention described above) which rotates in the clockwise direction as indicated by the arrow a; a charging apparatus 20 (an example of a charging unit) which is provided upstream to the electrophotographic photoreceptor 10 so as to face the electrophotographic photoreceptor 10, and charges the surface of the electrophotographic photoreceptor 10; an exposure apparatus 30 (an example of an electrostatic latent image forming unit) which exposes the surface of the electrophotographic photoreceptor 10 that has been charged by the charging apparatus 20, and forms an electrostatic latent image; a developing apparatus 40 (an example of a developing unit) which holds a developer containing a toner, and develops the electrostatic latent image formed on the electrophotographic photoreceptor 10 into a toner image using the developer; a belt-shaped intermediate transfer body 50 which runs in the direction indicated by the arrow b while being in contact with the electrophotographic photoreceptor 10, and transfers the toner image formed on the surface of the electrophotographic photoreceptor 10; and a cleaning apparatus 70 (an example of a cleaning unit) which cleans the surface of the electrophotographic photoreceptor 10.

The charging apparatus 20, exposure apparatus 30, developing apparatus 40, intermediate transfer body 50 and cleaning apparatus 70, and a lubricant supplying apparatus 60 are arranged in a circumferential form that surrounds the electrophotographic photoreceptor 10, in the clockwise direction. In the exemplary embodiment of the invention, a configuration in which a lubricant supplying apparatus 60 is disposed inside the cleaning apparatus 70 will be described, but the configuration is not limited to this, and a configuration in which a lubricant supplying apparatus 60 is disposed apart from the cleaning apparatus 70 may also be used. A configuration in which a lubricant supplying apparatus 60 is not provided may also be used.

The intermediate transfer body 50 is maintained while tension is applied from the inside by supporting rollers 50A and 50B, a backside roller 50C and a driving roller 500, and is also driven in the direction of the arrow b along with the rotation of the driving roller 50D. A primary transfer apparatus 51 which charges the intermediate transfer body 50 to a polarity different from the charging polarity of the toner, and tranfers the toner on the electrophotographic photoreceptor 10 on the outer surface of the intermediate transfer body 50, is provided at the position which faces the electrophotographic photoreceptor 10 in the inner side of the intermediate transfer body 50. On the outer side in the lower area of the intermediate transfer body 50, a secondary transfer apparatus 52 which charges a recording paper P (an example of the transfer medium) to a polarity different from the charging polarity of the toner, and transfers the toner image formed on the intermediate transfer body 50 onto the recording paper P, is provided to face the backside roller 50C. These members for transferring the toner image formed on the electrophotographic photoreceptor 10 onto a recording paper P correspond to an example of the transfer unit.

Provided at the lower area of the intermediate transfer body 50 are a recording paper supplying apparatus that supplies the recording paper P to the secondary transfer apparatus 52, and a fixing apparatus 80 that fixes the toner image while conveying the recording paper P on which the toner image has been formed in the secondary transfer apparatus 52.

The recording paper supplying apparatus 53 includes a pair of conveying rollers 53A, and a guide plate 53B which guides the recording paper P that is conveyed to the conveying rollers 53A toward the secondary transfer apparatus 52. On the other hand, the fixing apparatus 80 has fixing rollers 81, which are a pair of heating rollers that perform fixing of the toner image by heating and pressing the recording paper P onto which the toner image has been transferred by the secondary transfer apparatus 52, and a conveying rotating body 82 which conveys the recording paper P toward the fixing rollers 81.

The recording paper P is conveyed by the recording paper supplying apparatus 53, the secondary transfer apparatus 52, and the fixing apparatus 80, to the direction indicated by the arrow c.

The intermediate transfer body 50 is further provided with an intermediate transfer body cleaning apparatus 54 which has a cleaning blade that removes the toner remaining on the intermediate transfer body 50 after the toner image is transferred to the recording paper P in the secondary transfer apparatus 52.

Hereinafter, the constituent members in the image forming apparatus 101 according to the exemplary embodiment of the invention will be described in detail.

Charging Apparatus

An example of the charging apparatus 20 may be a contact type charging machine using a conductive charging roller, a charging brush, a charging film, a charging rubber blade, or a charging tube. Examples of the charging apparatus 20 include a non-contact type roller charging machine, and charging machine that are known, such as a scorotron charging machine and a corotron charging machine which utilize corona discharge. The charging apparatus 20 is desirably a contact type charging machine.

Exposure Apparatus

An example of the exposure apparatus 30 may be an optical instrument which imagewise exposes the surface of the electrophotographic photoreceptor 10 to light such as a semiconductor laser light, an LED light, or a liquid crystal shutter light. The wavelength of the light source may be in the spectral sensitivity region of the electrophotographic photoreceptor 10. The semiconductor laser light may be, for example, near-infrared radiation having an emission wavelength of approximately 780 nm. However, the semiconductor laser light is not limited to this wavelength, and a laser light having an emission wavelength in the region of 600 nm, or a blue laser light having an emission wavelength of from 400 nm to 450 nm may also be used. Furthermore, for the exposure apparatus 30, a surface emission type laser light source of multi-beam output type is also effective, for example, for the formation of color images.

Developing Apparatus

The developing apparatus 40 is, for example, disposed to face the electrophotographic photoreceptor 10 in the development region, and includes, for example, a developing container 41 (the main body of the developing apparatus) that holds a two-component developer composed of a toner and a carrier, and a holding container for developer for replenishment (toner cartridge) 47. The developing container 41 has the developing container main body 41A and a developing container cover 41B that closes the top of the developing container.

The developing container main body 41A has, for example, a developing roller chamber 42A that holds a developing roller 42 in the inside of the main body, and includes a first stirring chamber 43A that is adjacent to the developing roller chamber 42A, and a second stirring chamber 44A that is adjacent to the first stirring chamber 43A. Furthermore, provided inside the developing roller chamber 42A is, for example, a layer thickness regulating member 45 for regulating the layer thickness of the developer on the surface of the developing roller 42 when the developing container cover 41B is mounted on the developing container main body 41A.

The space between the first stirring chamber 43A and the second stirring chamber 44A is divided by, for example, a partition wall 41C. Although not depicted, the first stirring chamber 43A and the second stirring chamber 44A are in communication because the partition wall 41C has openings at the two ends in the longitudinal direction (the longitudinal direction of the developing apparatus), and the first stirring chamber 43A and the second stirring chamber 44A constitute a circulating stirring chamber (43A+44A).

A developing roller 42 is disposed in the developing roller chamber 42A so as to face the electrophotographic photoreceptor 10. Although not depicted, the developing roller 42 is provided with a sleeve on the outer side of a magnetic roller (fixed magnet) having magnetic properties. The developer of the first stirring chamber 43A is adsorbed onto the surface of the developing roller 42 by the magnetic force of the magnetic roller, and is conveyed to the development region. The developing roller 42 is such that the roller axis is supported by the developing container main body 41A to rotate freely. Here, the developing roller 42 and the electrophotographic photoreceptor 10 rotate in the reverse direction, and the developer adsorbed on the surface of the developing roller in the opposite area is conveyed to the development region in the same direction as the processing direction of the electrophotographic photoreceptor 10.

The sleeve of the developing roller 42 is connected to a bias power supply (not depicted) so that a developing bias is applied thereto (according to the exemplary embodiment, a bias obtained by superimposing the direct current component (AC) and the alternating current component (DC) is applied so that an alternating electric field is applied to the development region).

Disposed in the first stirring chamber 43A and the second stirring chamber 44A are a first stirring member 43 (stirring/conveying member) and a second stirring member 44 (stirring/conveying member), which convey the developer while stirring. The first stirring member 43 is composed of a first rotating axis that is extended in the axial direction of the developing roller 42, and a stirring conveying blade (projection) fixed in a helical form around the periphery of the rotating axis. Furthermore, the second stirring member 44 is also similarly composed of a second rotating axis and a stirring conveying blade (projection). Furthermore, the stirring members are supported by the developing container main body 41A to rotate freely. The first stirring member 43 and the second stirring member 44 are arranged such that the developer in the first stirring chamber 43A and the developer in the second stirring chamber 44A are conveyed in mutually reverse directions by the rotation of the stirring members.

One end in the longitudinal direction of the second stirring chamber 44A is connected to an end of a replenishment conveying channel 46 for supplying a developer for replenishment containing a toner for replenishment and a carrier for replenishment to the second stirring chamber 44A. The other end of the replenishment conveying channel 46 is connected to a holding container for developer for replenishment 47 which holds the developer for replenishment.

As such, the developing apparatus 40 supplies the developer for replenishment from the holding container for developer for replenishment (toner cartridge) 47 to the developing apparatus 40 (the second stirring chamber 44A) through the replenishment conveying channel 46.

Here, the developer used in the developing apparatus 40 will be described.

As the developer, for example, a two-component developer containing a toner and a carrier is employed.

Transfer Apparatus

Examples of the primary transfer apparatus 51 and the secondary transfer apparatus 52 include a contact-type transfer charging machine using a belt, a roller, a film, a rubber blade or the like, and known transfer charging machines that are known, such as a scorotron transfer charging machine and a corotron transfer charging machine that utilize corona discharge.

As the intermediate transfer body 50, a belt-shaped transfer body (intermediate transfer belt) made of polyimide, polyamideimide, polycarbonate, polyallylate, polyester, rubber or the like, containing a conductive agent, is used. Other shapes of the intermediate transfer body that may be used include a cylindrical shape in addition to the belt shape.

Cleaning Apparatus

The cleaning apparatus 70 includes a casing 71; a cleaning blade 72 that is arranged to be protruding from the casing 71; and a lubricant supplying apparatus 60 that is located downstream of the cleaning blade 72 along the rotating direction of the electrophotographic photoreceptor 10.

The cleaning blade 72 may be supported at the edges of the casing 71, or may be supported separately by a supporting member (holder). However, the exemplary embodiment adopts the form in which the cleaning blade 72 is supported at the edges of the casing 71.

First, the cleaning blade 72 will be described.

Examples of the material that constitutes the cleaning blade 72 include urethane rubber, silicone rubber, fluorine rubber, propylene rubber, and butadiene rubber. Among these, urethane rubber is favorable.

The urethane rubber (polyurethane) is not particularly limited, for example, as long as it is conventionally used in the formation of polyurethane. For example, a urethane prepolymer formed from a polyol (for example, a polyester polyol such as polyethylene adipate, or polycaprolactone), and an isocyanate (for example, diphenylmethane diisocyanate) may be used. Furthermore, it is desirable that the urethane rubber (polyurethane) use a cross-linking agent for, for example, 1,4-butanediol, trimethylolpropane, ethylene glycol or a mixture thereof, as a raw material.

Next, the lubricant supplying apparatus 60 will be described.

The lubricant supplying apparatus 60 is, for example, inside the cleaning apparatus 70, and is located upstream of the cleaning blade 72 along the rotating direction of the electrophotographic photoreceptor 10.

The lubricant supplying apparatus 60 is, for example, composed of a rotating brush 61 that is disposed in contact with the electrophotographic photoreceptor 10, and a solid-state lubricant 62 that is disposed in contact with the rotating brush 61. In the lubricant supplying apparatus 60, when the rotating brush 61 is rotated while being in contact with the solid-state lubricant 62, the lubricant 62 adheres to the rotating brush 61, and the adhering lubricant 62 is supplied to the surface of the electrophotographic photoreceptor 10, so that a coating film of the lubricant 62 is formed thereon.

The lubricant supplying apparatus 60 is not limited to the form described above, and for example, may employ a rubber roller instead of the rotating brush 61.

Next, the operation of the image forming apparatus 101 according to the exemplary embodiment of the invention will be described. First, as the electrophotographic photoreceptor 10 rotates along the direction indicated by the arrow a, the electrophotographic photoreceptor 10 is simultaneously charged negatively by the charging apparatus 20.

The electrophotographic photoreceptor 10 having the surface negatively charged by the charging apparatus 20, is exposed by the exposure apparatus 30, and a latent image is formed on the surface.

When the area on the electrophotographic photoreceptor 10 where a latent image has been formed is brought close to the developing apparatus 40, the toner adheres to the latent image by the developing apparatus 40 (developing roller 42), and a toner image is formed.

When the electrophotographic photoreceptor 10 having a toner image formed thereon further rotates in the direction indicated by the arrow a, the toner image is transferred to the outer surface of the intermediate transfer body 50.

When the toner image is transferred to the intermediate transfer body 50, a recording paper P is supplied to the secondary transfer apparatus 52 by the recording paper supplying apparatus 53, and the toner image transferred onto the intermediate transfer body 50 is transferred onto the recording paper P by the secondary transfer apparatus 52. Thereby, the toner image is formed on the recording paper P.

On the recording paper P on which an image is formed, the toner image is fixed by the fixing apparatus 80.

Here, after the toner image has been transferred to the intermediate transfer body 50, in the electrophotographic photoreceptor 10, the lubricant 62 is supplied to the surface of the electrophotographic photoreceptor 10 by the lubricant supplying apparatus 60 after the transfer, and a film of the lubricant 62 is formed on the surface of the electrophotographic photoreceptor 10. Thereafter, any toner remaining on the surface or discharge product is removed by the cleaning blade 72 of the cleaning apparatus 70. The electrophotographic photoreceptor 10 having the residual toner or discharge product removed by the cleaning apparatus 70, is charged again by the charging apparatus 20, and is exposed by the exposure apparatus 30, so that a latent image is formed.

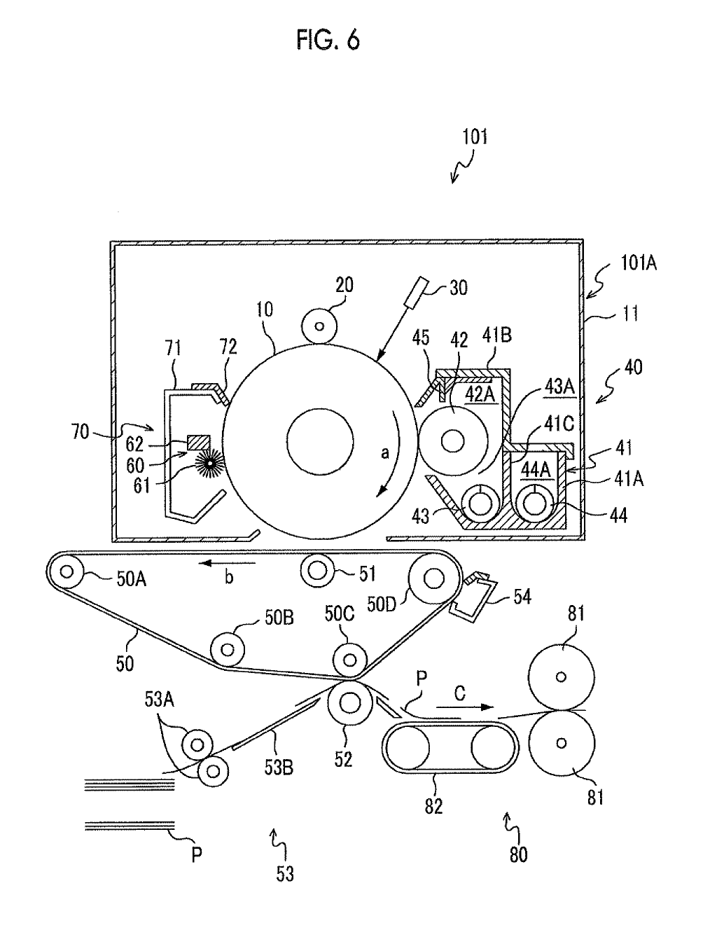

Furthermore, the image forming apparatus 101 according to the exemplary embodiment may include, for example, as shown in FIG. 6, a process cartridge 101A in which the electrophotographic photoreceptor 10, charging apparatus 20, developing apparatus 40, lubricant supplying apparatus 60, and cleaning apparatus 70 are integrally held in a casing 11. This process cartridge 101A integrally holds plural members, and is detachable from the image forming apparatus 101. In the image forming apparatus 101 shown in FIG. 6, the holding container for developer for replenishment 47 is not provided in the developing apparatus 40.

The configuration of the process cartridge 101A is not limited to this, and for example, the process cartridge 101A may include at least the electrophotographic photoreceptor 10, and may further include, in addition to that, for example, at least one selected from the charging apparatus 20, the exposure apparatus 30, the developing apparatus 40, the primary transfer apparatus 51, the lubricant supplying apparatus 60 and the cleaning apparatus 70.

The image forming apparatus 101 according to the exemplary embodiment of the invention is not limited to the configuration described above, and for example, the image forming apparatus 101 may be provided with a first erasing device which is located around the electrophotographic photoreceptor 10, downstream of the primary transfer apparatus 51 along the rotating direction of the electrophotographic photoreceptor 10, and upstream of the cleaning apparatus 70 along the rotating direction of the electrophotographic photoreceptor 10, and which align the polarity of the remaining toner to make the toner easily removable by the cleaning brush. The image forming apparatus 101 may also be provided with a second erasing device which is located downstream of the cleaning apparatus 70 along the rotating direction of the electrophotographic photoreceptor, and upstream of the charging apparatus 20 along the rotating direction of the electrophotographic photoreceptor, and which erases static charge from the surface of the electrophotographic photoreceptor 10.

The image forming apparatus 101 according to the exemplary embodiment of the invention is not limited to the configuration described above, and any well-known configuration, for example, a system which directly transfers the toner image formed on the electrophotographic photoreceptor 10 to the recording paper P may be employed, or a tandem type image forming apparatus may also be employed.

### EXAMPLES

Hereinafter, the invention will be more specifically described based on Examples, but the invention is not intended to be limited to these Examples.

### Example 1

### Preparation of Samples for Evaluation of Charge Transportability and for Evaluation for Friction and Wear Test

Preparation of Undercoat Layer

100 parts by mass of zinc oxide (average particle size 70 nm: manufactured by Tayca Corp.; specific surface area 15 m²/g) is mixed under stirring with 500 parts by mass of toluene, and 1.3 parts by mass of a silane coupling agent (KBM503: manufactured by Shin-Etsu Chemical Co., Ltd.) is added thereto. The resulting mixture is stirred for 2 hours. Subsequently, toluene is distilled off by distillation under reduced pressure, and the residue is baked for 3 hours at 120° C. Thus, a silane coupling agent-surface treated zinc oxide is obtained.

110 parts by mass of the surface treated zinc oxide is mixed under stirring with 500 parts by mass of tetrahydrofuran, and a solution prepared by dissolving 0.6 part by mass of alizarin in 50 parts by mass of tetrahydrofuran, is added thereto. The resulting mixture is stirred for 5 hours at 50° C. Subsequently, the zinc oxide with alizarin is separated by filtration under reduced pressure, and is dried under reduced pressure at 60° C. Thus, zinc oxide with alizarin is obtained.

38 parts by mass of a solution prepared by dissolving 60 parts by mass of this zinc oxide with alizarin, 13.5 parts by mass of a curing agent (blocked isocyanate Sumijule 3175, manufactured by Sumitomo Bayer Urethane Co., Ltd.), and 15 parts by mass of a butyral resin (S-Lec BM-1, manufactured by Sekisui Chemical Co., Ltd.) in 85 parts by mass of methyl ethyl ketone, is mixed with 25 parts by mass of methyl ethyl ketone, and the mixture is dispersed for 2 hours with a sand mill using 1 mmφ glass beads. Thus, a dispersion liquid is obtained.

0.005 part by mass of dioctyltin dilaurate as a catalyst and 40 parts by mass of silicone resin particles (Tospearl 145, manufactured by GE Toshiba Silicone Co., Ltd.) are added to the dispersion liquid thus obtained, and thus a coating liquid for undercoat layer formation is obtained. This coating liquid is applied on a plate-shaped aluminum substrate by a dipping coating method, and the coating liquid is dried and cured at 170° C. for 40 minutes. Thus, an undercoat layer having a thickness of 18 μm is obtained.

Preparation of Charge Generating Layer

A mixture of 15 parts by mass of hydroxygallium phthalocyanine having diffraction peaks at Bragg's angles (2θ±0.2°) of at least 7.3°, 16.0°, 24.9° and 28.0° in the X-ray diffraction spectrum obtained by using the CuKα characteristic X-ray, as a charge generating substance, 10 parts by mass of a vinyl chloride-vinyl acetate copolymer resin (VMCH, manufactured by Nippon Unicar Co., Ltd.) as a binding resin, and 200 parts by mass of n-butyl acetate is dispersed for 4 hours with a sand mill using glass beads having a diameter of 1 mmφ. 175 parts by mass of n-butyl acetate and 180 parts by mass of methyl ethyl ketone are added to the dispersion thus obtained, and the mixture is stirred. Thus a coating liquid for charge generating layer formation is obtained. This coating liquid for charge generating layer formation is applied on the undercoat layer, and is dried at normal temperature. Thus, a charge generating layer having a thickness of 0.2 μm is formed.
Preparation of Charge Transport Layer

0.801 g of a compound [(a-1)] represented by formula (ii-18), which is a compound having a reactive functional group having a carbon double bond and having a charge transporting skeleton, and 0.381 g of Karenz MT PE1 (pentaerythritol tetrakis(3-mercaptobutyrate), manufactured by Showa Denko K.K.) [(b-1)], which is a compound having an -ol group and not having a charge transporting skeleton are dissolved in 1.410 g of a mixed solvent of tetrahydrofuran (THF: containing no stabilizer, manufactured by Wako Pure Chemical Industries, Ltd.)/toluene (dehydrated, manufactured by Wako Pure Chemical Industries, Ltd.)=50 parts by mass/50 parts by mass. Subsequently, VE-70 (manufactured by Wako Pure Chemical Industries, Ltd.), which is a polymerization initiator, is added in an amount of 0.024 g, which is equivalent to 2% by mass of the total amount of the compounds (a-1) and (b-1), and the mixture is dissolved. This solution is used as a coating liquid for charge transport layer formation (charge transporting composition).

This coating liquid is applied on the charge generating layer by a blade method at a gap interval of 0.15 mm, and then the system is treated by heating at a temperature of 150±5° C. for 60 minutes at an oxygen concentration of 300 ppm or less. Thus, a charge transport film is formed, and this is used as the charge transport layer. The thickness of this charge transport layer is 32

The operation described above is carried out, and thus samples for the evaluation of charge transportability and for the evaluation of a friction and wear test are produced.

### Preparation of Sample for Evaluation for Flexural Bending Test

The coating liquid for charge transport layer formation is applied on a glass substrate by a blade method at a gap interval of 0.30 mm, and is similarly heated. Thus, a charge transport film is formed. The thickness of the charge transport film is 69 μm.

The operation as described above is carried out, and thus a sample for the evaluation of a flexural bending test is produced.

### Preparation of Electrophotographic Photoreceptor

An undercoat layer, a charge generating layer, and a charge transport layer are formed on a plate-shaped aluminum substrate in the same manner as in the case of the samples for the evaluation of charge transportability and the evaluation for a friction and wear test, and this aluminum substrate with the various layers formed thereon is wound around a cylindrical aluminum substrate for adhesion such that the charge transport layer faces outward.

The operation as described above is carried out, and thus an electrophotographic photoreceptor is produced.

### Examples 2 to 27, and Comparative Examples 1 to 11

Samples for various evaluations, and electrophotographic photoreceptors are produced in the same manner as in Example 1, except that the compositions of the coating liquids for charge transport layer formation (charge transporting compositions) are modified according to Table 1 to Table 3, and the coating liquids for charge transport layer formation (charge transporting compositions) thus obtained are used.

[Evaluation]

The samples for various evaluations and the electrophotographic photoreceptors produced in the respective Examples are subjected to the following evaluations. The results are shown in Table 4 to Table 6.

Measurement of Sulfur Atom Content of Charge Transport Layer (Charge Transport Film)

The charge transport layers (charge transport films) are shaved off from the respective electrophotographic photoreceptors thus produced, using a cutter knife. Samples are collected, and the sulfur atom content is measured according to an elemental analysis method using x-ray fluorescence.

Identification of the Cross-Linked Resin Constituting Charge Transport Layer (Charge Transport Film)

The charge transport layer (charge transport film) of the electrophotographic photoreceptor thus produced is scraped at the surface for about 1 cm with at least 10 strokes, using a cotton swab impregnated with tetrahydrofuran. When the film is dissolved and the trace of the cotton swab scraping is observed by visual inspection, the resin is considered to be non-cross-linked. When no scraping trace is observed, the resin is considered to be cross-linked.

Evaluation of Charge Transportability

For the samples for the evaluation of charge transportability thus produced, the light attenuation is measured using an electrostatic charge tester (EPA8200, manufactured by Kawaguchi Electric Works Co., Ltd.) in an environment of 25±3° C. and 50±10% RH, using a small-area mask having a diameter of 20 mmφ. The conditions are shown below.
Initial surface potential=−550.0 (V)
Dark decay time from immediately after charging to exposure=1.0 s; the surface potential at that time is designated as V₁ (V), the surface potential 0.2 s after exposure is designated as V₂ (V), and the light attenuation is determined by the formula: (V₁−V₂)/V₁×100(%).
The residual surface potential 1.0 s after exposure is designated as V₃ (V).

In the evaluation described above, a high light attenuation and a residual potential close to zero, imply that the sample film has an excellent photoelectric conversion rate and a small electric trap. This also proves that the film has an excellent charge transport function.

Evaluation for Friction and Wear Test

The samples produced for the evaluation of a friction and wear test are subjected to a friction and wear test using a Tribogear variable normal load friction and wear measurement system HHS-2000 (manufactured by Shinto Scientific Co., Ltd.), and the frictional force (gf) at the 1^{st} reciprocation and the 100^{th} reciprocation is measured. The value of the frictional force (gf) (100^{th} reciprocation)−frictional force (gf) (1^{st} reciprocation) is used to perform the evaluation, and this value is an index representing the changes in the frictional force in a reciprocal movement. Furthermore, the depth of wear after 100 reciprocations is measured using a confocal laser microscope OLS1100OLS (manufactured by Olympus Corp.). The conditions are shown below.
25±3° C., 50±10% RH
Needle made of diamond, R=0.2 mm
Load 20 g
Speed of reciprocation 15 mm/sec
Number of reciprocations 100 times

In the evaluation described above, a small fluctuation in the abrasive force and a small depth of wear imply that the film has high mechanical strength, has long-term stability in terms of friction and wear characteristics, and that the film may be used at sliding regions.

Evaluation for Flexural Bending Test

A strip specimen having a size of 25±1 mm in length and 10±1 mm in width is cut from the charge transport layer (charge transport film) of the samples for the evaluation for flexural bending test, using a cutter knife. An evaluation for the flexural bending test is carried out using the specimen according to the following criteria.

AA: The strip specimen may be cut out and may be bent, and the film has toughness.

A: The strip specimen may be cut out and may be bent.

B: The strip specimen may be cut out, but when the specimen is bent, the film is damaged.

C: The strip specimen may not be cut out, and the film is damaged.

In the evaluation described above, the fact that the strip specimen may be bent implies that the film has flexibility. The fact that the film has toughness implies that when an external force is applied to the film, the film has excellent resistance to the external force, and that the film is advantageous for use in a bent state.

Image Evaluation

The electrophotographic photoreceptor produced as described above is attached to a process cartridge, and the process cartridge is mounted on a modified printer of a DocuCentre Color 450 manufactured by Fuji Xerox Co., Ltd. Ten sheets of printed images with an area of 100% solid shading and a halftone area having an image density of 20% are printed on A4 paper in an environment of 20±3° C. and 40±5% RH, and thus an evaluation of an initial image is carried out.

Subsequently, 5000 sheets are continuously printed in an environment of 28±3° C. and 85±5% RH, and 5000 sheets are continuously printed again in an environment of 10±3° C. and 15±5% RH. Subsequently, 10 sheets are printed in an environment of 20±3° C. and 40±5% RH. After a lapse of time, an evaluation of the images is carried out.

The evaluation of an initial image is carried out using the halftone image area with an image density of 20% in the 10^{th} sheet of printed image, and arbitrary five sites that measure 1 mm on each side (hereinafter, site of observation) are observed using an optical microscope (magnification 100 times). Thus, the evaluation is carried out according to the following criteria.

Similarly, the evaluation of images after a lapse of time is carried out after printing of 10000 sheets, using the 10^{th} sheet of printed image, in the same manner as in the case of the evaluation of initial image.

For the evaluation of images, P paper (A4 size, transverse direction feed) manufactured by Fuji Xerox Office Supply Co., Ltd. is used.

A: Halftone dots are observed over the entire observation site, and image deletion does not occur.

B: Halftone dots are not developed in some parts of the observation site, or image deletion occurs.

C: Halftone dots are not developed in a region occupying a half or more of the observation site, or image deletion occurs.

TABLE 1
Composition of coating liquid for charge transport layer (charge transport film) formation

| | Compound having reactive | | | | | | Compound having reactive | | | | | | Number of moles of |
|---|---|---|---|---|---|---|---|---|---|---|---|---|---|
| | functional group having | | | Compound having | | | functional group having | | | | | | thiol group in |
| | carbon double bond, and | | | thiol group | | | carbon double bond, and | | | Compound having thiol | | | film raw |
| | having charge | | | and not having charge | | | not having charge | | | group and having charge | | | material/number of |
| | transporting skeleton | | | transporting skeleton | | | transporting skeleton | | | transporting skeleton | | | moles of reactive |
| | | Number of | | | Number of | | | Number of | | | Number of | | functional group |
| | | functional | | | functional | | | functional | | | functional | | having carbon |
| | | groups per | Mass | | groups per | Mass | | groups per | Mass | | groups per | Mass | double bond |
| | Kind | molecule | (g) | Kind | molecule | (g) | Kind | molecule | (g) | Kind | molecule | (g) | (%) |
| Example 1 | a-1 | 2 | 0.801 | b-1 | 4 | 0.381 | — | — | — | — | — | — | 100 |
| Example 2 | a-1 | 2 | 0.801 | b-2 | 4 | 0.342 | — | — | — | — | — | — | 100 |
| Example 3 | a-1 | 2 | 0.801 | b-3 | 3 | 0.530 | — | — | — | — | — | — | 100 |
| Example 4 | a-1 | 2 | 0.801 | b-4 | 2 | 0.412 | — | — | — | — | — | — | 100 |
| Example 5 | a-2 | 2 | 0.801 | b-1 | 4 | 0.262 | — | — | — | — | — | — | 100 |
| Example 6 | a-3 | 4 | 0.801 | b-1 | 4 | 0.434 | — | — | — | — | — | — | 100 |
| Example 7 | a-4 | 4 | 0.801 | b-1 | 4 | 0.699 | — | — | — | — | — | — | 100 |
| Example 8 | a-5 | 4 | 0.801 | b-1 | 4 | 0.547 | — | — | — | — | — | — | 100 |
| Example 9 | — | — | — | — | — | — | c-1 | 2 | 0.614 | d-1 | 2 | 0.801 | 100 |
| Example 10 | — | — | — | — | — | — | c-1 | 2 | 0.684 | d-2 | 4 | 0.801 | 100 |
| Example 11 | a-1 | 2 | 0.483 | — | — | — | — | — | — | d-1 | 2 | 0.517 | 100 |
| Example 12 | a-1 | 2 | 0.801 | b-1 | 4 | 0.285 | — | — | — | — | — | — | 75 |
| Example 13 | a-2 | 2 | 0.801 | b-1 | 4 | 0.198 | — | — | — | — | — | — | 75 |
| Example 14 | a-3 | 4 | 0.801 | b-1 | 4 | 0.329 | — | — | — | — | — | — | 75 |
| Example 15 | a-4 | 4 | 0.801 | b-1 | 4 | 0.527 | — | — | — | — | — | — | 75 |
| Example 16 | a-5 | 4 | 0.801 | b-1 | 4 | 0.409 | — | — | — | — | — | — | 75 |
| Example 17 | a-1 | 2 | 0.801 | b-1 | 4 | 0.190 | — | — | — | — | — | — | 50 |
| Example 18 | a-2 | 2 | 0.801 | b-1 | 4 | 0.132 | — | — | — | — | — | — | 50 |
| Example 19 | a-3 | 4 | 0.801 | b-1 | 4 | 0.220 | — | — | — | — | — | — | 50 |
| Example 20 | a-4 | 4 | 0.801 | b-1 | 4 | 0.351 | — | — | — | — | — | — | 50 |

TABLE 2
Composition of coating liquid for charge transport layer (charge transport film) formation

| | Compound having reactive | | | | | | Compound having reactive | | | | | | |
|---|---|---|---|---|---|---|---|---|---|---|---|---|---|
| | functional group having | | | Compound having | | | functional group having | | | | | | Number of moles of |
| | carbon double bond, and | | | thiol group | | | carbon double bond, and | | | Compound having thiol | | | thiol group in film |
| | having charge | | | and not having charge | | | not having charge | | | group and having charge | | | raw material/number |
| | transporting skeleton | | | transporting skeleton | | | transporting skeleton | | | transporting skeleton | | | of moles of |
| | | Number of | | | Number of | | | Number of | | | Number of | | reactive functional |
| | | functional | | | functional | | | functional | | | functional | | group having carbon |
| | | groups per | Mass | | groups per | Mass | | groups per | Mass | | groups per | Mass | double bond |
| | Kind | molecule | (g) | Kind | molecule | (g) | Kind | molecule | (g) | Kind | molecule | (g) | (%) |
| Example 21 | a-5 | 4 | 0.801 | b-1 | 4 | 0.273 | — | — | — | — | — | — | 50 |
| Example 22 | a-1 | 2 | 0.801 | b-1 | 4 | 0.095 | — | — | — | — | — | — | 25 |
| Example 23 | a-3 | 4 | 0.801 | b-1 | 4 | 0.110 | — | — | — | — | — | — | 25 |
| Example 24 | a-4 | 4 | 0.801 | b-1 | 4 | 0.176 | — | — | — | — | — | — | 25 |
| Example 25 | a-5 | 4 | 0.801 | b-1 | 4 | 0.137 | — | — | — | — | — | — | 25 |
| Example 26 | a-4 | 4 | 0.801 | b-1 | 4 | 0.105 | — | — | — | — | — | — | 15 |
| Example 27 | a-5 | 4 | 0.801 | b-1 | 4 | 0.082 | — | — | — | — | — | — | 15 |

TABLE 3
Composition of coating liquid for charge transport layer (charge transport film) formation

| | Compound having reactive | | | | | | Compound having reactive | | | | | | Number of moles of |
|---|---|---|---|---|---|---|---|---|---|---|---|---|---|
| | functional group having | | | Compound having | | | functional group having | | | | | | thiol group in |
| | carbon double bond, and | | | thiol group | | | carbon double bond, and | | | Compound having thiol | | | film raw |
| | having charge | | | and not having charge | | | not having charge | | | group and having charge | | | material/number of |
| | transporting skeleton | | | transporting skeleton | | | transporting skeleton | | | transporting skeleton | | | moles of reactive |
| | | Number of | | | Number of | | | Number of | | | Number of | | functional group |
| | | functional | | | functional | | | functional | | | functional | | having carbon |
| | | groups per | Mass | | groups per | Mass | | groups per | Mass | | groups per | Mass | double bond |
| | Kind | molecule | (g) | Kind | molecule | (g) | Kind | molecule | (g) | Kind | molecule | (g) | (%) |
| Comp. Ex. 1 | a-1 | 2 | 0.801 | — | — | — | — | — | — | — | — | — | 0 |
| Comp. Ex. 2 | a-2 | 2 | 0.801 | — | — | — | — | — | — | — | — | — | 0 |
| Comp. Ex. 3 | a-3 | 4 | 0.801 | — | — | — | — | — | — | — | — | — | 0 |
| Comp. Ex. 4 | a-4 | 4 | 0.801 | — | — | — | — | — | — | — | — | — | 0 |
| Comp. Ex. 5 | a-5 | 4 | 0.801 | — | — | — | — | — | — | — | — | — | 0 |
| Comp. Ex. 6 | a-2 | 2 | 0.801 | b-1 | 4 | 0.065 | — | — | — | — | — | — | 25 |
| Comp. Ex. 7 | a-1 | 2 | 0.801 | b-1 | 4 | 0.057 | — | — | — | — | — | — | 15 |
| Comp. Ex. 8 | a-2 | 2 | 0.801 | b-1 | 4 | 0.040 | — | — | — | — | — | — | 15 |
| Comp. Ex. 9 | a-3 | 4 | 0.801 | b-1 | 4 | 0.066 | — | — | — | — | — | — | 15 |
| Comp. Ex. 10 | a-1 | 2 | 0.801 | b-5 | 1 | 0.285 | — | — | — | — | — | — | 50 |
| Comp. Ex. 11 | a-1 | 2 | 0.801 | b-5 | 1 | 0.566 | — | — | — | — | — | — | 100 |

TABLE 4
Evaluation results

| | | | | Evaluation for friction and wear | | | | |
|---|---|---|---|---|---|---|---|---|
| | | | | test | | | | |
| | | | | Frictional force | | | | |
| | | Evaluation of charge | | (gf) (100^{th} | | Evaluation | Evaluation of images | |
| | Sulfur atom content in charge | transportability | | reciprocation) - | Depth of abrasion | for | | Image |
| | transport layer (film) (mass %)/ | Light | Residual | Frictional force | after 100 | flexural | | after |
| | Cross-linked resin or non- | attenuation | potential | (gf) (1^{st} | reciprocations | bending | Initial | lapse of |
| | cross-linked resin | (%) | (V) | reciprocation) | (μm) | test | image | time |
| Example 1 | 7.6/Cross-linked resin | 89 | −10 | 2 | 0.3 | AA | A | A |
| Example 2 | 7.8/Cross-linked resin | 87 | −10 | 3 | 0.3 | AA | A | A |
| Example 3 | 9.0/Cross-linked resin | 88 | −10 | 3 | 0.4 | AA | A | A |
| Example 4 | 14.8/Non-cross-linked resin | 93 | −9 | 3 | 0.6 | AA | A | A |
| Example 5 | 5.8/Cross-linked resin | 95 | −8 | 5 | 0.2 | AA | A | A |
| Example 6 | 8.3/Cross-linked resin | 94 | −12 | 6 | 0.1 | AA | A | A |
| Example 7 | 11.0/Cross-linked resin | 96 | −5 | 4 | 0.1 | AA | A | A |
| Example 8 | 9.6/Cross-linked resin | 99 | −1 | 5 | 0.1 | AA | A | A |
| Example 9 | 5.9/Non-cross-linked resin | 80 | −20 | 6 | 0.2 | AA | A | A |
| Example 10 | 6.3/Cross-linked resin | 73 | −34 | 7 | 0.1 | AA | A | A |
| Example 11 | 5.4/Non-cross-linked resin | 90 | −9 | 2 | 0.2 | A | A | A |
| Example 12 | 6.2/Cross-linked resin | 86 | −10 | 2 | 0.1 | AA | A | A |
| Example 13 | 4.7/Cross-linked resin | 95 | −8 | 5 | 0.1 | AA | A | A |
| Example 14 | 6.8/Cross-linked resin | 93 | −15 | 5 | 0.1 | AA | A | A |
| Example 15 | 9.3/Cross-linked resin | 93 | −5 | 5 | 0.1 | AA | A | A |
| Example 16 | 8.0/Cross-linked resin | 99 | −1 | 5 | 0.1 | AA | A | A |
| Example 17 | 4.5/Cross-linked resin | 85 | −9 | 3 | 0.1 | A | A | A |
| Example 18 | 3.3/Cross-linked resin | 93 | −22 | 6 | 0.4 | B | A | A |
| Example 19 | 5.1/Cross-linked resin | 95 | −10 | 7 | 0.1 | A | A | A |
| Example 20 | 7.1/Cross-linked resin | 93 | −5 | 7 | 0.1 | A | A | A |

TABLE 5
Evaluation results

| | | | | Evaluation for friction and wear | | | | |
|---|---|---|---|---|---|---|---|---|
| | | | | test | | | | |
| | | | | Frictional force | | | | |
| | | Evaluation of charge | | (gf) (100^{th} | | Evaluation | Evaluation of images | |
| | Sulfur atom content in charge | transportability | | reciprocation) - | | for | | Image |
| | transport layer (film) (mass %)/ | Light | Residual | Frictional force | Depth of abrasion | flexural | | after |
| | Cross-linked resin or non- | attenuation | potential | (gf) (1^{st} | after 100 | bending | Initial | lapse of |
| | cross-linked resin | (%) | (V) | reciprocation) | reciprocations (μm) | test | image | time |
| Example 21 | 6.0/Cross-linked resin | 93 | −2 | 7 | 0.1 | A | A | A |
| Example 22 | 2.5/Cross-linked resin | 88 | −12 | 8 | 0.4 | B | A | A |
| Example 23 | 2.8/Cross-linked resin | 76 | −22 | 8 | 0.4 | B | A | A |
| Example 24 | 4.2/Cross-linked resin | 85 | −5 | 3 | 0.2 | A | A | A |
| Example 25 | 3.4/Cross-linked resin | 80 | −20 | 8 | 0.3 | B | A | A |
| Example 26 | 2.7/Cross-linked resin | 93 | −6 | 8 | 0.7 | B | A | A |
| Example 27 | 2.2/Cross-linked resin | 93 | −8 | 7 | 0.7 | B | A | A |

TABLE 6
Evaluation results

| | | | | Evaluation for friction and wear | | | | |
|---|---|---|---|---|---|---|---|---|
| | | | | test | | | | |
| | | | | Frictional force | | | | |
| | | Evaluation of charge | | (gf) (100th | | Evaluation | Evaluation of images | |
| | Sulfur atom content in charge | transportability | | reciprocation) - | Depth of abrasion | for | | Image |
| | transport layer (film) (mass %)/ | Light | Residual | Frictional force | after 100 | flexural | | after |
| | Cross-linked resin or non- | attenuation | potential | (gf) (1st | reciprocations | bending | Initial | lapse of |
| | cross-linked resin | (%) | (V) | reciprocation) | (μm) | test | image | time |
| Comp. Ex. 1 | 0.0/Cross-linked resin | 52 | −183 | 16 | 0.2 | C | A | C |
| Comp. Ex. 2 | 0.0/Cross-linked resin | 55 | −190 | 22 | 0.2 | C | A | C |
| Comp. Ex. 3 | 0.0/Cross-linked resin | 51 | −195 | 15 | 0.1 | C | A | C |
| Comp. Ex. 4 | 0.0/Cross-linked resin | 30 | −412 | 12 | 0.1 | C | A | C |
| Comp. Ex. 5 | 0.0/Cross-linked resin | 23 | −390 | 18 | 0.1 | C | A | C |
| Comp. Ex. 6 | 1.8/Cross-linked resin | 70 | −32 | 11 | 1.0 | B | A | B |
| Comp. Ex. 7 | 1.6/Cross-linked resin | 85 | −9 | 10 | 1.2 | B | A | B |
| Comp. Ex. 8 | 1.1/Cross-linked resin | 88 | −22 | 10 | 1.1 | B | A | B |
| Comp. Ex. 9 | 1.8/Cross-linked resin | 93 | −10 | 12 | 1.0 | B | A | B |
| Comp. Ex. 10 | 16.7/Non-cross-linked resin | 93 | −9 | 10 | 1.3 | B | A | B |
| Comp. Ex. 11 | 26.2/Non-cross-linked resin | 93 | −7 | 33 | 21.0 | C | A | B |

From the evaluation results described above, it may be seen that the Examples may obtain satisfactory results in the evaluation of charge transportability, the evaluation for friction and wear test, the evaluation for flexural bending test, and the evaluation of images, as compared with the Comparative Examples.

The details of the respective materials shown in the tables will be described below. The term “Number of functional groups per molecule” in the tables means the number of the reactive functional groups having a carbon double bond or thiol groups in the compound used.

[Compounds having reactive functional groups having carbon double bond and having charge transporting skeleton]
(a-1): Compound represented by formula (ii-18)
(a-2): Compound represented by formula (ii-19)
(a-3): Compound represented by formula (iv-16)
(a-4): Compound represented by formula (iv-28)
(a-5): compound represented by formula (iv-55)

[Compound Having Thiol Group and not Having Charge Transporting Skeleton]
(b-1): Karenz MT PE1 (pentaerythritol tetrakis(3-mercaptobutyrate), manufactured by Showa Denko K.K., compound containing four secondary thiol groups)
(b-2): PEMP (pentaerythritol tetrakis(3-mercaptopropionate), manufactured by SC Organic Chemical Co., Ltd., compound containing four primary thiol groups)
(b-3): Karenz MT NR1 (1,3,5-tris(3-mercaptobutyloxyethyl)-1,3,5-triazine-2,4,6(1H,3H,5H-trione), manufactured by Showa Denko K.K., compound containing three secondary thiol groups)
(b-4): Karenz MT BD1 (1,4-bis(3-mercaptobutyryloxy)butane, manufactured by Showa Denko K.K., compound containing two secondary thiol groups)
(b-5): 1-Dodecanetihol (manufactured by Wako Pure Chemical Industries, Ltd., compound containing one primary thiol group)

[Compound Having Reactive Functional Group Having Carbon Double Bond and not Having Charge Transporting Skeleton]
(c-1): ABE-300 (ethoxylated bisphenol diacrylate, manufactured by Shin Nakamura Chemical Co., Ltd.)

[Compound Having Thiol Group and Having Charge Transporting Skeleton]
(d-1): Compound represented by formula (AA-6)
(d-2): Compound represented by formula (AA-22)

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charge transport film comprising an enethiol resin having a charge transporting skeleton, and having a sulfur atom content of from 2.0% by mass to 15% by mass.

2. The charge transport film of claim 1, which is a cured film comprising a cross-linked product of the enethiol resin.

3. The charge transport film of claim 1, wherein the charge transporting skeleton of the enethiol resin is a charge transporting skeleton represented by the following formula (AAA): 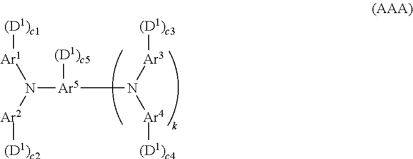
wherein Ar¹ to Ar⁴ each independently represent a substituted or unsubstituted aryl group; Ar⁵ represents a substituted or unsubstituted aryl group, or a substituted or unsubstituted arylene group; D¹'s each independently represent a linking group that links the skeleton to a site other than the charge transporting skeleton that constitutes the enethiol resin, and each represent “Ar”-(G)ₐ₁-(X)ₐ₂—Y—S—* or “Ar”-(G)ₐ₁-(Z)ₐ₂—Y′—CH(R)—CH₂—* (provided that “Ar” represents any one of Ar¹ to Ar⁵ to which D¹ is linked; G represents a divalent organic group having from 1 to 5 carbon atoms; X represents —CO—O— or —O—; Y represents a divalent organic group having from 1 to 5 carbon atoms which may be substituted with —SH as a substituent; Y′ represents a divalent organic group having from 1 to 5 carbon atoms; Z represents —CO—, —O—, or a phenylene group; R represents a hydrogen atom, or an alkyl group having from 1 to 4 carbon atoms; a1 and a2 each independently represent 0 or 1; and symbol * represents a linking unit to a site other than the charge transporting skeleton); c1 to c5 each independently represent 0, 1 or 2; k represents 0 or 1; and the total number of D¹'s is 2 or greater.

4. An organic electronic device comprising the charge transport film of claim 1.

5. The organic electronic device of claim wherein the charge transport film is a cured film containing a cross-linked product of the enethiol resin.

6. The organic electronic device of claim 4, wherein the charge transporting skeleton of the enethiol resin in the charge transport film is a charge transporting skeleton represented by the following formula (AAA): 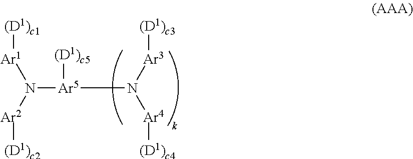
wherein Ar¹ to Ar⁴ each independently represent a substituted or unsubstituted aryl group; Ar⁵ represents a substituted or unsubstituted aryl group, or a substituted or unsubstituted arylene group; D¹'s each independently represent a linking group that links the skeleton to a site other than the charge transporting skeleton that constitutes the enethiol resin, and each represent “Ar”-(G)ₐ₁-(X)ₐ₂—Y—S—* or “Ar”-(G)ₐ₁-(Z)ₐ₂—Y′—CH(R)—CH₂—* (provided that “Ar” represents any one of Ar¹ to Ar⁵ to which D′ is linked; G represents a divalent organic group having from 1 to 5 carbon atoms; X represents —CO—O— or —O—; Y represents a divalent organic group having from 1 to carbon atoms which may be substituted with —SH as a substituent; Y′ represents a divalent organic group having from 1 to 5 carbon atoms; Z represents —CO—, —O—, or a phenylene group; R represents a hydrogen atom, or an alkyl group having from 1 to 4 carbon atoms; a1 and a2 each independently represent 0 or 1; and symbol * represents a linking unit to a site other than the charge transporting skeleton); c1 to c5 each independently represent 0, 1 or 2; k represents 0 or 1; and the total number of D¹'s is 2 or greater.

7. An electrophotographic photoreceptor comprising the charge transport film of claim 1 as an outermost layer.

8. The electrophotographic photoreceptor of claim 7, wherein the charge transport film is a cured film containing a cross-linked product of the enethiol resin.

9. The electrophotographic photoreceptor of claim 7, wherein the charge transporting skeleton of the enethiol resin in the charge transport film is a charge transporting skeleton represented by the following formula (AAA): 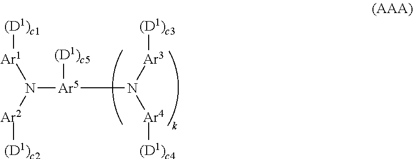
wherein Ar¹ to Ar⁴ each independently represent a substituted or unsubstituted aryl group; Ar⁵ represents a substituted or unsubstituted aryl group, or a substituted or unsubstituted arylene group; D¹'s each independently represent a linking group that links the skeleton to a site other than the charge transporting skeleton that constitutes the enethiol resin, and each represent “Ar”-(G)ₐ₁-(X)ₐ₂—Y—S—* or “Ar”-(G)ₐ₁-(Z)ₐ₂—Y′—CH(R)—CH₂—* (provided that “Ar” represents any one of Ar¹ to Ar⁵ to which D′ is linked; G represents a divalent organic group having from 1 to 5 carbon atoms; X represents —CO—O— or —O—; Y represents a divalent organic group having from 1 to carbon atoms which may be substituted with —SH as a substituent; Y′ represents a divalent organic group having from 1 to 5 carbon atoms; Z represents —CO—, —O—, or a phenylene group; R represents a hydrogen atom, or an alkyl group having from 1 to 4 carbon atoms; a1 and a2 each independently represent 0 or 1; and symbol * represents a linking unit to a site other than the charge transporting skeleton); c1 to c5 each independently represent 0, 1 or 2; k represents 0 or 1; and the total number of D¹'s is 2 or greater.

10. A process cartridge comprising at least the electrophotographic photoreceptor of claim 7, the process cartridge being detachable from an image forming apparatus.

11. The process cartridge of claim 10, wherein the charge transport film of the electrophotographic photoreceptor is a cured film containing a cross-linked product of the enethiol resin.

12. The process cartridge of claim 10, wherein the charge transporting skeleton of the enethiol resin in the charge transport film of the electrophotographic photoreceptor is a charge transporting skeleton represented by the following formula (AAA): 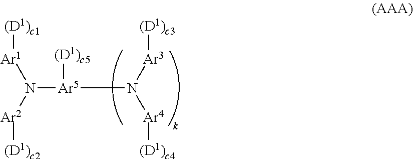
wherein Ar¹ to Ar⁴ each independently represent a substituted or unsubstituted aryl group; Ar⁵ represents a substituted or unsubstituted aryl group, or a substituted or unsubstituted arylene group; D¹'s each independently represent a linking group that links the skeleton to a site other than the charge transporting skeleton that constitutes the enethiol resin, and each represent “Ar”-(G)ₐ₁-(X)ₐ₂—Y—S—* or “Ar”-(G)ₐ₁-(Z)ₐ₂—Y′—CH(R)—CH₂—* (provided that “Ar” represents any one of Ar¹ to Ar⁵ to which D¹ is linked; G represents a divalent organic group having from 1 to 5 carbon atoms; X represents —CO—O— or —O—; Y represents a divalent organic group having from 1 to carbon atoms which may be substituted with —SH as a substituent; Y′ represents a divalent organic group having from 1 to 5 carbon atoms; Z represents —CO—, —O—, or a phenylene group; R represents a hydrogen atom, or an alkyl group having from 1 to 4 carbon atoms; a1 and a2 each independently represent 0 or 1; and symbol * represents a linking unit to a site other than the charge transporting skeleton); c1 to c5 each independently represent 0, 1 or 2; k represents 0 or 1; and the total number of D¹'s is 2 or greater.

13. An image forming apparatus comprising:
the electrophotographic photoreceptor of claim 7;
a charging unit that charges the electrophotographic photoreceptor;
an electrostatic latent image forming unit that forms an electrostatic latent image on the charged electrophotographic photoreceptor;
a developing unit that holds a developer containing a toner, and develops the electrostatic latent image formed on the electrophotographic photoreceptor into a toner image using the developer; and
a transfer unit that transfers the toner image to a transfer medium.

14. The image forming apparatus of claim 13, wherein the charge transport film of the electrophotographic photoreceptor is a cured film containing a cross-linked product of the enethiol resin.

15. The image forming apparatus of claim 13, wherein the charge transporting skeleton of the enethiol resin in the charge transporting film of the electrophotographic photoreceptor is a charge transporting skeleton represented by the following formula (AAA): 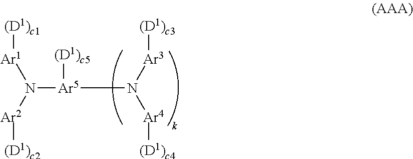
wherein Ar¹ to Ar⁴ each independently represent a substituted or unsubstituted aryl group; Ar⁵ represents a substituted or unsubstituted aryl group, or a substituted or unsubstituted arylene group; D¹'s each independently represent a linking group that links the skeleton to a site other than the charge transporting skeleton that constitutes the enethiol resin, and each represent “Ar”(G)ₐ₁-(X)ₐ₂—Y—S—* or “Ar”-(G)ₐ₁-(Z)ₐ₂—Y′—CH(R)—CH₂—* (provided that “Ar” represents any one of Ar¹ to Ar⁵ to which D¹ is linked; G represents a divalent organic group having from 1 to 5 carbon atoms; X represents —CO—O— or —O—; Y represents a divalent organic group having from 1 to carbon atoms which may be substituted with —SH as a substituent; Y′ represents a divalent organic group having from 1 to 5 carbon atoms; Z represents —CO—, —O—, or a phenylene group; R represents a hydrogen atom, or an alkyl group having from 1 to 4 carbon atoms; a1 and a2 each independently represent 0 or 1; and symbol * represents a linking unit to a site other than the charge transporting skeleton); c1 to c5 each independently represent 0, 1 or 2; k represents 0 or 1; and the total number of D¹'s is 2 or greater.
